(19) United States
(12) Patent Application Publication
(10) Pub. No.: US 2006/0156278 A1
(43) Pub. Date: Jul. 13, 2006

(54) Global localization and customization system and process

(76) Inventor: Sue Ellen Reager, Atlanta, GA (US)

Correspondence Address: MYERS & KAPLAN, INTELLECTUAL PROPERTY LAW, L.L.C., 1899 POWERS FERRY ROAD, SUITE 310, ATLANTA, GA, 30339, US

(21) Appl. No.: 11/280,877

(22) Filed: Nov. 16, 2005

Related U.S. Application Data
(60) Provisional application No. 60/629,136, filed on Nov. 18, 2004.

(51) Int. Cl. G06F 9/44

(52) U.S. Cl. 717/104

(57) ABSTRACT

A global localization and customization system and process comprising a graphical user interface, database, and table driver for collectively creating accurate and appropriate text, image, movie, video and sound file concatenation for localization and/or customization of a selected application for presentation of same in any world language, dialect and/or sub-customized language.

### CROSS-REFERENCE AND PRIORITY CLAIM TO RELATED APPLICATIONS

To the fullest extent permitted by law, the present non-provisional patent application claims priority to and the full benefit of provisional patent application entitled “Global Localization and Customization System and Process”, filed on Nov. 18, 2004, having assigned Ser. No. 60/629,136.

### COPYRIGHT NOTICE

A portion of the disclosure of this patent document contains material which is subject to copyright protection. The copyright owner has no objection to the facsimile reproduction by anyone of the patent document or patent disclosure as it appears in the U.S. Patent and Trademark Office patent file or records, but otherwise reserves all copyright rights whatsoever.

### TECHNICAL FIELD

The present invention relates generally to software systems and applications, and more specifically to a global localization and customization system and process, wherein the present invention is particularly advantageous for providing a host system or application with the requisite commands and data for expeditious, consistent and accurate localization and/or customization of same in any world language, dialect and/or sub-customized language.

### BACKGROUND OF THE INVENTION

Globalization is the desire to sell a product or service globally, wherein localization is the means by which globalization may be implemented, and wherein customization adds value and marketability to a product by personalizing the product to customer or user preferences.

Specifically, localization is the ability for a computer software system or application to present data in a way which creates the most appealing presentation to someone living in a selected locale. Web pages are the easiest applications to conceptualize, as web pages can be read around the world and, if selling a product/service therethrough, effective localization will tend to increase product/service sales as the web application will account for differences in distinct global markets. However, effective and efficient localization processes is one of the aspects of software ergonomics which is very difficult to manage and implement with consistency—particularly because of the hundreds of languages, dialects, and localizations around the world.

A process often utilized in localizing applications is that of concatenation, wherein selected text, pictures, video, audio, effects, and the like, are sequentially strung together to provide organized and meaningful data. For example, with regard to an electronic mailing application, if the final text to be displayed is “You have 3 messages in your mailbox.”, then concatenation of the text may appear as follows: (You have) (3) (messages in your mailbox.) The variable “3” is only available at run-time of the application, yet determines whether the word “message” is used or, more appropriately, “messages.” Such changes must be made impromptu or spontaneously as the product is operating (i.e., at run-time). Additionally, when translated into another language, such as Japanese, the order of the sentence must change to: (Your mailbox in) (3-boo) (message there is.). To date, however, in order to accommodate such changes as above, the developer must either alter the hard code for the new order, or manually alter the order and enter exceptions in a system-linked data table.

The process of “customization” is utilized to increase localized or user acceptability or to attract a specific targeted audience, whether that audience is in another language or in the base language of the product. Customization ranges from changes in visual or audio elements to accommodate a customer preference or personalization, to variations by language or region for text, audio or other media. Customization also includes “version control”, in which, for example, a product will use less or more features according to the region to which it is distributed. For example, an “e-fax” feature may be part of the English version of a product, but not the Arabic version.

Customization further encompasses changing any media in use at any time, such as pictures, video, audio or effects, in addition to changing any element of a project related to size, such as size of a picture, audio file, video, font, and/or any other element that comprises the end-product controlled either by programming or, if a digital entity, alterable via code.

Unfortunately, to accommodate for such customization processes and changes, current methods require the developer to alter the hard code for the change in text, sound, media, picture or the like; manually manipulate a system-linked data table and enter exceptions for each variation; or create entire sub-versions separate from the “main version” of a product, with the exceptions included therein. Moreover, access to, and manipulation of, such data tables are, in large part, restricted to the developers, and rarely available to marketing and sales executives or other non-developers whose responsibility is to meet customer needs. However, even if permitted, most non-developer input is often significantly limited in scope to minimum personalization by users.

Consequently, engineering and developer costs for performing the above-described localization and/or customization processes and sub-processes run into the hundreds of thousands of dollars for some small to mid-size companies, and often into the millions of dollars for larger companies. Furthermore, such current localization and customization approaches significantly impede rapid and versatile product development, extend time to domestic and international market, slow delivery to clients, reduce customization of any kind, increase costs, and stress company staff; thus, ultimately delaying development of new revenue.

Therefore, it is readily apparent that there is a need for a global localization and customization system and process designed to enhance a client application to enable predictable, accurate, maintainable and relatively inexpensive localization and customization in applications or systems ranging in size from embedded to enterprise.

### BRIEF SUMMARY OF THE INVENTION

Briefly described, in a preferred embodiment, the present invention overcomes the above-mentioned disadvantages and meets the recognized need for such an invention by providing a global localization and customization system and process comprising a graphical user interface, database, and table driver for collectively creating accurate and appropriate text, image, movie, video and sound concatenation for localization and/or customization of a selected application for presentation of same in any world language, dialect, sub-customized language, and/or customization in any language, including base language, to meet user-specific needs or preferences. Notably, via the present globalization system, once an application is hard coded in a selected language, the hard code will not need to be altered again, and, as such, the present system will be enabled to function in at least two-hundred (200) languages, with hundreds of customizations of any one audio voice prompt sentence or screen appearance—all without altering the original hard code.

According to its major aspects and broadly stated, the present invention in its preferred form is a global localization and customization system and process, comprising a graphical user interface, database, and table driver. The graphical user interface and database are preferably installed via CD-ROM, downloaded from an applicable website through a global networking system (i.e., Internet), or other conventional installation method, wherein the table driver is designed to be compiled with a client application, or accessed as a peripheral. Preferably, all components of the present invention are available for IBM COMPATIBLE, LINUX and UNIX/MACINTOSH systems; although other systems are contemplated.

More specifically, the present invention is a global localization and customization system and process preferably applicable to any system (IT and otherwise) comprising the following components: a client application, which holds business code and logic written in C, C++, J2SE, J2EE, .NET, Java, XML, VXML, HTML, or other suitable code/logic, wherein examples of such applications may include, without limitation, PBX, web sites, software, applications using voice prompts, applications displaying computer screen text, applications displaying computer screen artwork/media, navigation software, kiosks, point of sale machines and applications, stand-alone machines driven by software, voice response products, telephony products, ATMs, and the like; a set of presentation data (abstracted or hard-coded) which represents any media which is involved in presenting information to the application user, wherein such presentation data may include, without limitation, voice files, text, images, movies, pixel coordinates, home-grown maps, and the like; a platform on which the client application presents the data, wherein such platforms may include, without limitation, UNIX TELNET SESSION, WINDOWS INTERNET EXPLORER, BMW 5 SERIES navigation computer, LINUX, WINDOWS (2000, NT, XP and others), kiosks, POS, computer telephony platforms, other software and the like; a team which maintains the presentation layer, including the development, quality control, translation, voice talent, and product management thereof; and, a need to globalize or customize the application by better localizing and/or personalizing the presentation layer.

To provide the client with appropriate and accurate localization/customization, the present global localization and customization system and process utilizes a “compile-once translate-and-customize-forever” technology comprising a graphical user interface, database, and table driver. Through the graphical user interface, a client may enter raw components, such as conceptual sentences, images, movies, voice file names, or the like, and store the entered raw components in the database for future access. At anytime after startup, the client application can load the table driver with raw components and content from an extract file containing essential information from the database. The client application “asks” the table driver for a sentence or screen appearance by a “name” given to that sentence or screen, and utilizes the raw components and content of the database, along with run-time specific client data, to provide properly organized data results in the form of the exact combination of images, movies, voice files, or the like desired for the user at any particular time.

As such, the present global localization and customization system and process provides the application/system with all text, voice prompt names and any other information required for the system's programming to play full complete sentences created from short phrases and variables that are entered into the database of the present invention. The present system and process further determines what numberset to play, what order to play the prompts, what text or media to display or play on the screen and where, what fonts, colors, style to display, and which sub-language prompt/text to use, offering all such information to the system at run-time, and the system/application implements; thereby, facilitating localization and/or customization.

Consequently, when the present global localization and customization system and process is utilized with the above-referenced software and subroutines, the present system and process removes all need for developer hard code and/or peripheral table localization or customization by language or by variance. One-code-string-fits-all is the basic premise of the present global localization and customization system and process. That is, one repeating code string passed to the table driver will result in the host system receiving all commands and all data required for any localization and/or customization of the selected system or application. Further, once installed, the table driver functions forever in almost any world language, dialect and/or sub-customized language. As such, the present system and process enables a client application to react to almost infinite customization.

For example, because the present global localization and customization system and process provides any application or system with the commands and data required for a system to identify what text to display, sound files to play, multimedia to view, and more, dynamic/XML websites need no longer derive their content directly from a database. The entire database content is housed in an extract of the present system and process, and delivered with greater speed via the table driver and the web application's programming at run-time. Additionally, text, sound, pictures, and video can be customized, personalized and changed at run-time based upon any criteria the web developer has initiated; thus, facilitating localization and/or customization. Accordingly, via the present system, the majority of decision making is no longer required to be made via hard code, which is an otherwise slow, labor-intensive process largely subject to failure. Instead, the table driver of the present invention reads the extract (a compressed binary file) and makes all decisions utilizing one single code string.

Accordingly, a feature and advantage of the present invention is its ability to be incorporated into and provide localization and/or customization commands and information (i.e., text, audio, pictures, video, and the like) for any application or product that is driven by programming code, and changes in written or spoken language, sound, voice prompts, pictures, videos, multimedia, or other media to be viewed or heard, whether such changes are required once or thousands of times while the application is running.

Another feature and advantage of the present invention is its ability to “tell” an application or system what needs to be done, such as what voice prompts to play and in what order, what text to display (including font, size and screen location), what pictures to show (including size, dimensions and location on screen), what videos to play (including size, dimensions and location on screen), what subtitles to play with a video (including the in/out-timecodes, and subtitle text to be displayed at each timecode), and other media, data or information that can be stored in and retrieved from a database or from a given computer “address” or “path”.

Still another feature and advantage of the present invention is its ability to enable customer representatives, marketing and sales personnel, and/or other selected non-developers, to implement localization and/or customization of a particular application without involving developers or engineers, and to further empower end-users to personalize beyond conventional experience.

These and other features and advantages of the present invention will become more apparent to one skilled in the art from the following description and claims when read in light of the accompanying drawings.

### BRIEF DESCRIPTION OF THE DRAWINGS

The present invention will be better understood by reading the Detailed Description of the Preferred and Selected Alternate Embodiments with reference to the accompanying drawing figures, in which like reference numerals denote similar structure and refer to like elements throughout, and in which:

FIG. 1 is a component flow diagram of a global localization and customization system and process according to a preferred embodiment of the present invention;

FIG. 2 is a component flow diagram of a global localization and customization system and process according to a preferred embodiment of the present invention;

FIG. 3 is a component flow diagram of a global localization and customization system and process according to a preferred embodiment of the present invention;

FIG. 4 is a component flow diagram of a global localization and customization system and process according to a preferred embodiment of the present invention;

FIG. 5 is a screen print of a graphical user interface of a global localization and customization system and process according to a preferred embodiment of the present invention;

FIG. 6 is a screen print of general template options of a global localization and customization system and process according to a preferred embodiment of the present invention;

FIG. 7 is a screen print of an exemplary template of a global localization and customization system and process according to a preferred embodiment of the present invention;

FIG. 8 is a screen print of an exemplary template of a global localization and customization system and process according to a preferred embodiment of the present invention;

FIG. 9 is a screen print of an exemplary template of a global localization and customization system and process according to a preferred embodiment of the present invention;

FIG. 10 is a screen print of an exemplary template of a global localization and customization system and process according to a preferred embodiment of the present invention;

FIG. 11 is a screen print of an exemplary template of a global localization and customization system and process according to a preferred embodiment of the present invention;

FIG. 12 is a screen print of an exemplary template of a global localization and customization system and process according to a preferred embodiment of the present invention;

FIG. 13 is a screen print of an exemplary template of a global localization and customization system and process according to a preferred embodiment of the present invention;

FIG. 14 is a screen print of an exemplary template of a global localization and customization system and process according to a preferred embodiment of the present invention;

FIG. 15 is a screen print of an exemplary template of a global localization and customization system and process according to a preferred embodiment of the present invention;

FIG. 16 is a screen print of an exemplary template of a global localization and customization system and process according to a preferred embodiment of the present invention;

FIG. 17A is a screen print of an exemplary template of a global localization and customization system and process according to a preferred embodiment of the present invention;

FIG. 17B is a screen print of an exemplary template of a global localization and customization system and process according to a preferred embodiment of the present invention;

FIG. 17C is a screen print of an exemplary template of a global localization and customization system and process according to a preferred embodiment of the present invention;

FIG. 18 is a screen print of an exemplary template of a global localization and customization system and process according to a preferred embodiment of the present invention;

FIG. 19 is a screen print of an exemplary script of a global localization and customization system and process according to a preferred embodiment of the present invention;

FIG. 20 is a screen print of an exemplary user database of a global localization and customization system and process according to a preferred embodiment of the present invention;

FIG. 21A is a screen print of an administrator home page of a global localization and customization system and process according to a preferred embodiment of the present invention;

FIG. 21B is a screen print of an exemplary template of a global localization and customization system and process according to a preferred embodiment of the present invention;

FIG. 22 is a table driver process diagram of a global localization and customization system and process according to a preferred embodiment of the present invention;

FIG. 23 is a table driver client architectures diagram of a global localization and customization system and process according to a preferred embodiment of the present invention;

FIG. 24 is a table driver report suite diagram of a global localization and customization system and process according to a preferred embodiment of the present invention;

FIG. 25 is a table driver viewer diagram of a global localization and customization system and process according to a preferred embodiment of the present invention;

FIG. 26 illustrates features, components and considerations of the table driver process of a global localization and customization system and process according to a preferred embodiment of the present invention;

FIG. 27 illustrates features, components and considerations of the table driver process of a global localization and customization system and process according to a preferred embodiment of the present invention;

FIG. 28 illustrates features, components and considerations of the table driver process of a global localization and customization system and process according to a preferred embodiment of the present invention;

FIG. 29 illustrates features, components and considerations of the table driver process of a global localization and customization system and process according to a preferred embodiment of the present invention;

FIG. 30 illustrates features, components and considerations of the table driver process of a global localization and customization system and process according to a preferred embodiment of the present invention;

FIG. 31 illustrates features, components and considerations of the table driver process of a global localization and customization system and process according to a preferred embodiment of the present invention;

FIG. 32 illustrates features, components and considerations of the table driver process of a global localization and customization system and process according to a preferred embodiment of the present invention;

FIG. 33 illustrates features, components and considerations of the table driver process of a global localization and customization system and process according to a preferred embodiment of the present invention;

FIG. 34 illustrates features, components and considerations of the table driver process of a global localization and customization system and process according to a preferred embodiment of the present invention;

FIG. 35 illustrates features, components and considerations of the table driver process of a global localization and customization system and process according to a preferred embodiment of the present invention;

FIG. 36 illustrates features, components and considerations of the table driver process of a global localization and customization system and process according to a preferred embodiment of the present invention;

FIG. 37 illustrates features, components and considerations of the table driver process of a global localization and customization system and process according to a preferred embodiment of the present invention;

FIG. 38 illustrates features, components and considerations of the grammer process of a global localization and customization system and process according to a preferred embodiment of the present invention;

FIG. 39 illustrates features, components and considerations of the grammer process of a global localization and customization system and process according to a preferred embodiment of the present invention;

FIG. 40 illustrates features, components and considerations of the grammer process of a global localization and customization system and process according to a preferred embodiment of the present invention;

FIG. 41 illustrates features, components and considerations of the grammer process of a global localization and customization system and process according to a preferred embodiment of the present invention; and,

FIG. 42 illustrates features, components and considerations of the grammer process of a global localization and customization system and process according to a preferred embodiment of the present invention.

### DETAILED DESCRIPTION OF THE PREFERRED AND SELECTED ALTERNATE EMBODIMENTS

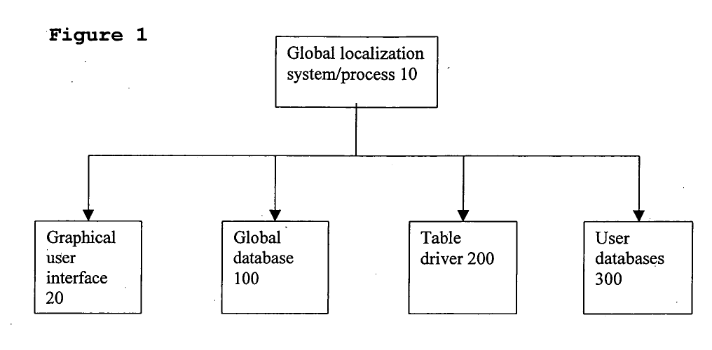

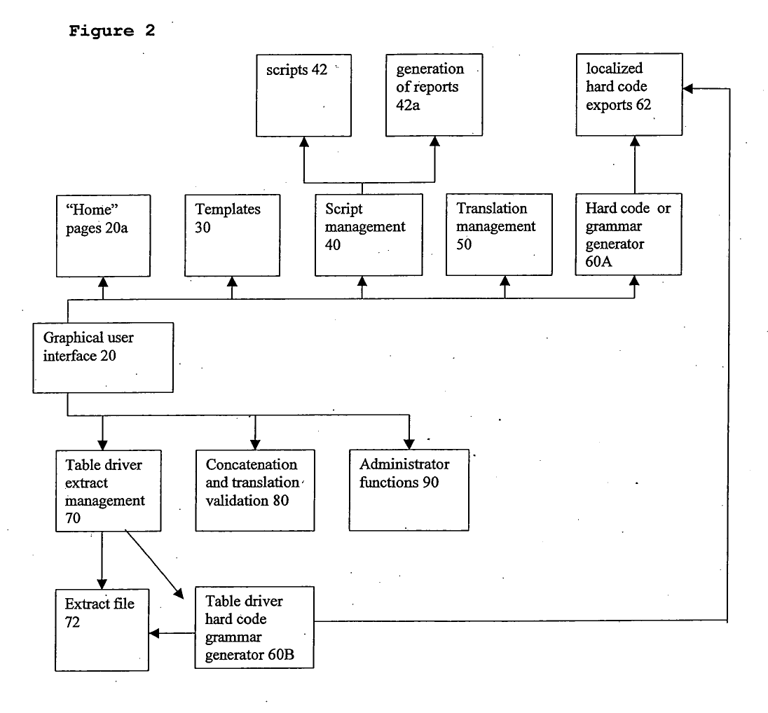

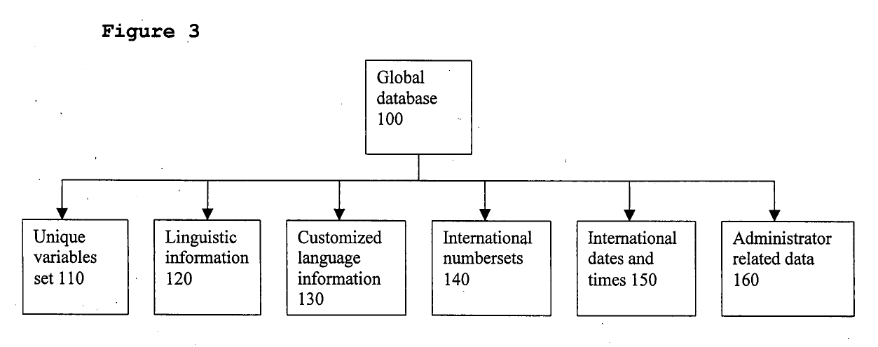

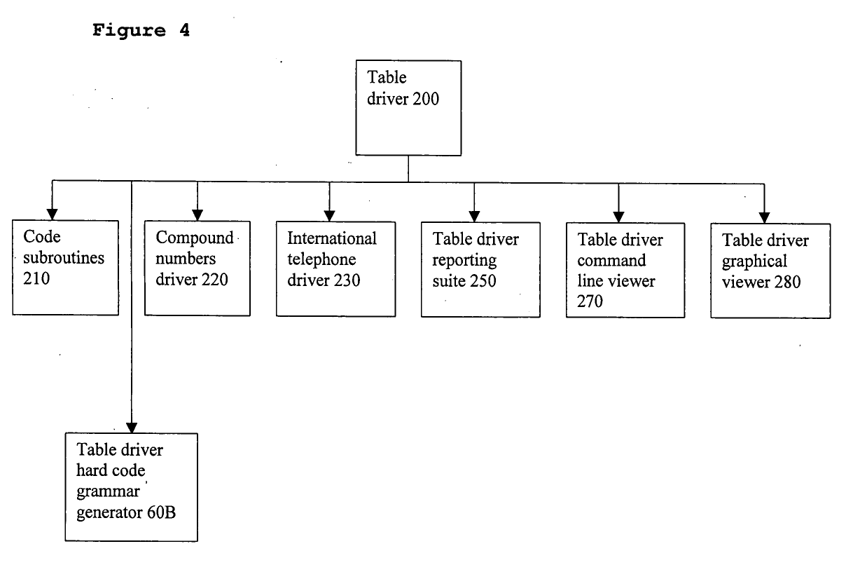

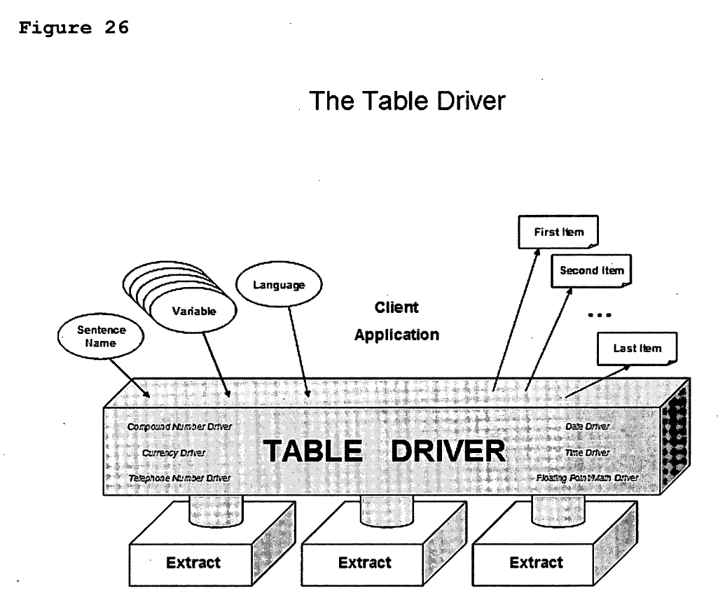

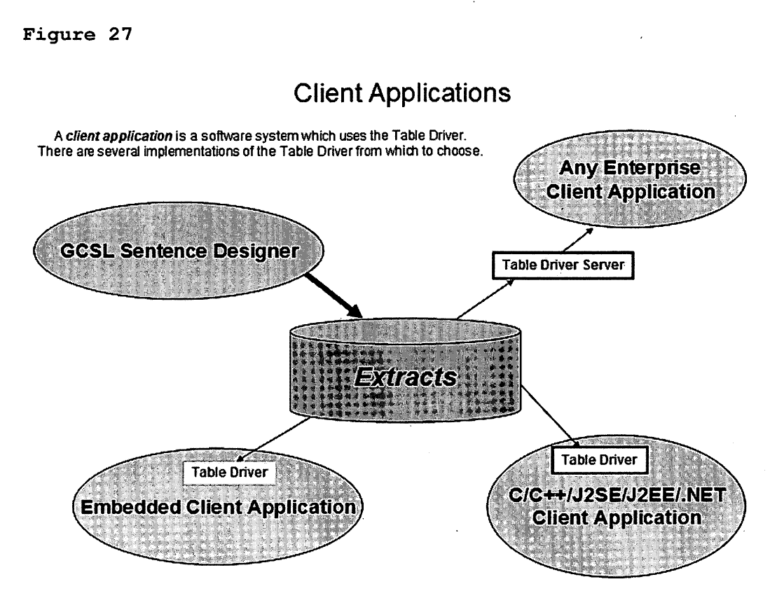

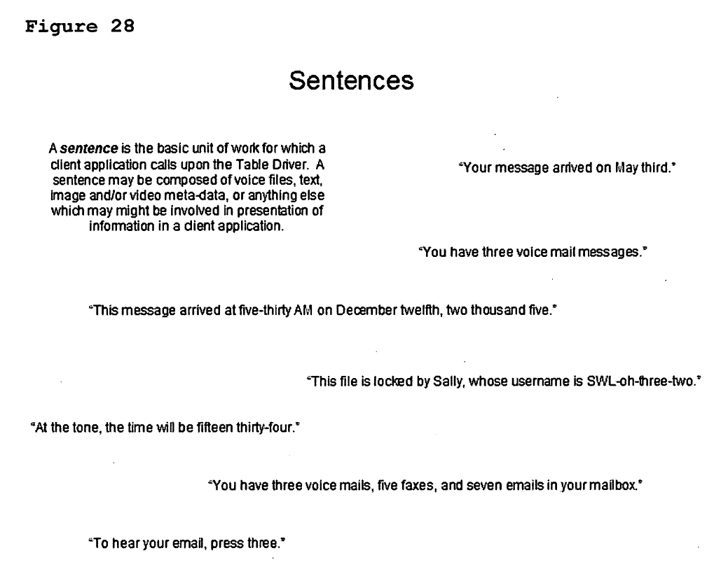

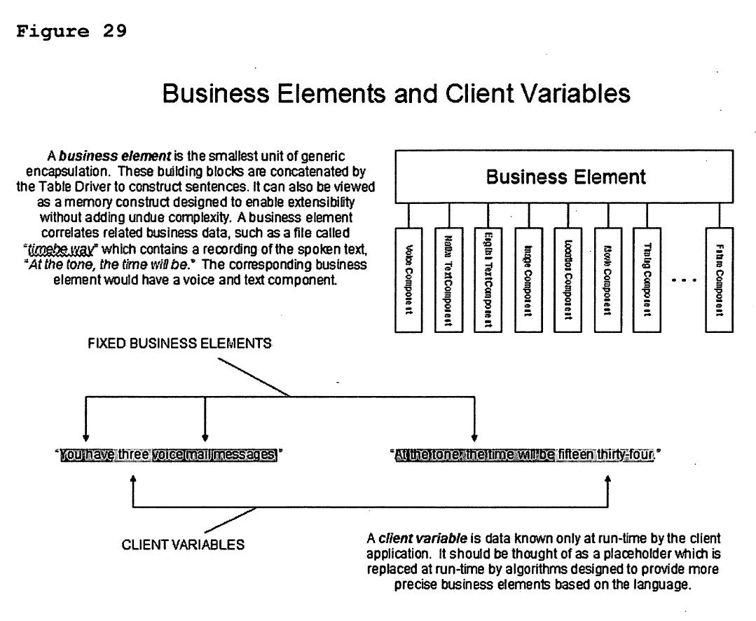

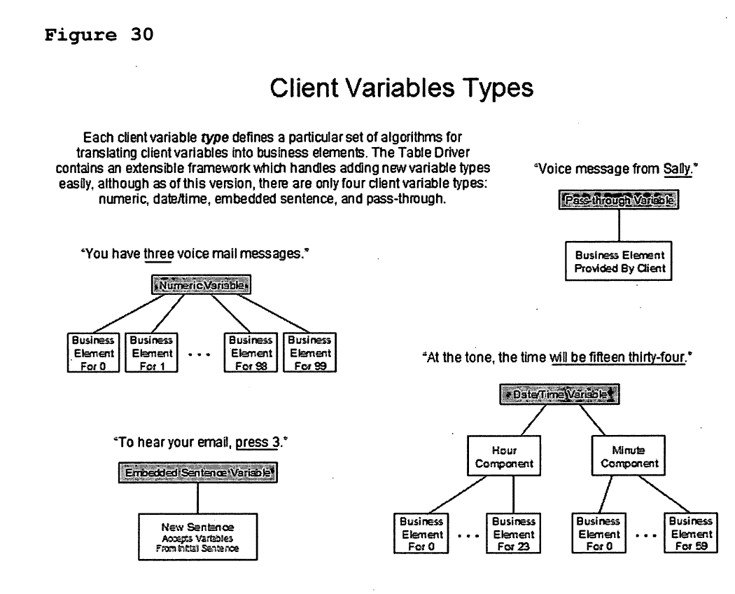

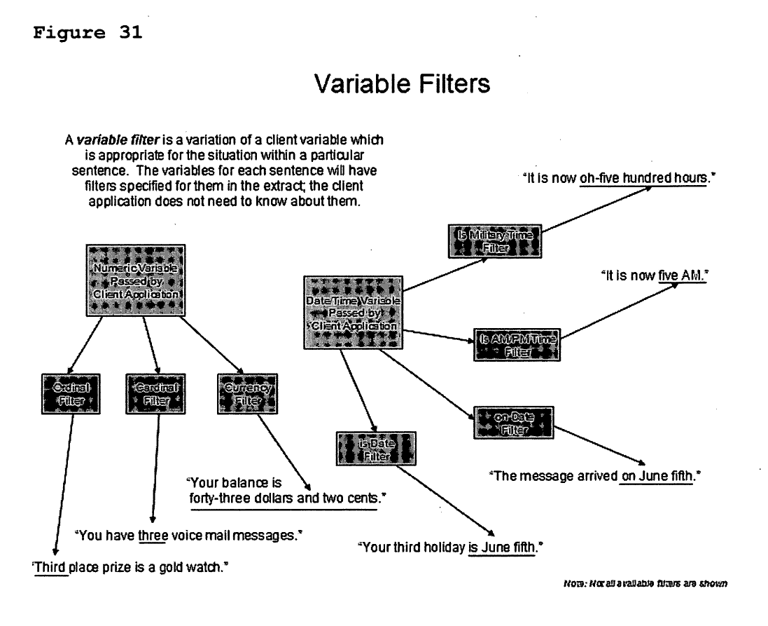

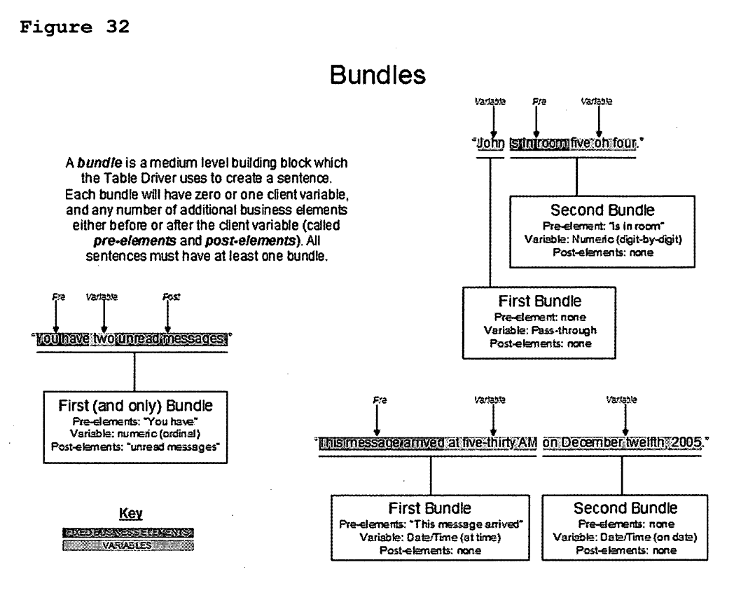

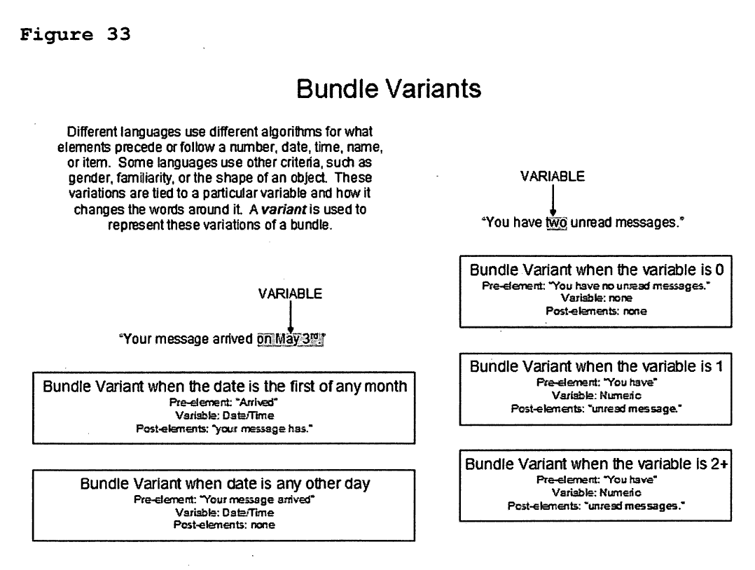

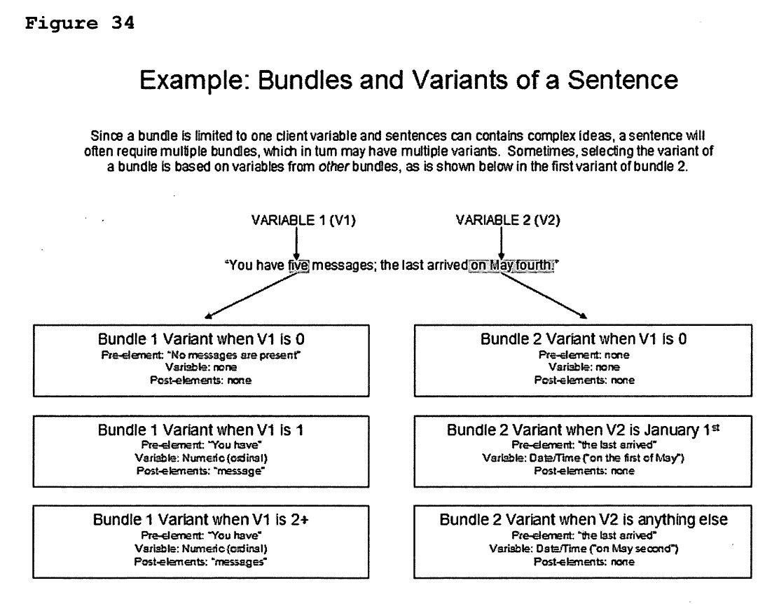

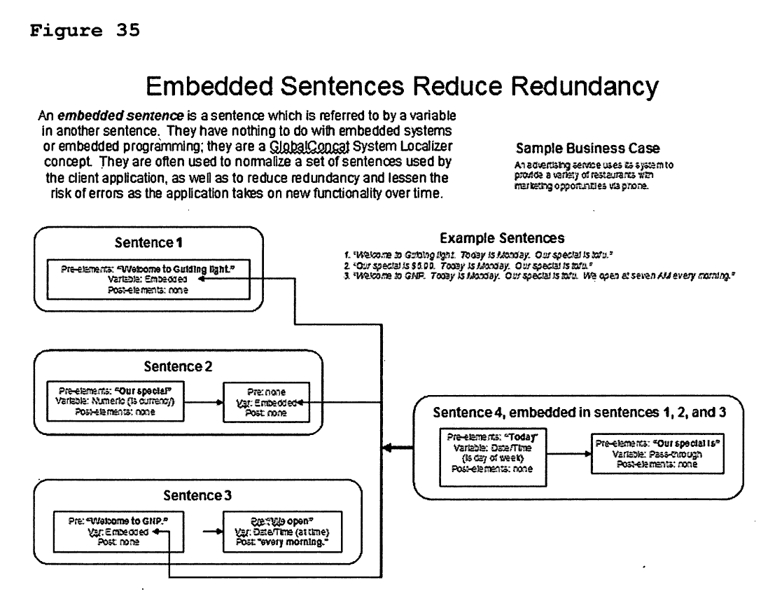

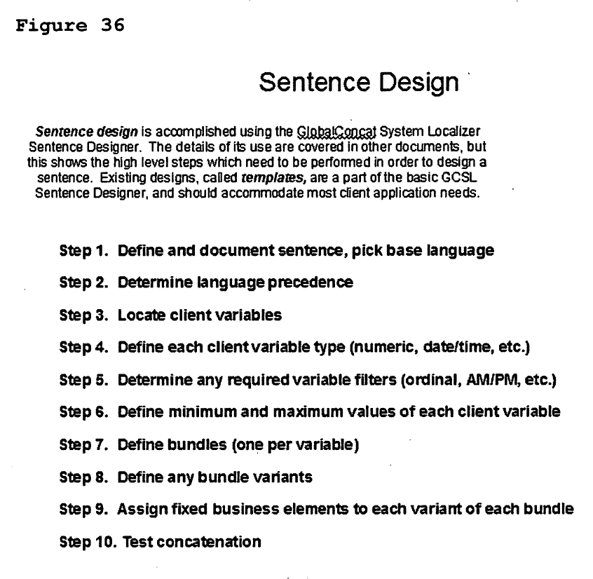

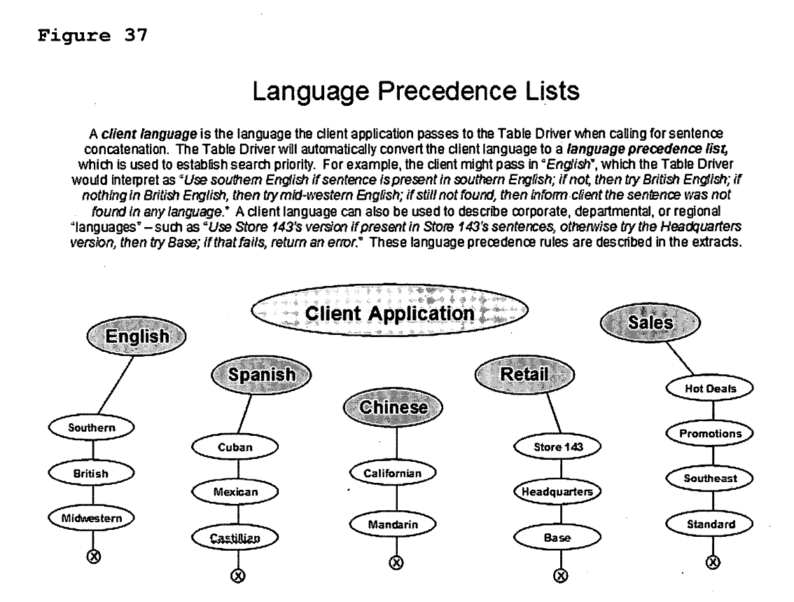

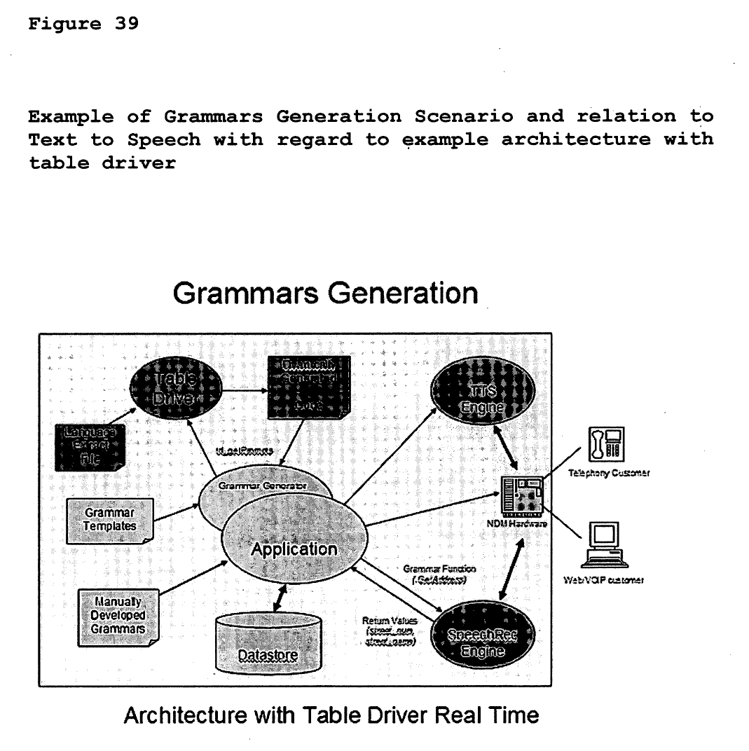

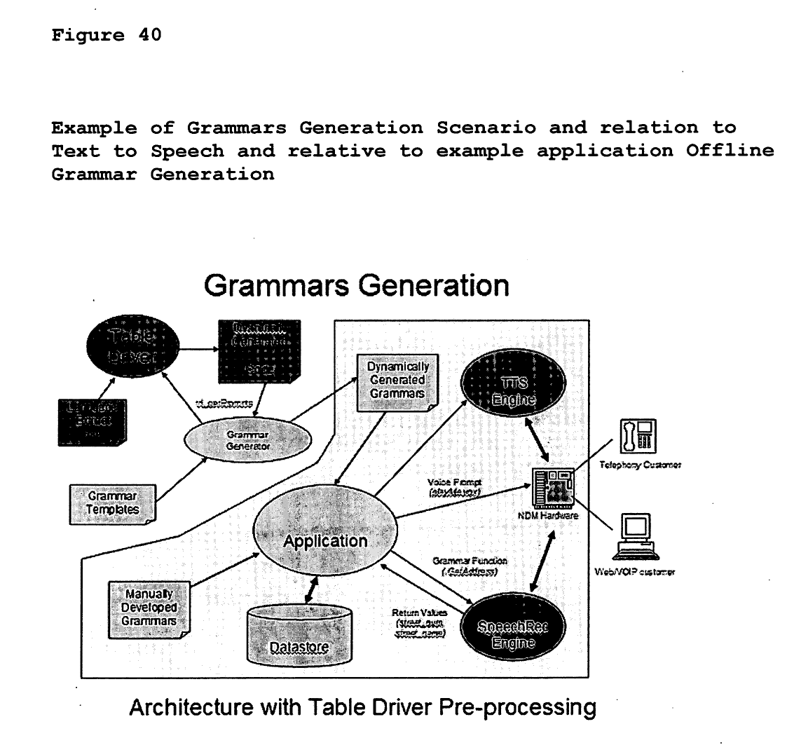

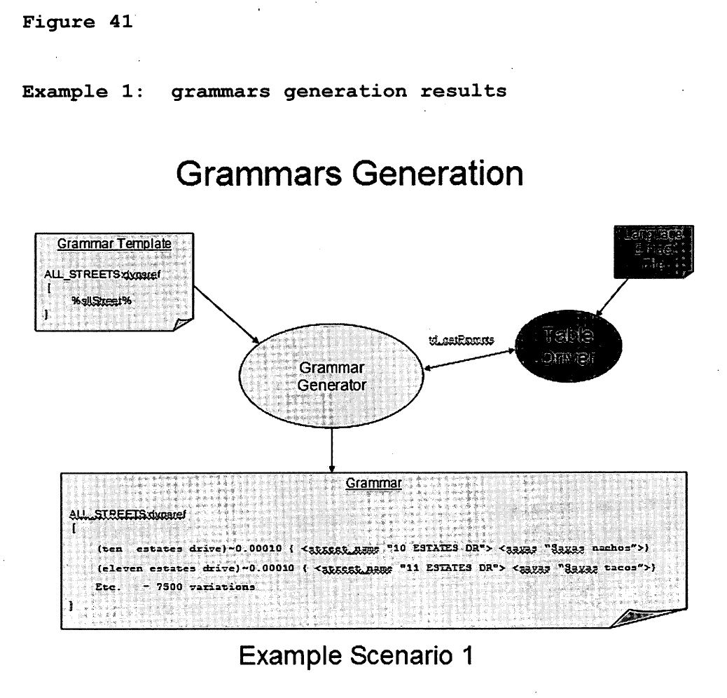

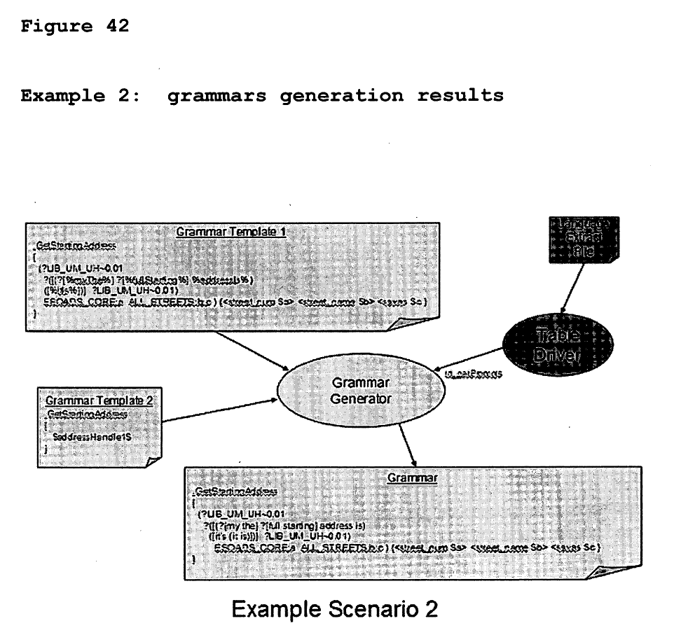

In describing the preferred and selected alternate embodiments of the present invention, as illustrated in FIGS. 1-42 specific terminology is employed for the sake of clarity. The invention, however, is not intended to be limited to the specific terminology so selected, and it is to be understood that each specific element includes all technical equivalents that operate in a similar manner to accomplish similar functions.

Referring now to FIGS. 1-4, the present invention in a preferred embodiment is a global localization and customization system and process 10 (“system 10”), comprising graphical user interface 20, global database 100, table driver 200, and application content databases 300 (“user databases 300”). Further, graphical user interface 20, global database 100, table driver 200, and user databases 300, each comprise sub-features or sub-parts that operate to effectively implement system 10.

Generally, and as more fully described below, graphical user interface 20, the “control center” of system 10, preferably comprises templates 30 to guide and control master text and data entries into user databases 300, thereby ensuring natural function and proper grammar when the text and data is translated into any selected language, dialect and/or sub-customized language; script management 40, which produces and manages a plurality of relevant scripts 42 generated from the master text/data entries, including talent scripts (i.e., talent scripts for recording client sentences, dates, times, numbers, and the like), scripts destined for translation (i.e., translation import, bilingual translation review files, or the like), audio scripts, and the like; translation management 50, which creates documents from scripts 42, or the like, for translation, and which automatically imports translated documents and/or scripts 42 into user database 300, thereby removing the need for manual manipulation of foreign text, and, accordingly, limiting errors; hard code generator 60, which creates usable, perfectly localized hard code exports 62 in several programming languages, including, without limitation, C, C++, V/XML, JAVA, and/or the like; table driver extract management 70, which produces and manages an obfuscated extract file 72 that operates as the “dictionary” of commands for table driver 200 and further produces table driver extract reports 260, as more fully described below; concatenation and translation validation 80, which facilitates full concatenation validation or verification, in written and/or audio form, by automatically replacing variable names with true variable content and, with regard to voice, by playing or providing a playlist of prompts in correct play order, including replacing variable names with true variable content audio file names; and, administrator functions 90, which provides user control, user level, application languages.

Additionally, and as further described below, graphical user interface 20 provides a plurality of other features, such as, custom variable control, which allows the user to create new customized variables, wherein the user is guided by system 10 to ensure that the variables will be internationally compatible; custom language creation, which allows the user to assign custom language names to sub-groups of a major language group, wherein such custom language names are utilized in hierarchal search pattern during operation of system 10; generation of reports 42a, which may include, without limitation, database content, audio file names/lists, variable requirements, programmer outlines, sentence lists, and/or the like; and printable call-flow simulation for filling in variable information.

Graphical user interface 20 is preferably designed so that the developers do not need to adapt or change what they desire to say for any considerations whatsoever, including considerations of reuse of previous prompts or for localization concerns. Rather, developers choose freely what is to be said, and enter same into user databases 300 via graphical user interface 20, with the knowledge that all entries will function perfectly when translated into any selected language, dialect and/or sub-customized language. Additionally, what is spoken (audio) and what is seen (screen text, pictures, faxes, video, media) can be separate issues, yet processed simultaneously.

In the conventional approach to localization, the manner in which data is entered by developers, regardless of native tongue or programming language, has prohibited applications from functioning when translated and customized, and often requires further code changes or system data-table modifications. As more fully described below, in the present invention, the process of text entry and other entries in user databases 300 through graphical user interface 20 will be different than conventional methods, and will further break at different points, but the end result will play more naturally and with the same or less concatenated prompts than traditional approaches yield. No forethought or planning for coding changes will be required, as there will be no coding changes if table diver 200 is in use, and because hard code exports, when in use, will expedite any such changes to be compatible with table driver 200.

With specific reference now to global database 100, sub-parts thereof preferably include unique variables set 110, linguistic information 120 for user entry validation; customized language information 130, both written and verbal international numbersets 140, both written and verbal international dates and times 150, and administrator related data 160. Accordingly, global database 100 generally stores all required basic variable translations and controls, in internationalized form, for proper application via system 10. Global database 100 is integrated into graphical user interface 20.

With specific reference now to table driver 200, primary sub-parts thereof preferably include code subroutines 210; compound numbers driver 220; international telephone and address driver 230; hard code and grammar generator 60B for voice response applications; table driver reporting suite 250; table driver command line viewer 270; and, table driver graphical viewer 280. Each specific sub-part of table driver 200 is described more fully hereinbelow.

User databases 300 preferably comprise unique schema utilized by the client/user to store its/his/her own information as entered through graphical user interface 20, wherein such information may include, without limitation, sentences, text, paths to or names of pictures and videos, audio files, dimensions, screen locations or other data related to the client's application that is or may be localized or customized. The client may choose to store all sentences or only concatenated sentences in user databases 300, and most particularly sentences or screen appearance controls with variable content affected at run-time. User databases 300 are preferably unicode compatible, both UTF 8 and 16, 2-byte enabled, and can further store “right to left” and special character languages, such as Arabic, Thai, and the like.

Through proper schema via SQL and other connectors, graphical user interface 20 can alternatively connect to databases other than user databases 300. Accordingly, the client is not required to solely utilize user databases 300. Because of the differences in schema between user databases 300 and unrelated databases, the client may choose to house only concatenated sentences or entries (with variable content provided at run-time) in user database 300, and static text (sentences and paragraphs) in the client's own database(s). As such, and as more fully described below, the present methodology of information storage in user databases 300, as inserted and manipulated by and through graphical user interface 20, is the key to flawless and effortless localization without reprogramming.

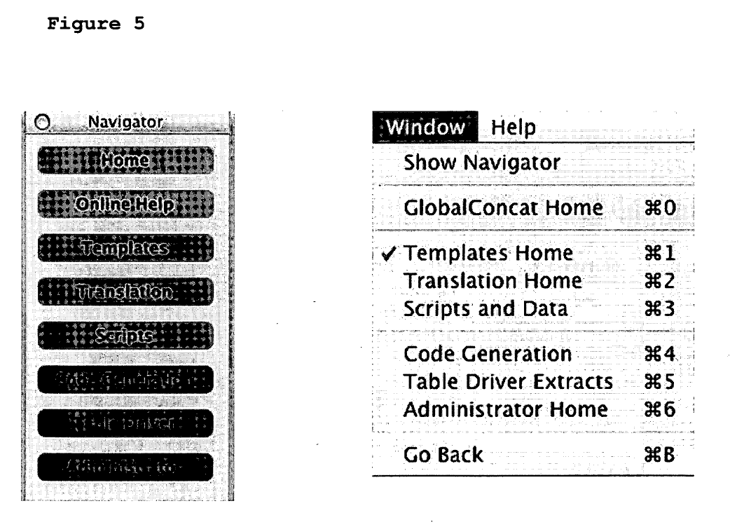

Referring now more specifically to FIG. 5, to facilitate navigation through graphical user interface 20, graphical user interface 20 is laid out similar to a website, with a series of “home” pages 20a (i.e., Home (main home), Administrator Home, Templates Home, Scripts and Data Home, Code Generation Home, Table Data Home, etc.) for each main task performed by graphical user interface 20, wherein each “home” page 20a preferably comprises a series of buttons or pull down menu choices of features for various sections thereof, and wherein each sub-page preferably comprises a full description and instructions for each item or command featured on that particular page.

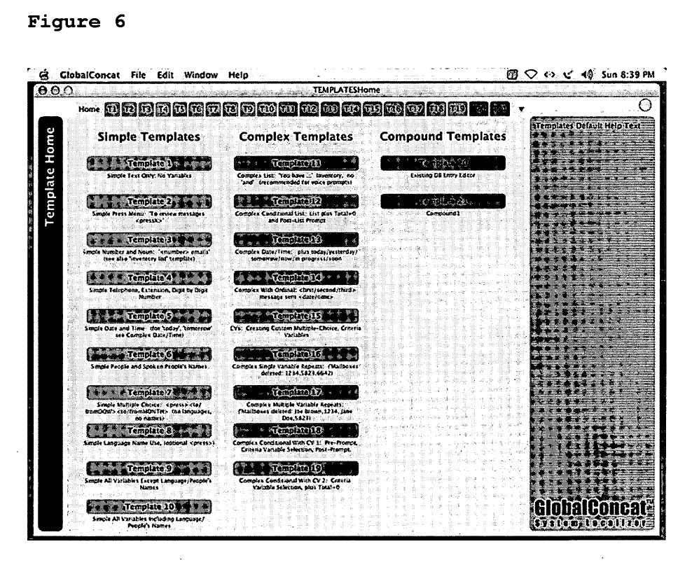

Referring now more specifically to FIG. 6, templates 30 are utilized by the client/user to guide and control entry of master text or data (i.e., the first, original text entry by the client/user) through graphical user interface 20, wherein the master text or data is utilized by script management 40 to produce and manage scripts 42. Thereafter, scripts 42 are preferably sent to translation management 50 for transmission to applicable translators. Scripts 42 are preferably translated by the translators, returned to translation management 50, and thereafter automatically imported into user databases 300.

Preferably, graphical user interface 20 provides a plurality of templates 30 to facilitate the foregoing processes. The purpose of the variety of templates 30 is to ensure that the developer can enter any text desired, without restriction, with the assurance that the text so entered will function properly when translated or customized. In utilizing templates 30, the user may enter any desired text, in its/his/her own native language. However, contrary to conventional approaches to such projects, templates 30 will guide the user to break up sentences into prompts, binary data, media types, and variables in such a manner that will ensure that the client's/user's entire application is internationalized, and that the translation will be in proper grammar so as to avoid the need to reprogram for localization and/or customization. That is, although full sentences are relatively easy to manage in almost any programming or database environment, it is the ability of system 10 to change appearance, sound and text on an impromptu or spontaneous basis, without changing programming or coding, that lends to the many features and advantages of system 10.

Moreover, templates 30 are designed such that the programmer, developer or user searches templates 30 to locate one that is in the style of the sentence/text the user wishes to enter. Only the master text needs to be entered by the user utilizing a selected template 30. The selected template 30 preferably guides the user to change its/his/her preconceptions, and successfully enter the desired text sentence, but in a manner different than the user would have used without template 30. Thus, templates 30 act as both guides and teaching tools.

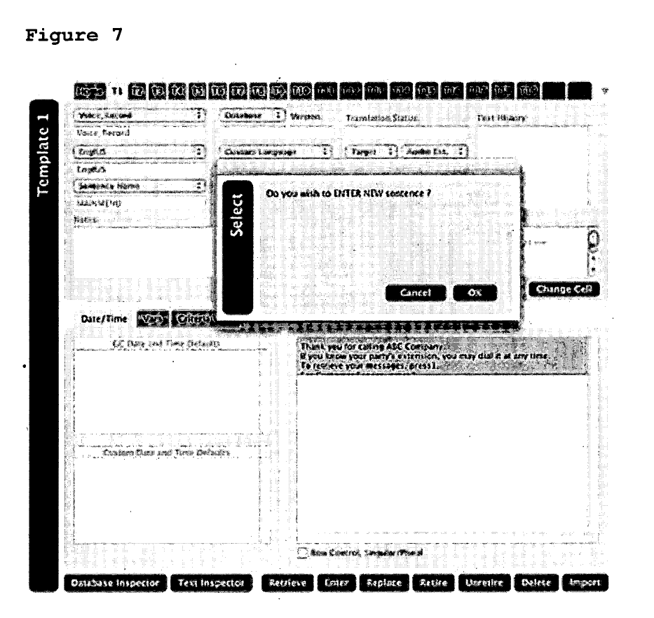

Referring now more specifically to FIGS. 7-18, illustrated therein are various exemplary uses or applications of various templates 30. Accordingly, and with specific reference now to FIG. 7, exemplary template 30a may preferably be utilized to enter “single prompt full sentences”, such as “Thank you for calling ABC Company.”, “If you know your party's extension, you may enter it at any time.”, “For Customer Service, press 1.”, “For Sales, press 2.”, and/or the like. Accordingly, at run-time, the foregoing sentences will appear exactly as referenced above. Notably, with such single prompt full sentences, paragraphs, and/or groups of paragraphs, system 10 functions substantially similar to conventional systems; however, it is the application of variable information where system 10 may be distinguished.

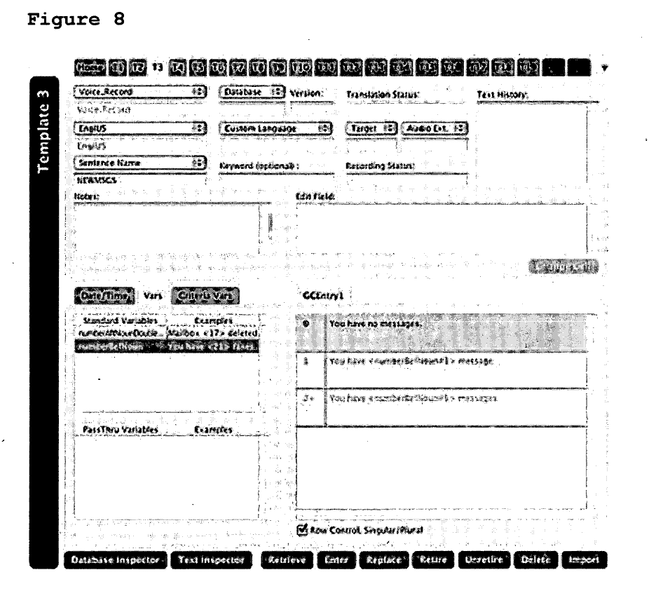

With specific reference now to FIG. 8, exemplary template 30b may preferably be utilized to enter “single number variable sentences”, such as “You have <number> message/s.” Accordingly, at run-time, the foregoing sentence may appear as “You have 10 messages.” or “You have 1 message.”

Notably, with conventional approaches, reprogramming or changes to data tables is required for complex spoken languages in order to accommodate multiple “10s” to choose from according to the gender or plural of the noun. Also, the prompts would need to be re-ordered for many languages, because the “you have” might need to appear at the end of the sentence, as a different expression, or not at all. Additionally, there is often a vast difference between spoken numbers versus numbers written as text, which affects voice prompts and products (ex.: Spanish has 4 spoken numbersets, but only 3 written; French has 5 spoken numbersets but only 2 written; Japanese has 12 spoken numbersets; Chinese has 9 spoken numbersets; and so on) Moreover, with conventional systems, manual manipulation is necessary for almost all developers to accommodate “counters” for Asian languages (most Asian numbers have “counters”, which are syllables spoken after a number and before the noun). Which counter to use is often based upon the shape of the object, although some languages use other factors. To achieve this, and to satisfy the various number rules of world languages, numbers are divided into 4 main categories: (1) Number before a noun (<number> messages); (2) Number after a noun (extension <number>); (3) Number spoken/displayed digit-by-digit (<5-2-2-9>); and, (4) Number for telephone (770.414.6003) (which is further processed by international telephone number driver 230 to be spoken and/or displayed properly for the applicable language and culture.

However, contrary to such conventional processes, table driver 200, and associated extract files 72 and algorithms, of system 10 will determine which “10” numberset is correct for the sentence, including differentiating between text and spoken numbersets. Through system 10, there is no need for the developer to reorder prompts, even if the “you have” appears at the end of the sentence, as extract file 72 for table driver 200 has already predetermined the changed order. Accordingly, system 10 meets all requirements for “counters” in any language.

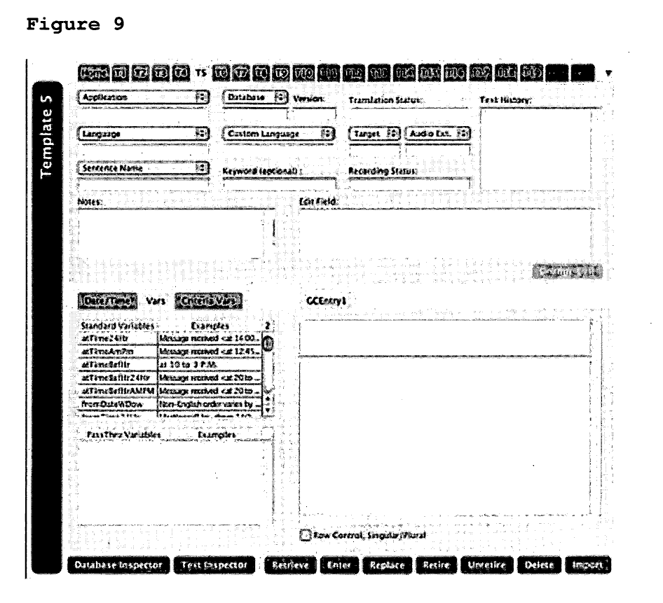

With specific reference now to FIG. 9, exemplary template 30c may preferably be utilized to enter “date/time variable sentences”, such as “Message received on <date> at <time>.” Accordingly, at run-time, the foregoing sentence may appear as “Message received on June 14^{th} at 3:45 p.m.”

Notably, with conventional approaches, reprogramming or changes to data tables is required in order to accommodate for the different order of various languages. In Japanese, for example, the sentence should read: “P.M. 3 hour 45 minute at June 14 on message received.” English itself has 13 different date formats; for example, 4^{th} of July, the 4^{d} of July, July 4^{th}, July 4, etc. Moreover, the words “on” and “at” have many different spellings and pronunciations in many languages. The “on” may be different for “Sunday” than for “Tuesday”. As such, conventional programming would dictate that the sentence be programmed or written as follows: (Message received on) <date> (at) <time>. Because of the non-internationally friendly splitting of these variables, however, in order to change to a different date format or play/display a different word for “on”, such changes must be manually entered either via code or data table in conventional systems.

However, contrary to such conventional processes, table driver 200, and associated extract files 72 and algorithms, of system 10 allow easy date or time format with no code change. Template 30c will guide the developer to split the dates/times in the following manner: (Message received)(onDate)(atTime). The “on Date” variable text and prompts include the word “on” wherever that word will be spoken, guaranteeing that the word “on” will be different for “Sunday” than for “Tuesday” when applicable. The word “at” will be included in all variable prompts where applicable. All prepositions (i.e., on, at, for, to, between, among, etc.) are included in the variables of system 10. The inclusion of the prepositions within the variables is another feature and advantage of the present invention.

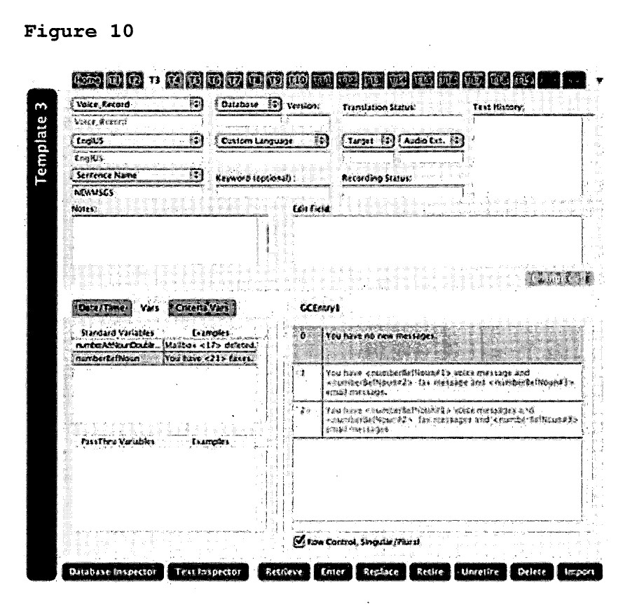

With specific reference now to FIG. 10, exemplary template 30d may preferably be utilized to accommodate for “and” constructions, such as “You have [<number> voice message/s] [<number> fax/es] [and <number> email/s]. Accordingly, at run-time, the foregoing sentence may appear as “You have 4 voice messages, 1 fax and 2 emails.”, “You have 4 fax messages and 1 email.”, “You have 1 voice message and 2 faxes.”, or “You have 3 emails.”

Conventional approaches to “and” constructions, however, may program the foregoing exemplary sentence as follows:

```
if x + y + z > 0 then
  (You have)
  if y > 0 then
    if y = 1 then
      <number>(voice messages)
    else
      <number> (voice messages)
    end if
  end if
  if y > 0 then
    if y = 1 then
      <number> (fax)
    else
      <number> (faxes)
    end if
  end if
  if z > 0 then
    if z = 1 then
      <number> (email)
    else
      <number> (emails)
    end if
  end if
end if
```

Notably, the problem with such conventional approaches, or with modification of any corresponding data table, is that the sentence must be manually changed for each language in several ways. Each of the nouns (message, fax, email) utilize a different numberset because each noun's genders will differ. Also, many languages have 3 to plurals (i.e., messages, messagi, messagu). The above-described conventional programming method only offers one plural variation. Moreover, the language rules for which plural to use and when, vary wildly across the language spectrum. Furthermore, most plural rules are based upon the last digit of the number modifying the noun; however, the vast majority of conventional systems have no programming to accommodate for same. Furthermore, the “you have” will appear at the end of the sentence in many languages, and may change “There is/there are” according to a sum total of messages received. Additionally, in some countries, the “have” varies according to what nouns play thereafter or therebefore.

However, contrary to such conventional processes, table driver 200, and associated extract files 72 and algorithms, of system 10 select the proper numberset, proper singular or plural, proper version of “you have” according to the run-time variables, plus provide the correct prompt order at run-time with no reprogramming or data table changes required. Properly entering the master text through graphic use interface 20, in the language of the developer, is sufficient to ensure that the text will function perfectly when translated by qualified professional translator. If the full “and” sequence is utilized, then items where the variable is “zero” are dropped at run-time, and the verb inserted where applicable according to the first item that is greater than zero. Moreover, the “and” feature will appear only with the final entry in the list, if any.

When entering master text in template 30d, the single line (“1”) contains the single of every noun on the list (message, fax, email). The plural line (“2+”) contains the plurals of all (messages, faxes, emails). Yet, at run-time, table driver 200 will produce the right words, right plurals and correct use of “and”.

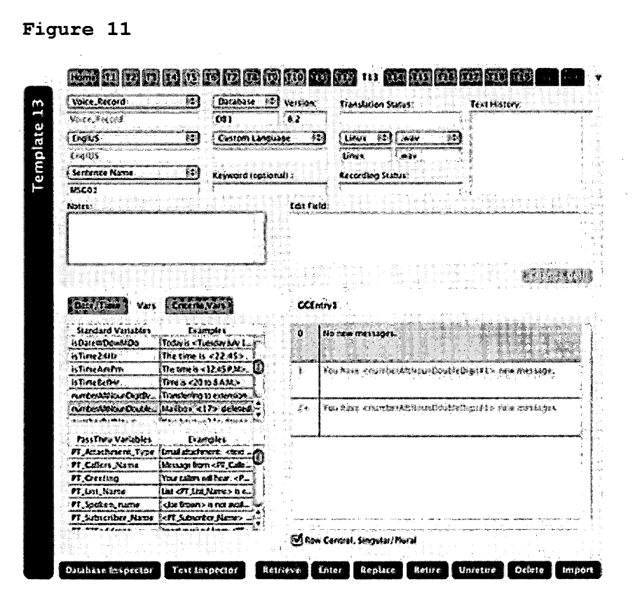

With specific reference now to FIG. 11, exemplary template 30e may preferably be utilized to accommodate for “nested conditionals”, such as “You have <number> message/s.” Accordingly, if x=0, then at run-time, the foregoing sentence will appear as “You have no messages.”, else (You have mail.), if y=1 then “You have one new message.”, or, if y=2 then “You have two new messages.”, or, if y=3 then “You have three new messages.”, (To hear your messages, press 1) end if.

Notably, with conventional approaches, multiple lines of code (7+ lines) are required. Additionally, manual reprogramming or manual changes to data tables is required in order to accommodate numberset choices. Changes may be required for “you have”, which may be singular or plural, and may or may not appear at the end of the sentence. Plus the multiple plural selections must be manually inserted, as explained above, and the “choose plural by the last digit” also requires manual manipulation.

However, contrary to such conventional processes, through system 10, the required code will only be a few short code lines to replace hundreds of hard code lines from the conventional method. Table driver 200, and associated extract files 72 and algorithms, of system 10 will determine which numberset is correct for the sentence. System 10 will reorder the prompts, if necessary, provide the proper “you have” wherever it should be located in the sentence, and choose the proper plural, including plural choices based upon the last digit of a number.

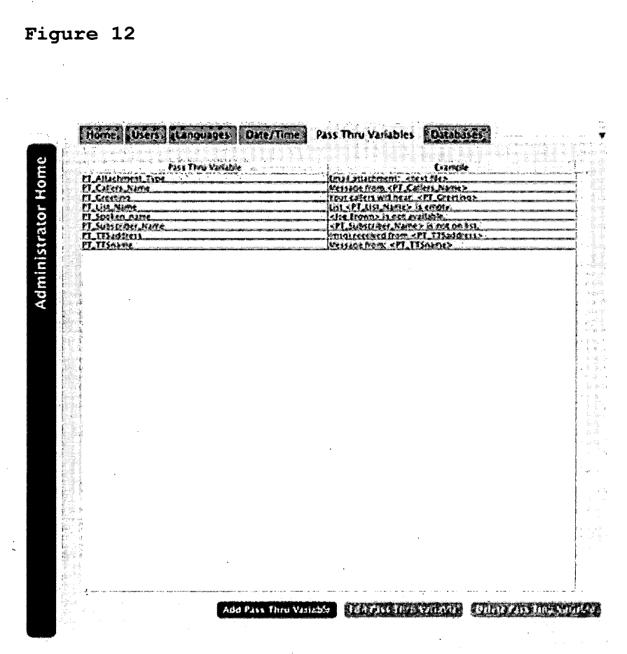

With specific reference now to FIG. 12, exemplary template 30f may preferably be utilized to accommodate for “pass thru variables”, such as “To leave a message for <Spoken_name> press 1.” Accordingly, at run-time, the foregoing sentence may appear as “To leave a message for Joe Brown, press 1.”

Notably, conventional approaches will work if the pass thru is always identical. However, many countries desire basic information spoken in a different way. Almost all such requests are currently ignored by developers due to the reprogramming changes required in such conventional systems.

However, contrary to such conventional processes, system 10 will not process such pass thru variables, but will rather simply permit such variables to “pass thru” to the host application as received for the host application to process, but quite possibly in a different order to assure that the grammar is perfect in any target language. Through system 10, the order of appearance can be changed in seconds depending upon the language, without reprogramming or changes to data tables. By way of example: English-based telephony systems will ask: “Enter the date you wish to receive your order. Enter 2 digits for the Month, 2 digits for the Day, and 2 digits for the Year.” However, the following is not the sequence of a system created in France or Spain or Italy, wherein a native system would ask for the “Day” and then the “Month.” In Asia, the year is spoken first, and thus the entry order should be “Year-Month-Day” or “Year-Day-Month,” according to the specific Asian country. System 10 can re-order the information for the specific country, yet inform the application in a manner it can process. By way of another example, because there are many people in Korea with the last name of “Kim”, a system should search a directory by the first name, then last name; but the difficulties in conventional reprogramming efforts have left this need virtually ignored. System 10 can change the search priority.

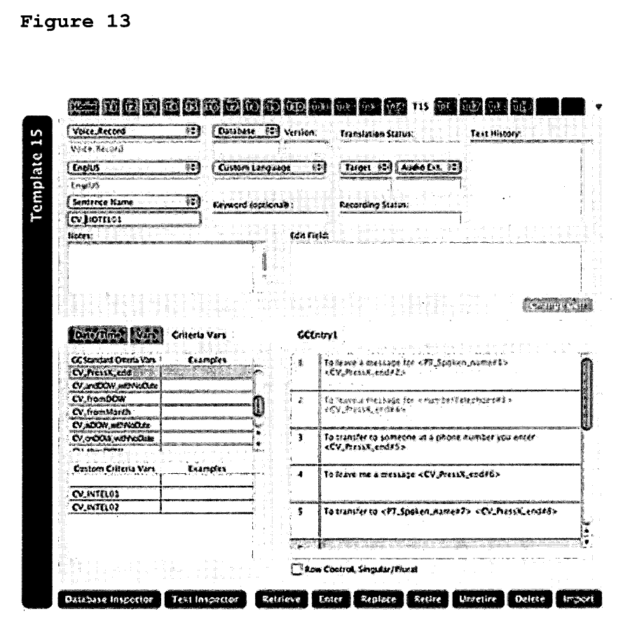

With specific reference now to FIG. 13, exemplary template 30g may preferably be utilized to accommodate for “criteria variables—multiple choice”, such as:

If user press 1: To leave a message

for<PT_Spoken_name#1><CV_PressX_end#2>

If user press 2: To leave a message

for<numberTelephone#3><CV_PressX_end#4>

If user press 3: To transfer

to<PT_Spoken_name#7><CV_PressX_end#8>

If user press 4: To transfer

to<numberTelephone#9><CV_PressX_end#10>

If user press 5: To listen to the automated attendant

menu <CV_PressX_end#12>

Accordingly, at run-time, the foregoing sentences may appear as “To leave a message for Joe Brown Press 5”, “To leave a message for 7-7-0-4-1-4-6-0-0-3 press 7”, “To transfer to Joe Brown press 8”, “To transfer to 770.414.6003 press 9”, and, “To listen to the automated attendant menu press star.”

Notably, with conventional approaches, reprogramming or changes to data tables are mandatory for each and every instance of the foregoing. Moreover, the numbers a phone user is required to press or speak (press 4, press 8, say 4, say 8, etc.) often vary with a version, country or customer. All such exceptions must be manually made in conventional system code or data-tables, and must be made with great accuracy. That is, if in Dutch it should be “press 4”, but in French it should be “press 3”, one single typing error could cause such systems to cease to function properly.

However, contrary to such conventional processes, programming is unchanged in system 10, and the numbers to press can be changed directly and quickly inside graphical user interface 20. Further, all changes can be verified. A wide variety of “re-routing” can be done by just using template 30g of graphical user interface 20, wherein any multiple-choice is covered, whether multiple choice of voice prompts, text, pictures, video, multimedia or other.

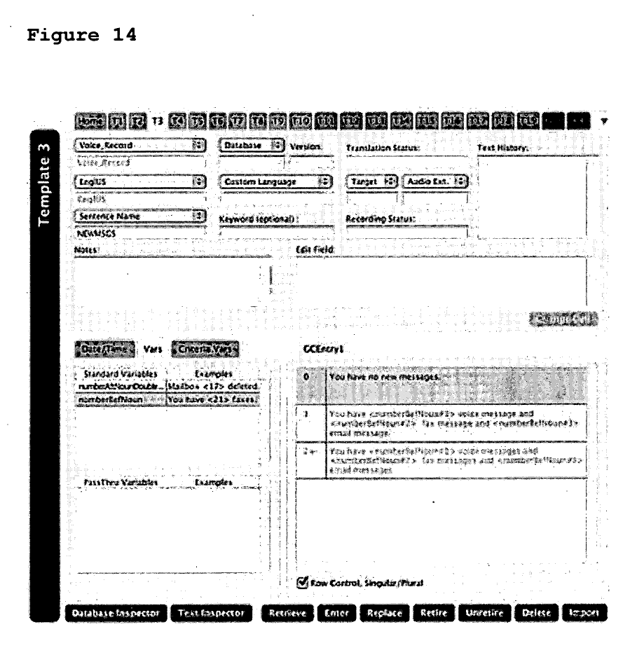

With specific reference now to FIG. 14, exemplary template 30h may preferably be utilized to accommodate for “repeat single variables”, such as:

“You have deleted the following mailboxes:
<number>
<number>
<number>
<number>

To confirm delete, press 1.”

Accordingly, at run-time, the foregoing sentence may appear as:

“You have deleted the following mailboxes:
1388
2199
2345
5432

To confirm delete, press 1.”

Notably, with conventional approaches, reprogramming or changes to data tables is required in order to accommodate for change of numberset. Further, in order to ease the complex programming, developers avoid using the natural way to say such numbers. It is not “natural” to say: 1-3-8-8. It is natural to say “13-88”. Moreover, in some countries, mailboxes and extensions are spoken as compound numbers, “1 thousand 3 hundred eighty eight”. Thus, developers have reduced the quality of conventional systems in order to use easier programming.

However, contrary to such conventional processes, table driver 200, and associated extract files 72 and algorithms, of system 10 perform the foregoing complex numbers management by choosing the correct numberset to indicate the correct way to speak each number for each circumstance.

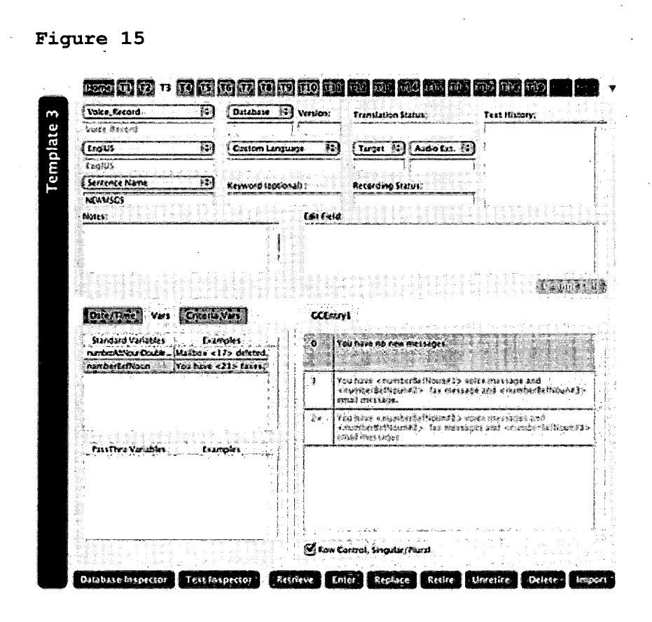

With specific reference now to FIG. 15, exemplary template 30i may preferably be utilized to accommodate for “compound numbers”, such as “Your bank balance is <number> dollars and <number> cents.” Accordingly, at run-time, the foregoing sentence may appear, in English, as “Your account balance is 111,080 dollars and 21 cents.”, but appear in Chinese as “11-mon 1-thousand zero-hundred 80 dollar your account balance is.”

Notably, with conventional approaches, reprogramming or changes to data tables is required in order to accommodate for different text order for various languages. In various other languages, the foregoing sentence may appear as “$111,030.21 your account balance is.” or could be “Your account balance $111,030.21 is.”, or other various constructions. Additionally, changes must be made to choose the numberset for the international currency (native “dollars” and “cents”), and both elements (dollars and cents) generally use different numbersets. As for compound numbers, there are 3 major international compound number structures. Most Asian languages have a special word for 10,000 which changes all concatenation programming thereafter. Many languages have a special word for 100,000, which also changes all concatenation programming thereafter. Still further, many Asian languages have a special word for 10,000,000 and/or 100,000,000 which changes all concatenation programming thereafter. Moreover, many languages speak a “zero” amount if there are zero of one element of a number (ex., “thousand zero hundred 21”).

However, contrary to such conventional processes, table driver 200 of system 10 comprises compound number driver 220, which, along with extract files 72 and algorithms, provide all proper numbersets, and pass the correct prompts for spoken compound numbers in the exact concatenation pattern required for the language. System 10 further provides for all “zero” numbers that may be required, as well as all “counters” (i.e., counters are syllables spoken after a number and before the noun in many languages—which counter to use is usually based upon the shape of the object, though other languages use other factors).

Such proper playback and text for compound numbers is achieved through a specific manner of housing and cross-referencing numberset fields, divided into various sub-fields, such as “first” or “even” and “plus” fields, and differentiating spoken/written numbers according to their placement in the entire numeric series. For example, “2” of “2145” being a “first”, as this has no preceding number; “2” of “2000” being “even” as there are no following digits other than “0”; “1” in “2133” being a “plus type 1” in the middle of a full number (being 2 thousand plus “1xx”); and, “45” of “2345” being “plus type 2” because this is the end of the numeric string (in this position, i.e. plus final digits “45”). Because numbers are often spoken differently around the world, whether such numbers are “first”, “even”, “plus type 1” or “plus type 2”, the provision for multiple versions of each single numeric unit create numbers that are perfect in every language—such is provided via use of table driver 200 and same original code. A simple example of difference of use is that many languages speak 1,024 as “thousand 24”, where the “thousand” is the “first” numeric element. But in 201,024 the “1” would include the word “one” for “one thousand”, as this version of thousand is a “plus type 1” in the middle of a number, and will thus speak as “two hundred one thousand 24”.

The main segments of compound numbers are broken down into basic components:

A. Digits 0-99,, plus a 2^{nd} zero position;

B. Hundreds 0-9, plus a 2^{nd} zero position;

C. Thousands 0-99, plus a 2^{nd} zero position;

D. Hundred thousands 0-9, plus a 2^{nd} zero position;

E. Millions 0-99, plus a 2^{nd} zero position;

E. Hundred millions 0-9, plus a 2^{nd} zero position;

G. Billions 0-99, plus a 2^{nd} zero position; and, so on.

For each of the number main fields A-G, there are preferably four (4) redundant “copies” of each. In English, where there is only one way to speak “one hundred”, all four fields will have identical content. But for Mandarin or Russian or other languages, one field—for example, a “plus type 1” field—may have “one hundred” in the 100 position, but another field—for example, the “even” field—will have “hundred” in the 100 position. All, some, one or none of the number entries in the various fields may vary, or not, from its counterparts in the other affiliated fields according to the grammatical requirements of the language.

Each field of numbers begins with a “zero”, rather than “1” as in English, because many languages speak the digit in every decimal position albeit a “zero”. The purpose served by the 2^{nd} zero position is an allowance for several languages that will either speak a second zero in a row differently than the first (i.e. for 2004), or that speak the 2^{nd} zero but never a 3^{rd} or 4^{th} zero (i.e. for 20004).

International numbers are extremely complex, going far beyond the foregoing examples in their vagaries and differences, including both spoken and written. All such issues are resolved via the present system 10.

Specifically, and with reference to the compound numbers rules embodied in Table 21 hereinbelow, table driver 200 also processes all words, text or symbols surrounding the compound numbers in the proper manner for the target language or culture. For example, the screen text components of a U.S. price $10,101.25 uses the “$” currency symbol, followed by thousands, followed by comma, followed by a number between 0 and 999, followed by period, followed by the number “25” (representing cents). In Europe, the same number must be processed with the comma and period reversed, and the currency symbol at the end: 10.101,25 [symbol] . On the other hand, in speaking a currency amount, the “$” is spoken at the end of the number rather than at the beginning (i.e. ten thousand dollars). Thus, spoken audio application variations on numbers must be processed in an entirely different order than the screen text versions thereof. Such differences and others in the written appearance of compound numbers is achieved by system 10 through use of a series of “conjunctions” in the process logic. “Conjunction” can be a text element (i.e. $, comma, or period) or can be spoken words such as “and” or “dollars” or “cents”, and the like. There are “conjunctions” before and after each numeric field for processing. Additionally, there is a set of conjunctions, called “EndConjunctions” that are processed half at the beginning—before processing of the number itself—and the other half processed at the end, after the entire number has been processed.

The conjunctions are contained in a single n line with fourteen (14) sub-fields, and each sub-field can have more than one value, i.e. “x” for text or “xxx” for audio voice prompt. The 14 sub-fields are as follows:

Before-1|Before-2|Before-3|Before-4|Before-5|Before-6|Before-7

After-6|After-7|After-8|After-9|After-10|After-11|After-12|After-13|After-14

The first seven (7) sub-fields are “before conjunctions,” appearing/playing before a specific numeric element, and the last seven (7) are “after conjunctions,” appearing/playing after the specific numeric element—“mirror images” of one other with respect to the number field that each sub-field modifies.

One or more conjunctions may either lead or follow a particular piece of numeric data—data that is considered according to its respective field (A-G and its variations above). There may be up to seven conjunctions before and/or after numeric data, for a grand total of fourteen possible conjunctions. The pattern of use for these 14 conjunctions is as follows:

1. BEFORE—ALWAYS

2. BEFORE—EVEN

3. BEFORE—NON-EVEN

4. BEFORE—PLUS EVEN

5. BEFORE—PLUS NON-EVEN

6. BEFORE—MID-ARRAY

7. BEFORE—IF DATA
(numeric data plays/displays here)

8. AFTER—IF DATA

9. AFTER—MID-ARRAY

10. AFTER—PLUS NON-EVEN

11. AFTER—PLUS EVEN

12. AFTER—NON-EVEN

13. AFTER—EVEN

14. AFTER—ALWAYS

Wherein the foregoing utilize the following definitions:

ALWAYS: This conjunction will be played/displayed no matter what—even if there is no numeric data to be drawn from the related field. It is unique in this aspect; all the other conjunctions will only be used if data is present.

EVEN: This conjunction will be played/displayed if the current number is non-zero, and all the numbers to the right of it are zero. This should not be confused with the mathematical definition of “even”, which means divisible by two.

NON-EVEN: This conjunction will be played/displayed if the current number is non-zero, and any one or more numbers to the right of it is/are not zero.

The following chart shows examples of even and non-even numbers.

| Number | Even or non-even |
|---|---|
| 300 | Even hundred |
| 312 | Non-even hundred |
| 350 | Non-even hundred |
| 1,000 | Even thousand |
| 1,001 | Non-even thousand |
| 500,000 | Even hundred-thousand |
| 501,000 | Non-even hundred-thousand, BUT |
| | even thousand |

PLUS: This conjunction is used if the particular numeric data element is not the highest. Consider the last example in the EVEN/NON-EVEN chart (hereinabove), 501,000, which, after splitting, will become two numbers: 500,000, and 1,000, in that order. The 500,000 component is the highest component (or “first component”), therefore any conjunctions of the PLUS type are ignored when processing the concatenation for this piece. However, the 1,000 component is not the highest; therefore it is a “plus” component—and conjunctions of the PLUS type are relevant when concatenating this piece. Additionally, as the 1,000 component is also an even number (as defined above), then the appropriate conjunction type is “PLUS EVEN”.
MID-ARRAY: This conjunction type is relevant depending on how the item was split. A number is said to be split into an “array,” where each element of the array represents one particular piece of the original number to be processed. For example, the number 123 is split into two pieces: 100 (1^{st} array element) and 23 (2^{nd} array element). The mid-array conjunction is used when the piece being processed is not the first or last piece; i.e., somewhere in the middle of the array. The example of 123 could never use mid-array conjunctions because it only divides into two pieces, but the number 1234 might, because it is split into 1000, 200, and 34. In this case, the mid-array element is 200, and if this has a mid-array conjunction defined for it, then such will be implemented by the present system 10. To even further clarify the foregoing example, it might be assumed that the BEFORE_MID_ARRAY conjunction is defined as a “one second pause”, which would result in the number being spoken as “one thousand (pause) two hundred thirty four” when output—the “pause” is placed before the middle element (“200”).
IF DATA: This conjunction is used simply if data exists—whether it is even or non-even, plus or non-plus, mid-array or first/last. An example would be the dollar sign which leads a monetary number; no matter what the actual number, there should always be a dollar sign preceding it. But, if there is no number at all (i.e., no data), then the dollar sign should not be printed.

There are almost unlimited possibilities for variations on each conjunction n line. Meaning, there is not just one conjunction line for one numeric data field. Rather each conjunction line can be assigned a name or “style”, allowing for almost infinite variation on results. For example, a PlusDigitsConjunction may be called “Conj_Euro” which conjunction set supports currency display in Euros (i.e. 22,05 [symbol] ), and another style of PlusDigitsConjunction may be called “Conj_USD” which conjunction set supports currency display in U.S. Dollars (i.e. $22.05)

Accordingly, the following applies to the above-enumerated sub-fields:

#1 has the same properties as #14

#2 has the same properties as #13

#3 has the same properties as #12

#4 has the same properties as #11

#5 has the same properties as #10

#6 has the same properties as #9

#7 has the same properties as #8

As a further example of use of conjunctions, with regard to sub-fields #7 and #8, the conjunction n line content field thereof plays as long as there is some content being taken from the upcoming field, the numeric content for processing. So, the first “before conjunction” sub-field #7 is always played, and the first “after conjunction” sub-field #8 is always played, as long as the numeric content field it precedes or follows, respectively, will draw content. For example, if the number is 2420 and PlusDigitsConjunction n line contains “and” in its sub-field #7, then the result will be “two-thousand four-hundred and twenty”. But if the number is 2400, then the EvenThousand field will be played with no “and”, because no PlusDigits are being selected, resulting in “two-thousand four-hundred” (or “twenty-four-hundred” depending upon the content of that EvenThousand field).

With regard to sub-fields #4 and #11, the conjunction n line content field numbers thereof play as long as there is some content being taken from the upcoming field, and that content field has a name that contains the word “PlusEven.” For example, if the number is 220000 and PlusDigitsConjunction n line contains “and” in its sub-field #4, then the result will be two-hundred and twenty-thousand. The basic purpose of n line sub-fields 4 and 11 is to provide a place for something to appear (text) or play (audio) that is only attached to the last step in the entire numeric ladder, which would be a “PlusEven” field, such as an ending of “100” in 2,100 or “24,000” or 224,000.

With regard to sub-fields #1 and #14, the conjunction n line content sub-fields thereof always play, regardless of whether there is some content being taken from the upcoming field.

With regard to sub-fields #6 and #9, conjunction n line content sub-field numbers 6 and 9 will play only if appears in a mid array element, and preferably not first or last.

With regard to sub-fields #1 and #14, conjunction n line content sub-fields thereof always play no matter what—whether or not there is some content being taken from the upcoming field. As such, the first “before conjunction”, sub-field #1, is always played, and the first “after conjunction”, sub-field #14, is always played regardless of whether the field it precedes or follows will draw content. For example, if the number is $20.20 and the PlusDigitsConjunction n line style in use with the numberset for dollars contains the audio conjunction words “dollars and” in its sub-field #14, and DigitsConjunction n line style in use with the numberset for cents contains audio conjunction “cents” in its sub-field #14, the spoken result is “twenty dollars and twenty cents”. Importantly, dollars and cents are processed as two entirely different numbersets by table driver 200. Thus, if there were no cents, no numeric for cents would be processed for that currency amount, and quite possibly a different DigitConjunction style would be selected as well.

Throughout the entire globalization process of the present invention, and all of its components, “0” or “00” of everything have special handling, thus, in this case, there is no overlap, and no accidental erroneous plays such as “four dollars cents”. As another example, consider the number “10020 22”, which, if comprised of 1^{st} part “10020” and it's 2^{nd} part, “22”, would appear as “10,020.22” in English, “10.020,02” in French, “10020,22” in Chinese, and “10 020 py [symbol] . 22 Λoπ.” in Russian through proper use of the conjunctions.

With regard to the end conjunctions, this set of conjunctions sub-fields are split in half, with the first 7 “before conjunctions” sub-fields playing at the beginning of entire number to be processed, and the last 7 “after conjunctions” sub-fields playing after the number has been processed to completion. These end conjunctions function similarly to the foregoing described conjunctions, except that the “before” and “after” groups of the end conjunctions are split to encompass the entire number calculation. The EndConjunction n line content sub-fields #7 and #8 play as long as there is a number to be calculated. The “beginning” EndConjunction n line content sub-field #7 plays/displays as long as there is a number to be calculated, and plays/displays before processing begins. EndConjunction n line content sub-field #8 plays/displays as long as there is a number to be calculated, and then plays/displays after anything else. For example, if the number is 770 and EndConjunction n line contains “(” in its sub-field #7, and “)” in its sub-field #8, the result is (770), as in the U.S. punctuation for telephone area codes. Other countries do not use parentheses, but may use a (slash), “.” (period), space, or nothing at all. If the number is 770 and EndConjunction n line contains “$” in its sub-field #7, the result is $770. If the number is 770 and EndConjunction n line contains “¥” in its sub-field #8, the result is “770¥”. If the number is 770 and EndConjunction n line contains the text “Area Code” in its sub-field #7, the result is “Area Code 770”, and so on.

To help table driver 200 decide which of the various ways to “split” numbers (telephone, compound, address or other), a series of “splitter style lines” are included inside extract 72. These styles are exploited by subroutine(s) in table driver 200, to produce the desired results as explained hereinabove. Some splitter styles have the added complexity of having to cross over languages. Consider telephone number styles. Splitter styles preferably determine into what groups a phone number would be broken. Thus, the American splitter style may preferably be used to split a normal, ten digit telephone number into parts for a call originating for or from the USA, then process those parts with numbersets and conjunctions, to produce:

7705113333 spliting into (770) 511-3333

Likewise, the British style would be used to split a British number into parts, then process those parts with numbersets and conjunctions, to produce:

0203434455 spliting into +20-343 4455

However, for out-of-country calls, the splitter style is exchanged by the code, transferring to the style of the destination country. Thus, a call from the UK to the US would produce:

0017705113333 spliting into 00 1 (770) 511-3333

Whereas a call from the US to the UK would produce:

01144203434455 spliting into 011 44 20-343 4455.

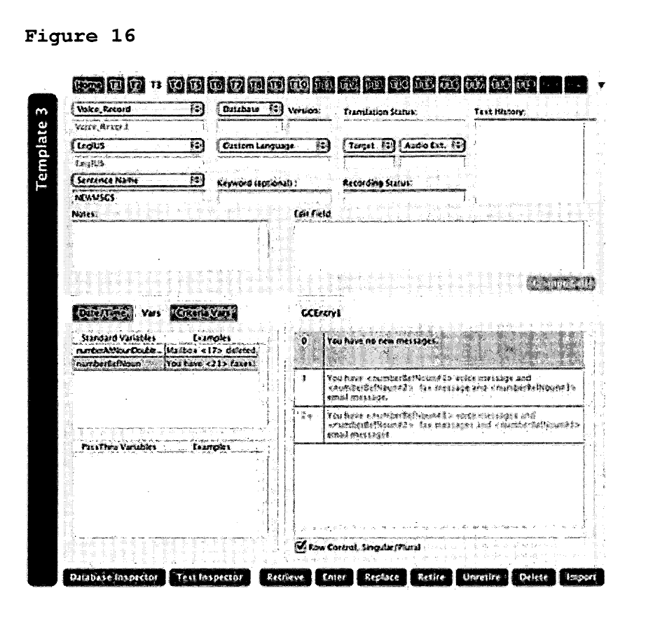

With specific reference now to FIG. 16, exemplary template 30j may preferably be utilized to accommodate for “international telephone numbers and addresses”, such as “Message sent to: <telephone>”, or “The address is: <number,street,direction>. For telephone numbers, with conventional systems, at run-time, “Message sent to: <telephone>”may be spoken as “Message sent to: 7.7.0.4.1.6.6.4.2.3”. However, with system 10, the foregoing sentence, at run-time, may be spoken as:

“Message sent to <7.7.0.4.1.4.4.7.0.0> becomes:
USA 7.7.oh.4.1.4.forty-seven-hundred
U.K. double-seven oh.4.1.double-four.7.double-oh
France seven hundred seventy.41.66.four hundred.23.

Notably, with conventional approaches, reprogramming or changes to data tables is required in order to accommodate for the variety of spoken telephone number styles worldwide. The result is that almost no companies play numbers properly around the world, defaulting to digit-by-digit (7.7.0.4.1.6.6.4.2.3), which decreases sales and lowers the product quality.

However, contrary to such conventional processes, table driver 200 of system 10 comprises international telephone and address driver 230, which, along with extract files 72 and algorithms, inform the host system of all proper prompts to play, and pass the correct prompt names for spoken telephone numbers in the exact concatenation pattern required for the language, and also pass the written text forms of telephone numbers, including all variations of punctuation and symbols, in the proper order.

International telephone and address driver 230 also correctly processes variations on telephone numbers, which are often spoken differently around the world, such as extension numbers, fax numbers, speed dial numbers, and so on.

For addresses, conventional systems process addresses in the same manner as telephones, digit-by-digit, in the play-order of the programmer. Any other variations must be specially hard coded. Use of telephone and address driver 230 of table driver 200 produces natural, human speech patterns, such as:

The address is: <2.2.4.5 Grand Street>

U.S.: twenty-two forty-five Grand Street

U.K.: double-two forty-five Grand Street

Latin Based: street Grand number twenty-two forty-five

Asia: Grand Street two two four five

Other: two thousand two hundred forty five Grand Street

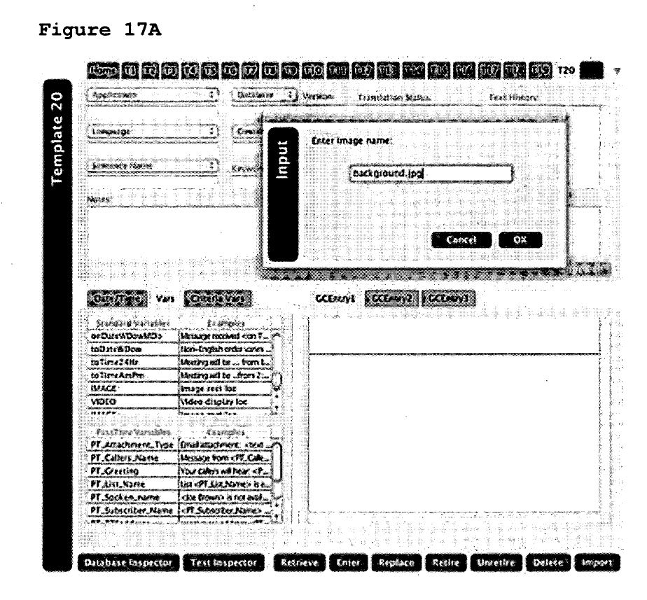

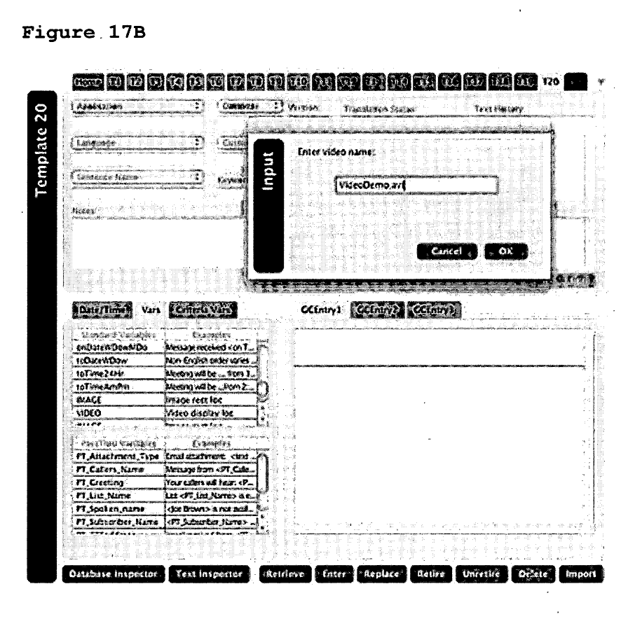

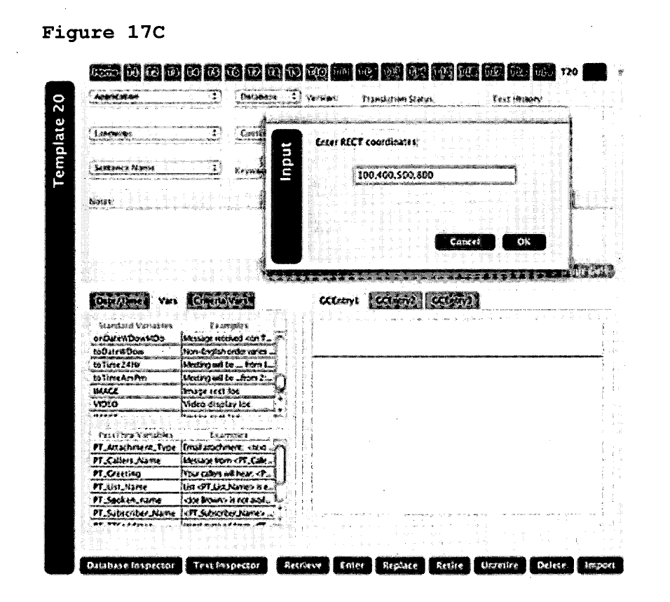

With specific reference now to FIGS. 17A-C, exemplary template 30k may preferably be utilized to accommodate for “pictures, video and multimedia and other customization”, such as:

“Fruit and Produce:”<picture:background.jpg>+coordinates

“Credit Card”<picture:button1.jpg>+coordinates

“Cash”<picture:button2.jpg>+coordinates

“Debit Card”<picture:button3.jpg>+coordinates

Accordingly, with conventional systems, at run-time, the foregoing may appear as:

Title: Select payment method:

Button 1: Credit Card (+VisaMC.jpg)

Button 2: Cash

Button 3: Debit Card (+DebitCard.jpg)

Unfortunately, with such conventional systems, no changes can be made to the foregoing pattern, text, pictures, or other features, without altering application code or data table.

However, with system 10, at run-time, the foregoing example (with customer-specific customized visual) may appear as:
Title: Select payment method: (showing lower on screen than above Master)
Button 1: Home Depot Card (+HomeDepotCreditCard.jpg) (larger than above “VisaMC.jpg)
Button 2: Cash
Button 3: Other Credit Card (+OtherCreditCard.jpg) (larger than above “VisaMC.jpg)

Through system 10, localization and reformatting of the foregoing is accomplished as follows:

Title: text=“Select payment method:” font:arial48 color:green coor=x,y,z,zz

Button 1: text=“Home Depot Card” font:arial36 coor=x,y,z,zz/image=HomeDepotCreditCard.jpg coor=x,y,z,zz

Button 2: text=“Cash” font:arial36 coor=x,y,z,zz/image=ButtonOval.jpg coor=x,y,z,zz

Button 3: text=“Other Credit Card” font:arial36 coor=x,y,z,zz/image=OtherCreditCard.jpg coor=x,y,z,zz

As such, pictures, video, text locations, size, names, colors, and the like, can all be changed by the client's application simply by assigning the values provided by table driver 200, with no change in application coding or data tables. Moreover, image names and/or paths can be used to vary screen appearance, coordinates can be set, and the timing of appearance can be set to coincide with certain actions or timing.

Furthermore, and as best illustrated in FIG. 17B, video or other multimedia names and/or paths can be changed by language or custom language, coordinates can be set, and the timing of appearance can be set to coincide with certain actions or timing. As such, because setting timing is possible, basic subtitling can be created.

Moreover, and as best illustrated in FIG. 17C, all media can be set for almost any information the developer chooses. Standard information includes image size, font size, colors, timing, coordinates, shape, method of appearance and fade away, and any other information a developer might need at run-time. System 10 does not make the actions happen, it informs the host application what needs to be done, and the developers own code puts all actions in motion.

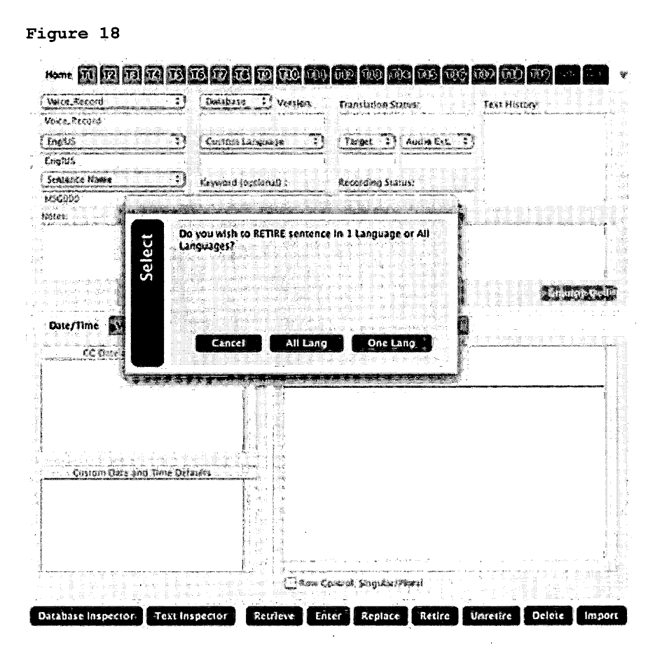

With specific reference now to FIG. 18, exemplary template 301 may preferably be utilized to create a new version of a localized application, a shorter version, and/or different versions by country, language or custom language. Version names can be entered in the database “Version” field 31a of template 301, and an extract file 72 or localized hard code (the latter created from hard code generator 60) produced for only the entries that qualify. Alternatively, a list of desired masters for a selected language can be pasted into “Control” field 31b of template 301, and an extract file 72 or localized hard code will be produced only for those masters on the list.

Additionally, masters (sentences, paragraphs, etc.) can be added and “retired” freely, and further deleted with an applicable administrator password. Retiring masters is recommended, rather than deletion, as the same database entries can be “unretired” and brought back to life, with all associated translations and recordings, at any time.

Referring now more specifically to translation management 50 of graphical user interface 20, system 10 preferably utilizes same to facilitate the handling or management of translations. Translations, particularly those in character languages outside the experience of the developer, can be difficult to handle and manipulate without damaging the text. Moreover, users are often too hesitant to handle characters that they cannot read.

With conventional systems, developers force translators to work inside spreadsheet type files for the convenience of the developer, not the convenience of the translator. However, spreadsheets are often the worst possible environment for a translator. A good translator is an artist. For a good translator to do a truly fine job, creating natural text with maximum fine composition, translators need the freedom of word processing type software, with open spaces, not tiny cells. A translator's quality of translation will deteriorate when typed in spreadsheet format. The more often the translator types in spreadsheet or table format, the worse the translations become over time. The worse the translation becomes, the less products the owner will sell.

System 10 enables translators to function in their preferred environment, yet provides an automated text-to-database import feature (via translation management 50) necessary for good database maintenance. Preferably, such an environment of freedom further provides the translator everything he/she requires to ensure accurate results.

Many client applications present short, disembodied phrases for translation, such as “You have . . . ” or “deleted”, without regard to the fact that the translation must change according to “what” it is that “you have”, or “what” has been “deleted”. These phrases are usually called prompts, and are parts of sentences to be later concatenated together by the client application to form full sentences, inserting any run-time variables or other variables as may be applicable. Moreover, developers re-use these same prompts across the entire system, without understanding that these words must change according to circumstance for 90% of world languages. System 10 rectifies such approaches that prevent an application from functioning properly when translated without reprogramming or data table manipulation.

Accordingly, system 10 has completely resolved the foregoing issue by making all text appear for translation as part of a whole concept. System 10 has brought together the best of both working environments, and eliminated all impediments to ensure excellent translation by providing an ideal environment to achieve high quality translation which provides natural sentences and assures perfect grammar; wherein innovative translator's script layout achieves 99.999% flawless concatenation; wherein “naturalness” of the translation is emotionally attractive to prospective customers—even to their engineers—positively impacting sales; wherein the translator will perform work in his/her favorite word processing environment with the “freedom” of that environment; and wherein translated files will import automatically into assigned record fields in user databases 300.

Referring now more specifically to script management 40, scripts 42 and reports 42a form a vital part of system 10. Script management 40 creates scripts for translation, scripts for recording, scripts of database content, file names, variables by entry, and much more. Information and text can be directly exported from user database 300, or imported into EXCEL, RTF, UNICODE files, printable tables, HTML, XML, delimited lists, and in client proprietary formats.

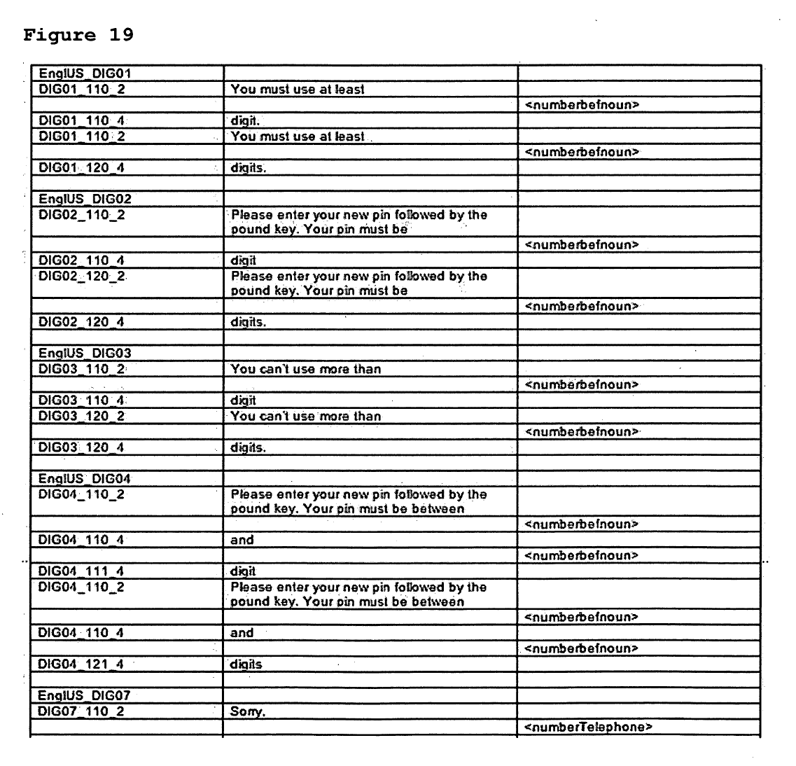

Scripts 42 may be either copy-pasted into a word processing file, such as MS WORD, wherein “Table: Convert Text To Table” is selected, or, alternatively, imported into EXCEL or other spreadsheet software utilizing tab delimiters. An example of a voice talent recording script 42, exported from graphical user interface 20, may be best illustrated with reference to FIG. 19.

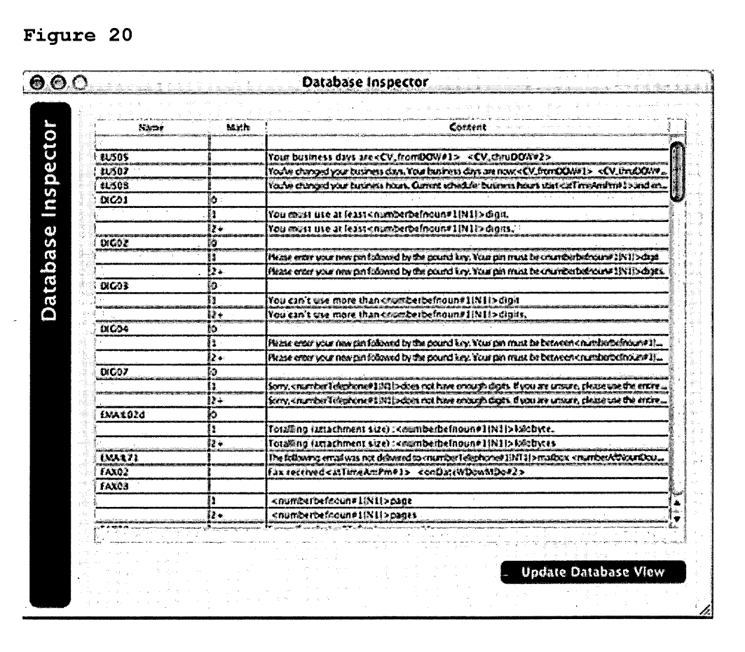

Referring now more specifically to FIG. 20, illustrated therein is an exemplary embodiment of user database(s) 300, depicted as an easily readable composite. The developer may choose and view the desired language, as well as the application type (voice, text only, voice and text). These views are specifically organized for the viewer, and no view fully reflects the special way in which that data is stored in the database, but rather simplifies for user reading purposes.

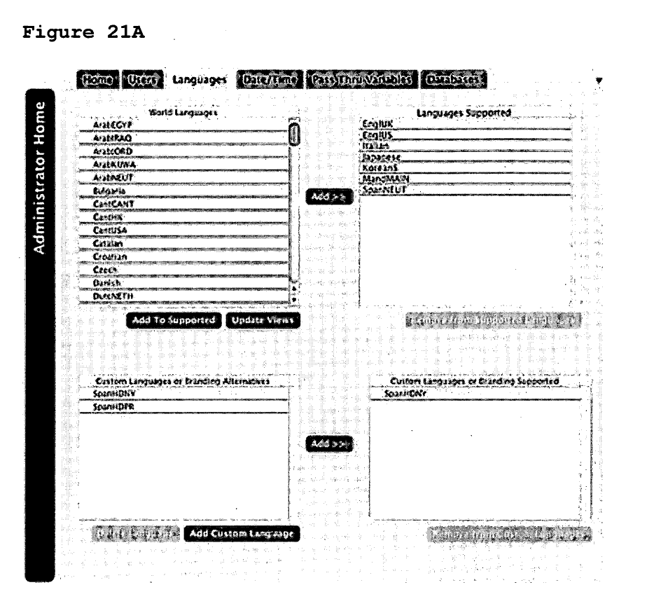

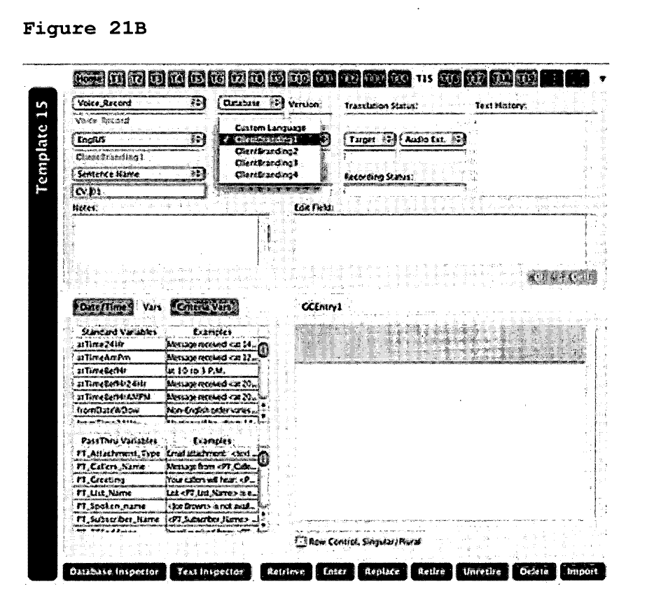

Referring now more specifically to FIGS. 21A-B, the enormous power for customization of system 10 is preferably attributed to the way information is entered (i.e., templates 30, generally) combined with a language hierarchy search pattern. In addition to the over two-hundred languages and dialects from the “normal world” (including character, 2-byte and multi-byte languages), developers can assign an unlimited number of “custom language” names, wherein such custom languages are often associated with a client (ex.: SpanishHOMEDEPOT).

Search by language hierarchy provides maximum versatility in assigning text/image/video/sound via sublanguages. Table driver 200 preferably calls up the proper information required at run-time for the exact location and circumstance. This latter effort is accomplished via a customized language hierarchy, wherein unlimited hierarchies can be assigned. For example, and with regard to HOME DEPOT stores, each store can have its own hierarchy, if desired. Accordingly, the language hierarchy for a HOMEDEPOT store may appear as follows:
1) HomeDepotStore#141
2) HomeDepotSpanishCalifornia
3) HomeDepotSpanish
4) SpanishNeutral (base system entries for this language)

In the above example, for a given sentence (“Please select payment method”), system 10 will search first for a sentence for custom language HomeDepotStore#141. If not found, for a sentence under custom language “HomeDepotSpanishCalifornia”. If not found, for a sentence under custom language “HomeDepotSpanish”. If not found, for a sentence under system original base “SpanishNeutral”. In such a manner, the large set of basic “Spanish Neutral” text/prompts/pictures/videos will be utilized if no other items in the hierarchy are found. Neither programming changes nor data table changes are required. Further, hundreds of custom languages can be created, and a developer can set its/his/her own search pattern.

As best illustrated in FIG. 21A, language names are preferably set in custom language section 21a of administrator home page 21. Thereafter, custom or “normal” world languages identify the language of a particular sentence, and table driver 200 will search in a hierarchal manner for up to eight languages, defaulting to the last language in the list if no version of the other languages is found (see FIG. 21B).

Referring generally now to system 10 and graphical user interface 20, system 10 preferably “tells” the host application or system what needs to be done, and the host system/application performs the action. Accordingly, there are preferably two ways for system 10 to “tell” the host system/application what to do: (1) localized hard code can be automatically generated by hard code generator 60 of graphical user interface 20, and inserted into the host system/application programming either sentence-by-sentence or in peripheral files searched at run-time; or (2) the host system/application can access table driver 200 via one single string of programming valid for all languages and receive back all information required for localization, wherein the host system/application plays, displays, and/or performs the actions utilizing its own methods.

More specifically, with respect to the localized hard code approach, graphical user interface 20 exports localized hard code 62 for any language that has been translated and entered into user database 300. Hard code exports 62 can be in most major programming languages including C, C++, Java, XML, and the like.

Localized hard code generated by hard code generator 60 is usable hard code created by selecting code generation page 22 from graphical user interface 20, in choice of programming language. Generated hard code 62 is fully prepared for the language chosen, and its content and format was based upon the database entries made in graphical user interface 20 and associated databases, combined with algorithms of system 10. Accordingly, a developer can copy-paste exported localized hard code 62 into the host system/application exactly as if it had been entered manually (i.e., “If language is Italian then (paste)”), or, alternatively, the developer can place code 62 in a library, module, jar file, or other archive or location, depending upon the platform of host system/application, wherein the location is searched at run-time (i.e., “go <address> do <hard code>”).

Although generic versions for C+ and XML are provided, many developers of major applications have their own approach to each programming language, and desire “customized hard code”. Hard code export 62 can be customized by a system 10 developer in almost any programming language to be in the same format as the client's application code, utilizing the same method/handler names, subroutine names, and other client-specific indicators and global variables. Thus, the client can utilize the automatically generated XML, C++, Basic code 62 as a guideline for manually typing its/his/her own coding, or prepare system 10 to export code to exact client specifications for quick copy-paste into the client's application at a later date, without fear of error.

Localized hard code exports 62 generated by hard code generator 60 is normal code, and tells the host system/application what to do in the same way that manually typed hard code would. As with regular code, the host system/application locates localized hard code exports 62 and takes the action indicated. Accordingly, the advantage of utilizing generated localized hard code 62 is that it is already correct for a selected language, and its concatenation can be checked in written form, and even audio, before entering into it into the host system/application. Localized hard code 62 further guarantees quality grammar, correct use of numbersets, and the like. Further, the programmer does not have to code manually, nor change a data table. Additionally, because sentences can be added, deleted, and/or retired in graphical user interface 20, any sentences not included in a version, or those that have been delete or “retired”, will not appear in exported hard code 62, making the export perfect for the current state of the host system/application.

Use of table driver 200 logic, subroutines 210, international compound numbers 220, international telephone numbers 230, international addresses 230, plus any results based upon the logic of the 14 conjunctions, included in system 10, is preferably utilized to reproduce the naturalness of human speech patterns. Moreover, hard code inevitably creates enormous over-heavy code blocks (hundreds, thousands or millions of lines) as any hard code will, growing in length and complexity with each localization language, dialect or customization thereof.

With respect to the table driver approach, as a prerequisite, in order to provide the host system/application with commands and information, table driver 200 requires an extract file 72 produced by graphical user interface 20. Extract file 72 contains all information table driver 200 requires for perfect localization and customization.

Table driver 200 is an advantageous approach to driving call-up and concatenation of text, prompts, pictures, multimedia, and the like, utilizing run-time variable information. Table driver 200 may be distinguished from conventional approaches to localization in that table driver 200 makes the decisions previously delegated to the host system/application hard coding or data tables (i.e., table driver 200 is essentially a decision-making engine). That is, table driver 200 makes hard coding or data table changes for localization or customization obsolete.

Table driver 200 is a supplementary software package to system 10, and is designed to work in conjunction with extract file 72 created by graphical user interface 20. Table driver 200 is preferably a C library designed for cross-compilation on a variety of operating systems, and can have JAVA wrap, or the like. Extract file 72 can be thought of as the brains of the high quality translation and concatenation algorithms, and table driver 200 can be thought of as the voice of extract file 72.

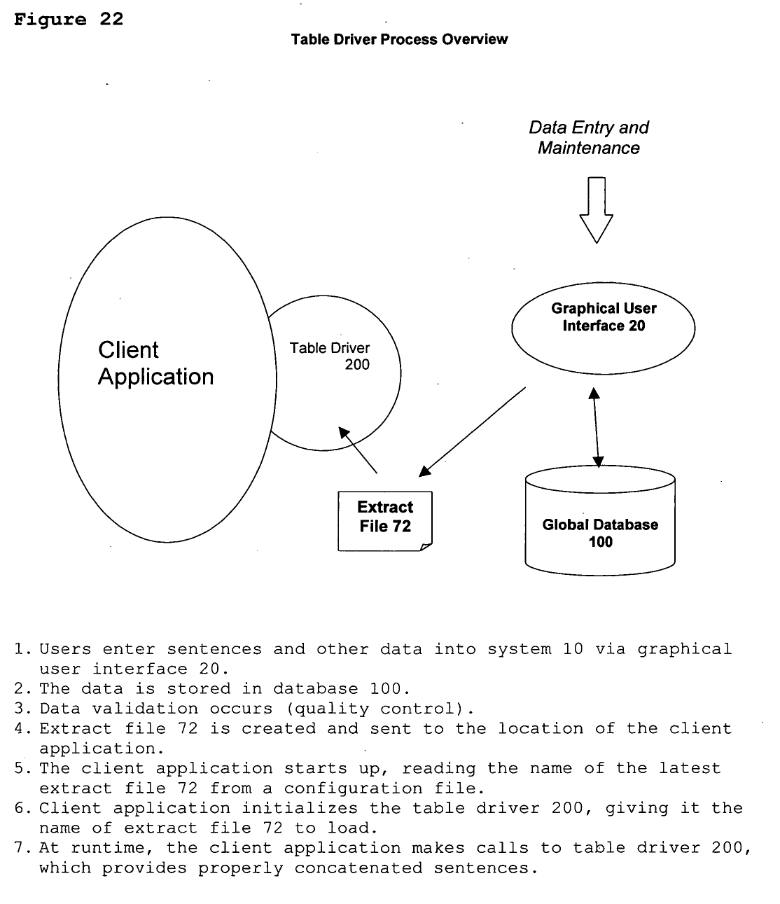

Referring now more specifically to FIGS. 22-37, there are preferably four steps to the table driver approach or process. First, the master text is entered into graphical user interface 20 in whatever language the client prefers. Next, system 10 is utilized to assist translators to create the perfect concatenation in their native tongue. Then, an extract file 72 is exported from graphical user interface 20, and later loaded into table driver 200. Finally, the client application queries table driver 200 to receive the exact text, prompt file names, picture and multimedia names/coordinates—all information for use and concatenation that is required on an as-needed basis at run-time. The same sentence can be represented in any selected language and/or dialect, providing world-class concatenation that sounds perfectly natural to a native speaker without requiring a recompile of the client application, or change to a single line of code.

Table driver 200 is designed to be compiled and linked with an existing application. Table driver 200 presents a simple application program interface (API) consisting of preferably three primary functions: loadGCTableDriver( ), getGCTDList( ), and unloadGCTableDriver( ). Moreover, statistical functions are available to query the state of table driver 200, and provide run-time information such as the time table driver 200 was loaded, how many languages are available, and how many times a sentence has been requested in a particular language.

Accordingly, table driver 200 comprises several features and advantages, including its ability to support over two-hundred languages; its ability to support multiple versions of the same sentence at the same time (in the same language and other languages); its ANSI-C compliancy; availability of test harnesses for unit, acceptance, and regression testing; a static library of compiled objects are available for the operating systems, such as, SOLARIS, LINUX, BSD, UNIX, INCLUDING OS-X; source code of table driver 200 can be utilized on any operating system, including embedded systems; and, table driver 200 is thread safe.

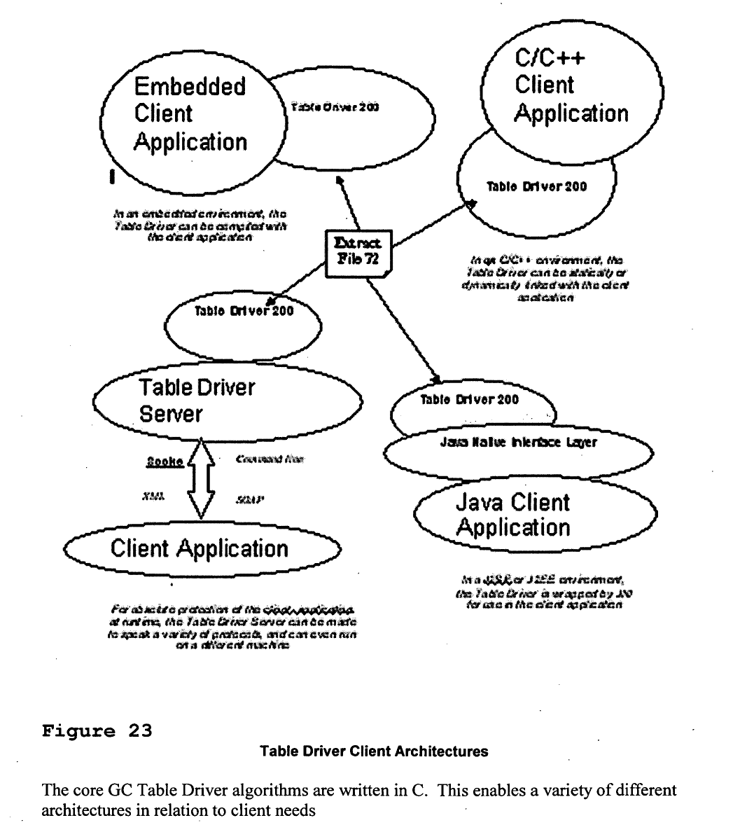

Moreover, and as best illustrated in FIG. 23, because the core algorithms of table driver 200 are written in C, a variety of different architectures in relation to client needs is enabled. As such, in an embedded environment, table driver 200 can be compiled with the client application. In a C/C++ environment, table driver 200 can be statically or dynamically linked with the client application. For absolute protection of the client application at runtime, a table driver 200 server can be made to speak a variety of protocols, and can even run on a different machine. Moreover, in a J2SE or J2EE environment, table driver 200 is wrapped by JNI for use in the client application.

As addressed hereinabove, table driver 200 further includes a mini-application called compound numbers driver 220. Compound numbers are so complex across the world's languages, that almost no applications (possibly none) can handle them properly, and the time consumption to make application properly handle international compound numbers is significant. Moreover, spoken language and written language are not the same, thus concatenation patterns differ for spoken versus written compound numbers.

Compound numbers have three main concatenation schemes worldwide, and hundreds of other individual variations. For example, numbers up to ninety-nine will vary by gender in almost all languages and, as such, use will vary according to the number of objects. Moreover, many languages speak “zero hundred” if there are no hundreds, or speak “zero thousand” if there are no thousands; however, that same language may possibly avoid speaking two “zeros” consecutively (i.e., zero thousand-zero hundred). Some languages cannot concatenate any number ending in “2” to a noun. Still other languages begin new concatenation patterns as of 10,000 with 10,000 having its own word (10,000=1 wan), or start new concatenation patterns as of 100,000 (200,000=2 lak), or do not have a billion (billion=1,000 million). Further, some languages play a different number “2” for 200 than for 2,000, or a different “1” for a number spoken digit-by-digit than for a “1” for “List #1” and different than “1 message”. Additionally, many Slavic languages have a dozen variations on any number, including words for hundreds and thousands, the selection of which varies with the number's location in the sentence (subject, direct object, object of preposition, etc.) plus the gender of the noun modified.

As further addressed hereinabove, table driver 200 additionally comprises a mini-application called international telephone number and address driver 230, which provides the prompt names and information required to display (written text) or play (audio) telephone numbers as they should be according to the language and country around the world. For example, digit-by-digit style (USA 7-7-0-4-1-4-6-0-0-3); double-triple style (U.K., Australia, and the like, 7-70-41-46-double zero-three); or, hundreds style (France, Italy, Spain, and the like, 77-zero-4-hundred-fourteen-sixty-zero three). Furthermore, user interface 20 allows developers to select the telephone style of preference, and table driver 200 will implement that preference, enabling a U.S. telephone to play:

7.7.oh.4.1.4. forty-seven hundred

rather than:

7.7.0.4.1.4.4.7.0.0.

The variation between one and the other is accomplished by a special segment of code in combination with a specific database organization, which includes the facility to assign different numbersets to various parts of a telephone number, i.e. 770 (numberset #12—where “0” is “oh”), 414 (numberset #1—where “0” is “zero”), 6000 (numberset #1). Additionally, depending upon which conjunction line n is called, the word “area code” may be spoken before the 770, and the word “telephone number” could be spoken before the 414-6000, if desired.

Although hard-coding international telephone numbers is quite complex, some companies have done this, with the corresponding high cost of programmer and developer time, plus cost of outside linguists and language specialists, consultants, translation and programming error correction. The vast majority of companies do not even try to meet the world's requirements for telephone numbers.

Brief Overview of Generated Hard Code and Grammars, and Grammar Pre-Recognition:

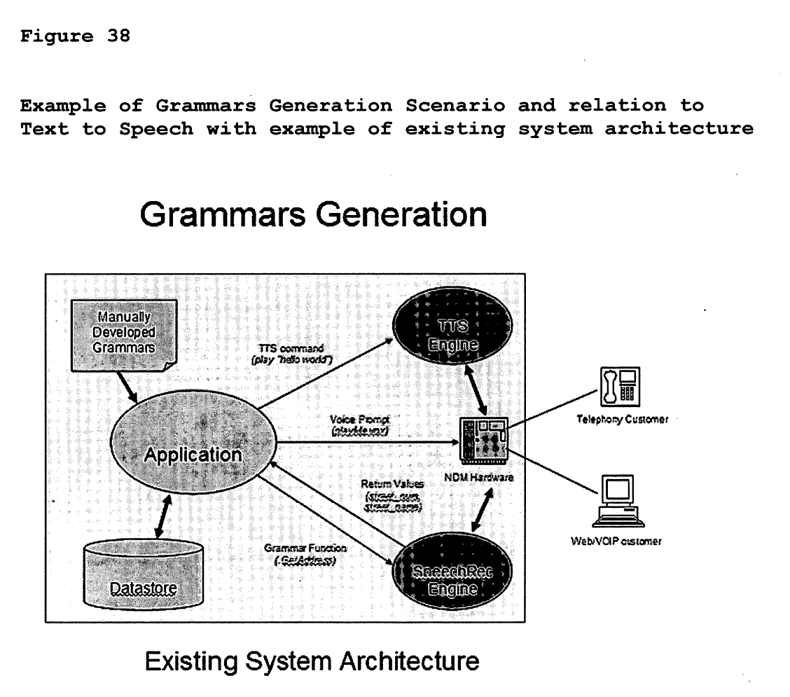

Referring now more specifically to FIGS. 38-42, with continued reference to FIGS. 1-4, for IVR (voice response), speech recognition, speech applications, and other types of applications, table driver 200 used in tandem with extract 72 and/or hard code generator 60A together generate hard code elements—or replace hard code elements—that are required for emerging voice response technologies, and that are generally laboriously prepared manually for each language, with accompanying high cost and intense labor. Accordingly, “grammars”, which are another type of hard code, preferably function, although are not limited to, (1) assisting third-party speech recognition technology to decipher which words that are spoken by a user and are identified as “desirable”; (2) which words are superfluous (and thus need to be eliminated); and, (3) once the desirable words are identified, to assist the system in improving the processed results from th third-party speech technology. With its “grammars” from hard code and/or grammar generator 60A, system 10 adds a further step of natural, “humanity” to the spoken and written word in all languages. Most specifically improved are spoken numbers, street addresses, extensions, pronunciations, suite numbers, mailing addresses, and the like. Plus, generation of these “grammars” in this manner allows the application developer to choose from various date formats, time formats, and the like.

Once the speech recognition technology has identified desirable spoken words, the host application will then take action based upon the results. For many of these results, the host system will preferably request assistance from table driver 200, or from the “grammars” generated by table driver 200 and/or by hard code or grammars 62, in organizing the application's response or answer in the most grammatically perfect and humanly natural manner.

After the host system makes its “decision” concerning what needs to be done, table driver 200 or generated hard code or “grammars” 62 then informs the host system of the text or audio files to use as a response or as an answer to the user. For audio file names, the audio files identified by table driver 200 will preferably be played by the host system to the user or other use made of said audio files. If text or the like, the text results from table driver 200 will preferably be passed to third-party text-to-speech processor, sent to a screen, stored, or similar. Use of table driver 200 in tandem with hard code and grammars 62 makes all of the corrections and improvements offered by the global localization process in responding to information that is only available at run-time.

One of the strengths of hard code or grammar generator 60A when used in tandem with table driver 200, with the resulting capability to produce dynamic “grammars” code and assistance toward speech recognition and processing, is that the words and sounds to be identified, eliminated and/or processed during the speech recognition and response cycle (which are currently generally hard coded into system code), can be removed from the hard code itself, and replaced with variable tokens, the content of which can be updated, translated, modified and changed, swiftly and easily, using user interface 20. Thereafter, user interface 20 issues extract file 72 which feeds table driver 200, and table driver 200 or hard code or grammar generator 60A, or a combination thereof, creates the “grammars” 62. Moreover, such “grammars” can be generated at any time including on a timed periodic basis, thus refreshing the entire set of “grammars” to include any new or changed variable content. Additionally, such “grammars” can be generated wherever table driver 200 or a version thereof is located, and can be internal or external to the machine housing the application, if desired, and the grammars in the machines updated in the manner preferred by the application developer.

User interface 20 and table driver 200 also perform limited auto-translations or auto-lookup, using extract 72 or database 300 as source of information. These auto-translations or auto-lookup can fulfill simplified translation requirements, glossary needs and the like. For example, with a bilingual navigation system for Miami, Texas or California, to speak first an English version of a street address followed by the Spanish version of that street address without participation of a translator or third-party software would be as follows:

Address: <1.2.0.0 Main Street Northwest>

English: 12 hundred Main Street Northwest

Spanish: calle Main noroeste 12.0.0

The auto-translation or auto-lookup can also be used to assure consistency in translation by pre-translating certain glossary words, phrases or repeating text.

Detailed Explanation of Generated Hard Code and Grammars, and Grammar Pre-Recognition:

With continued reference to FIGS. 1-4 and 38-42, hard code blocks of almost unlimited length can be generated either by the user interface hard code feature 60A or by table driver 200 hard code grammar generator feature 60B. The hard code (or grammars, which are also hard code) are preferably a special, customized result, customized to the application developer's code specifications. The generated code or grammars can be in almost any computer programming language.

The main purpose of basic generated hard code 62 is to replace the time consumption required for manual programming for localization of a system. Such hard code will not have the benefit of features only available through table driver 200, such as compound number driver, international telephone and address driver, or table driver 200's hard code grammar generator 60B. Thus, the hard code approach to localization is not the premiere approach, but is desired by certain companies because it mimics their own manual work. The hard code generator 60A located in user interface 20 creates its code based upon the content of fields in global database 300, and ties database entries together with snippets of repetitive code associated with the various types of database entries, which, when strung together, result in usable source code. The hard code that is generated will be based upon a model code block or two or three provided by the application's developer. Once customized, hard code generator 60A will continue to export usable source code in that desired pattern.

Example of One Sentence of Generated Hard Code Localized for Russian Language as xml Programming Language:

```
<sentence id=“ListHasNumEnt” record=“LIS02B”>
  <phrase id=“2” type=“choice” source=“3”>
      <case value=“1 21 31 41 51 61 71 81 91”>
        <audio source=“LIS02B_2_1”>
          co [symbol] ep [symbol] T
        </audio>
      </case>
      <case value=“2 3 4 22 23 24 32 33 34 42 43 44 52 53
54 62 63 64 72 73 74 82 83 84 92 93 94”>
        <audio source=“LIS02B_2_2”>
          co [symbol] ep [symbol] T
        </audio>
      </case>
      <default>
        <audio source=“LIS02B_2_3”>
          co [symbol] ep [symbol] T
        </audio>
      </default>
  </phrase>
  <phrase id=“3” type=“variable” input=“number”>
        <prepend audio=“N7_”>
        </prepend>
  </phrase>
  <phrase id=“4” type=“choice” source=“3”>
      <case value=“1 21 31 41 51 61 71 81 91”>
        <audio source=“LIS02B_4_1”>
          a [symbol] pec
        </audio>
      </case>
      <case value=“2 3 4 22 23 24 32 33 34 42 43 44 52 53
54 62 63 64 72 73 74 82 83 84 92 93 94”>
        <audio source=“LIS02B_4_2”>
          a [symbol] peca
        </audio>
      </case>
      <default>
        <audio source=“LIS02B_4_3”>
          a [symbol] pecoB
        </audio>
    </default>
  </phrase>
</sentence>
```

Example of the Same Sentence as Another Output Format Based Upon Client Model:

LIS02B:ListHasNumEnt|a|||N#3|aflist=LIS02B_4_1,LIS02B_4_2
rule=index ac=4 type=number|||||

Another Sentence as Another Output Format Based Upon Client Model in C++ Programming Language:

```
// Sentence CONF05T24
// Your conference is scheduled to be held  <onDATEwDOW>
<atTIME>. Please call back at that time.
void CBuildCS::Build_CONF05T24(CStringArray& astrFileList,
time_t nTime)
{
  CString str;
  // Uw conferentie is gepland
  astrFileList.Add(_T(“CONF05T24_1”));
  // <onDATEwDOW> /
  struct tm stm;
  GetGMTTime (&nTime, &stm);
  // onDATEwithDOW
  // generate DOW prompt
  str.Format(_T(“onDATEwDOW_DOWBefMO_%d”), stm.tm_mon +
1);
  astrFileList.Add(str);
  // generate DOMBefMo prompt
  str.Format(_T(“onDATEwDOW_DayBefMO_%d”), stm.tm_mday);
  astrFileList.Add(str);
  // generate MONTH prompt
  str.Format(_T(“onDATEwDOW_MONTH_%d”), stm.tm_mon + 1);
  astrFileList.Add(str);
  // <atTIME24> /
    // 24 HOUR TIME CREATION - WITH EXACT HOUR
  // if minute is not 0
  if (stm.tm_min)
  {
    str.Format(_T(“atTIME_24HR_Hour_%d”), stm.tm_hour);
    astrFileList.Add(str);
    str.Format(_T(“atTIME_24HR_MinAftHr_%d”),
stm.tm_min);
    astrFileList.Add(str);
  }
  else
  {
    str.Format(_T(“atTIME_24HR_Hour_%d”), stm.tm_hour);
    astrFileList.Add(str);
  }
  // Gelieve dan terug te bellen.
  astrFileList.Add(_T(“CONF05T24_9”));
}
```

Grammars are a special type of hard code often, but not exclusively, used for speech technology applications: voice response, speech recognition and speech processing. Hard code grammars can be generated either by user interface 20's hard code generator 60A or by table driver 200's hard code grammar generator 60B. The advantage to generating with table driver 200 hard code grammar generator 60B is that the table driver will be located wherever the application is housed—with as many table drivers 200 as there are applications in use. These table drivers 200 can generate hard code grammars 62 offline during quiet or down times, and even generate on a timed basis, wherein the grammars hard code thus produced will already be in the desired physical location. If grammars hard code 62 is generated by user interface 20, then the hard code is preferably transferred to the location/s of the application.

With grammars hard code 62, large blocks of code will be housed in one or more fields in a database. All “translatable” or “customizable” pieces of that code will be changed from hard coded words and replaced with variable token names. The content of these variables can then be managed as text in user interface 20, with all of its relevant features, such as updatability, ease of changes and modifications, hands-on translation management, and the like.

Example of a Line of Original Grammars Hard Code from a Developer:

?([(?[my the] ?[full starting] address is)

In this line, the words in [ ] are a signal to the speech processor that if the processor “hears” the words “my” or “the” or “full” or “starting”, these words are not relevant, and are preferably ignored. The words “address is”, however, are key words that should be passed back to the application so that the application can take action.

However, by including only two words, “my” and “the”, this “trap” is not organized optimally, and completely misses the fact that a user might speak the word “our” instead. The modification of existing code or “trap words” is called tweaking, and is done by developers, and thus is a heavy, laborious and burdensome process imposed on the engineering department. All such labor has been removed by the present system 10.

In preparing the code, and splitting it into sub-components, hard coded words are replaced with variable tokens, which variable tokens may be used often throughout an application, but need only be entered once via system 10. The manner in which the token variables and content are assigned, and the surrounding code snippets and code “punctuation” can vary widely with the application and the needs of the speech processor in use. Example:

From:

?([(?[my the] ?[full starting] address is)

To:

?([(?[A] ?[B] C)

The content of A, B, and C can thus be entered into user interface 20 as entries, and can be added to, edited or modified at any time. Thus, at this point, all content in all languages (variable content and hard code snippets) are housed in global database 300. Thus, grammars can be generated either by hard code generator of the user interface 20 directly using the information in global database 300, or can be generated by the hard code grammar generator of table driver 200.

For translations and localizations of system 10, only the content of the variable tokens need be translated (A, B, C). Later, for other languages, as with the original language, new “trap words” can be added and variable content modified at any time, followed by generation of refreshed grammars when desired.

In this manner, one single code block, created by the original developer, is sufficient for all languages for that event, without limitation. Below is an example of one grammar, and its translation:

Original Grammar Direct from Developer:

```
.GetStartingAddress
[
  (?LIB_UM_UH˜0.01
    ?([(?[my the] ?[full starting] address is)
      ([it's (it is)])] ?LIB_UM_UH˜0.01)
          ESOADS_CORE:a ALL_STREETS:b ) {<street_num $a>
<street_name $b> }
  (?LIB_UM_UH˜0.01
      (the ?street number is ESOADS_CORE:a
        and the ?street name is ALL_STREETS:b) )
{<street_num $a> <street_name $b> }
  (?LIB_UM_UH˜0.01
      (the ?street name is ALL_STREETS:b
        and the ?street number is ESOADS_CORE:a))
{<street_num $a> <street_name $b> }
  Universals˜.001
]
From the above, a skeleton code block template is created
that maximizes use of variable tokens:
.GetStartingAddress
[
  (?LIB_UM_UH˜0.01
    ?([(?[A] ?[B] C)
      ([D])] ?LIB_UM_UH˜0.01)
          ESOADS_CORE:a ALL_STREETS:b ) {<street_num $a>
<street_name $b> }
  (?LIB_UM_UH˜0.01
      ([E] ?F ESOADS_CORE:a
        [G] ?H ALL_STREETS:b) ) {<street_num $a>
<street_name $b> }
  (?LIB_UM_UH˜0.01
      ([E] ?F ALL_STREETS:b
        [G] ?J ESOADS_CORE:a)) {<street_num $a>
<street_name $b> }
  Universals˜.001
]
```

As an example, the content of the variable tokens A-J are entered into global database 300 for the respective language:

ENGLISH:

LIB_UM-UH=um, uh, oh, rrr,mmm, err, . . .

A=my the

B=full starting

C=address is

E=it's it is

F=street number is

G=and the

H=street name is

Universals=again, repeat, start again, what . . .

SPANISH:

LIB_UM-UH=eteh, este, ethteh,um, uh, oh, U, mmmm . . .

A=mi, mis, nuestro, nuestra, nuestros, nuestras, el, la, las, los . . .

B=completo, para empezar, soy al, somos al, soy a la, somos a la . . .

C=la direccion es, a la direccion, a la . . .

E=es, esta, este, son, de, del, de los, de las . . .

F=numero, el number, numero del edificio.

G=y, I, y el, y la, y las, y los . . .

H=nombre de la calle es, el nombre de la calle es, la calles es . . .

Universals=como, otra vez, repetir, volver.

Because the content of the variable tokens is housed in the global database, they can be modified outside the code, and grammars regenerated. Example:

From:

A=my the

To

A=my the our this here

When the actually hard coded grammars are generated (either in user interface 20 or table driver 200), the variables will be combined with the code snippets, to form complete source code.

The hard code grammars are preferably moved outside of the “normal” code area of the application, and “called” by the application's code. One, single main template is preferably created for each code block that will be usable for all languages, often repeating some of the “trap word” variable tokens, to balance the fact that persons of other languages may speak “it is” after the “my street”, rather than before, and so on. Thus, in the skeleton template of the code block, there will often be an increase and repeated use of the same variable tokens to meet the vagaries of spoken language.

Auto-Translation in Grammars Code Generation:

A limited use of auto-translation is incorporated into the table driver version of grammars generation.

Processing Results of Recognition by Speech Processor:

When applications are programmed by developers, they are programmed under assumptions made by that programmer, based upon his/her own language. Thus, and English application will ask:

“Please speak the street address where you are now.”

And the code behind this sentence will almost certainly expect, and be coded for, a spoken return of: (1) house number followed by (2) street name followed by (3) type of street (i.e. 1234 Main Street). Table driver 200 receives the results from the speech processor and can flip the order to properly accommodate the grammatical order of the language of the user, example:

“calle Main numero 1234” (street Main number 1234)

Table driver 200 hard code grammar generator 60B uses a combination of the auto-translation feature and an order specification line, both in the extract, to first identify the text being sent to or coming back from processing in the speech processor, and then to re-order that information into the order preferred by the language in use.

As an example, a street auto-translation line may be presented in various manners in the extract, depending upon the needs of the particular application, and can be a straight word-for-word translation, example:

Access Road=via de acceso

or can be a string of choices, with a specific pattern, and the applicable sub-word/s chosen according to the text or audio usage, including abbreviations, example:

EnglUS|StreetName|Access Road=access rd=Access Rd: vía

de acceso=VÍA DE ACCESO=vía de acceso

EnglUS|StreetName|Expressway=expressway=Expwy.:

autopista=AUTOPISTA=autopista

EnglUS|StreetName|Freeway=freeway=fwy:

autovía=AUTOVÍA=autovía

Note: Spanish does not abbreviate these words.

Then, when “street” words have been identified by table driver 200, the components can be reordered using the “address order” lines. In the below example of address lines, note the diverse order in which addresses are spoken/written for each language. Moreover, proper use of “conjunctions” assures that any screen text, audio and other effects are grammatically perfect when exported from table driver 200.

Address Order Example:

English:
AO|1|FirstNameˆConj_AO1_FirstName|MiddleNameˆConj_AO1_MiddleName|MaternalNameˆConj_AO1_MaternalName|LastNameˆConj_AO1_LastName|JobTitleˆConj_AO1_JobTitle|CompanyN ameˆConj_AO1_CompanyName|StreetNumberˆConj_AO1_StreetN umber|StreetNameˆConj_AO1_StreetName|StreetTypeˆConj_A O1_StreetType|StreetDirectionˆConj_AO1_StreetDirection |FloorˆConj_AO1_Floor|FloorNumˆConj_AO1_Floor Number|Su iteNameˆConj_AO1_SuiteName|SuiteNumberˆConj_AO1_SuiteN umber|CityNameˆConj_AO1_CityName|StateRegionNameˆConj_AO1_StateRegionName|CountyProvinceNameˆConj_AO1_County ProvinceName|ZipCountryCodeˆConj_AO1_ZipCountryCode|Co untrynameˆConj_AO1_CountryName|

Spanish:
AO|2|FirstNameˆConj_AO1_FirstName|MiddleNameˆConj_AO1_MiddleName|MaternalNameˆConj_AO1_MaternalName|LastNameˆConj_AO1_LastName|JobTitleˆConj_AO1_JobTitle|CompanyN ameˆConj_AO1_CompanyName|StreetNameˆConj_AO1_StreetNam e|StreetTypeˆConj_AO1_StreetType|StreetDirectionˆConj_AO1_StreetDirection|StreetNumberˆConj_AO1_StreetNumber |FloorˆConj_AO1_Floor|FloorNumˆConj_AO1_Floor Number|Su iteNameˆConj_AO1_SuiteName|SuiteNumberˆConj_AO1_SuiteN umber|CityNameˆConj_AO1_CityName|StateRegionNameˆConj_AO1_StateRegionName|CountyProvinceNameˆConj_AO1_County ProvinceName|CountryNameˆConj_AO1_CountryName|ZipCount rycodeˆConj_AO1_ZipCountryCode|

Japanese:
AO|3|CountryNameˆConj_AO1_CountryName|StateRegionNameˆConj_AO1_StateRegionName|CountyProvinceNameˆConj_AO1_C ountyProvinceName|CityNameˆConj_AO1_CityName|SuiteNumb erˆConj_AO1_SuiteNumber|SuiteNameˆConj_AO1_SuiteName|F loorNumˆConj_AO1_Floor Number|FloorAConj_AO1_Floor|Stre etNumberˆConj_AO1_StreetNumber|StreetDirectionˆConj_AO1_StreetDirection|StreetTypeˆConj_AO1_StreetType|Stree tNameˆConj_AO1_StreetName|CompanyNameˆConj_AO1_Company Name|JobTitleˆConj_AO1_JobTitle|LastNameˆConj_AO1_Last Name|MaternalNameˆConj_AO1_MaternalName|MiddleNameˆCon j_AO1_MiddleName|FirstNameˆConj_AO1_FirstName|

Table driver 200 reads the Address Order line from left to right, and feeds a list of the components to the host system in the order in which they are found.

The “Sayas” Feature:

An added benefit of grammar generation in this manner using hard code grammar generator 60B of table driver 200, is particularly applicable to words with pronunciation issues. In the hard code, there is a possibility to list the way something is pronounced, either in ABC letters or in phonetic pronunciation symbols. Example:
(eleventh avenue)˜0.00010 {<street_name “11TH AVE NW”><sayas “eleventh avenue northwest”>}
   or, in Spanish:
(avenida once)˜0.00010 {<street_name “11TH AVE NW”><sayas “avenida once al noroeste”>}

In the above, the user spoke only the words “11^{th} avenue”. However, the probabilities indicate that that user is probably at “11^{th} Avenue NW”. The grammar generation feature combined with the limited auto-translation can divide and split to increase the chances of understanding what a user truly means. Example (original from developer (which includes the probability):
(fourteenth street northwest)˜0.00010 {<street_name “14TH ST NW”><sayas “fourteenth street northwest”>}

However, when most people giving their location would not respond, “I am at fourteenth street northwest and Broadway Street Northwest”. Rather, the natural human tendency would be to say, “I am at 14^{th} and Broadway.” Grammar generator 60B not only generates subgroups of an original entry, but then performs auto-translation on them, as well to turn those items into the Spanish version thereof (particularly useful for countries with bilingual population). Example of multiple possibilities generated by grammar generator 60B:
(fourteenth street northwest)˜0.00010 {<street_name “14TH ST NW”><sayas “fourteenth street northwest”>}(fourteenth street)˜0.00010 {<street_name “14TH ST NW”><sayas “fourteenth street northwest”>}(fourteenth)˜0.00010 {<street_name “14TH ST NW”><sayas “fourteenth street northwest”>}
   As the next step in this application would be for the system to confirm the understanding with the user, we hear the following:
“I heard 14^{th} Street Northwest, is that correct? Say ‘yes’ or ‘no’”.

Grammar generator 60B, during its auto-translation process, can also accommodate the confusion that always arises from persons who speak one language at home, but are living in a country of another language, such as Spanish speakers in the U.S. where English and Spanish words and grammar order become confused, especially under circumstances where the “correct” expression might be an English one. Such persons often speak a muddle of the two languages, especially when “put on the spot” by a telephone application with no time to prepare. Grammar generator 60B, using auto-translation, will thus produce more possibilities than one language alone. It will produce all of the English varieties of “11^{th} Avenue Northwest) above, plus auto-translate and auto-reorder possible Spanish equivalents that not only incorporate the “11^{th} and Broadway” possibilities but also the possibility of combining English words with Spanish words. Accordingly, the following is provided:
(avenida once al noroeste)˜0.00010 {<street_name “11TH AVE NW”><sayas “avenida once al noroeste”>}
(avenida once)˜0.00010 {<street_name 11TH AVE NW”><sayas “avenida once al noroeste”>}
(once)˜0.00010 {<street_name “11TH AVE NW”><sayas “avenida once al noroeste”>}
(avenida 11)˜0.00010 {<street_name “11TH AVE NW”><sayas “avenida once al noroeste”>}
(avenida 11 Northwest)˜0.00010 {<street_name “11TH AVE NW”><sayas “avenida once al noroeste”>}
(11 Street noroeste)˜0.00010 {<street_name “11TH AVE NW”><sayas “avenida once al noroeste”>}
   . . . as well as other possibilities to increase successful recognition.

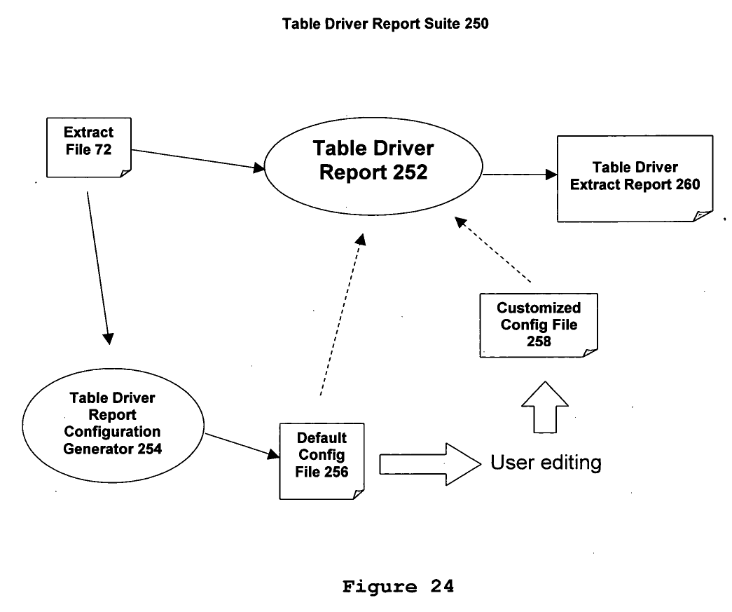

Referring now more specifically to FIG. 24, table driver 200 further comprises table driver reporting suite 250, wherein table driver reporting suite 250 provides a report 252 showing what table driver 200 will return to the client application for a range of possible run-time inputs. Table driver reporting suite 250 preferably operates on an extract file 72. By default, all sentences are reported in all available languages, and the range of numeric variables is 0 to 99. Time/Date variable ranges are preferably the widest allowable (0-59 for minutes, 1-12 for months, etc.), and pass-through variables are set to static data. Accordingly, suite 250 is designed for quality control.

In operation, suite 250 is provided with an extract file 72, wherein table data report configuration generator 254 generates a default configuration file 256. Default configuration file 256 may be modified to reduce ranges or eliminate sentences, wherein such a step is strongly recommended because of the vast amount of data produced utilizing configuration file 256. Table driver report 252 is preferably run against a customized configuration file 258 to produce table driver extract report 260. Preferably, a quality analyst analyzes table driver extract report 260 for errors, discrepancies, or anything else out of the ordinary that might adversely affect the client application.

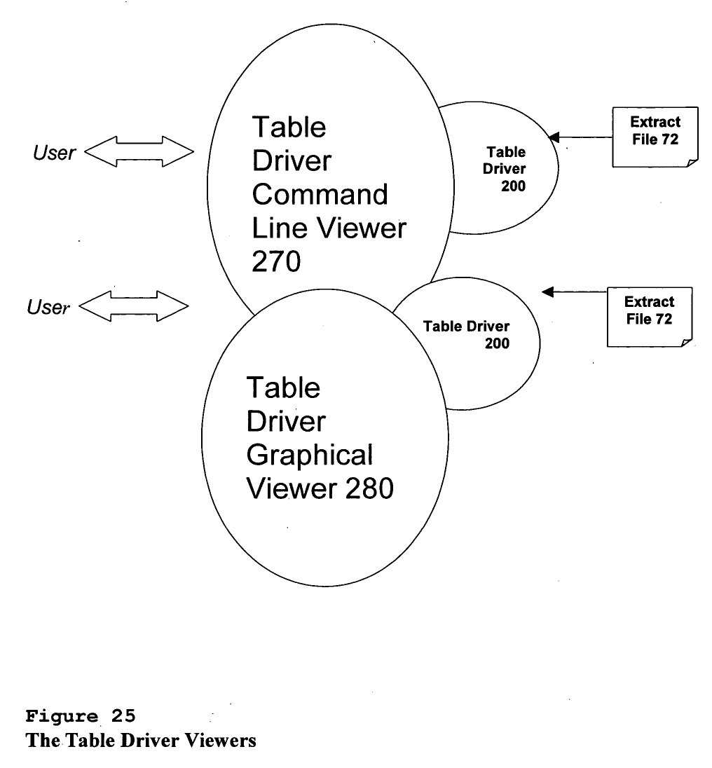

Referring now more specifically to FIG. 25, table driver 200 further comprises table driver command line viewer 270, wherein table driver command line viewer 270 is preferably utilized by support personnel to troubleshoot issues and validate data integrity of an extract file 72. Table driver command line viewer 270 is useful for English sentences and to see meta-data (such as version). Moreover, table driver command line viewer 270 preferably enables remote validation of an extract file 72 via telnet.

Table driver 200 still further comprises table driver graphical viewer 280, wherein table driver graphical viewer 280 is useful for viewing foreign character sets and other graphical fonts that cannot be displayed properly on the command line.

### EXAMPLES

### Example 1

### Grammar, Prompt and Text Concatenation Results of System 10, as Applied to a Telephone Messaging System

The grammar structure of any sentence varies widely across languages. Additionally, almost all languages have multiple “numbersets” from which to choose (up to 15 numbersets). Accordingly, if the “master” sentence (as entered by the developer) is “You have <number> messages in your mailbox.”, then system 10, as applied to a telephone messaging system, would yield the following results in the designated language (selected languages are presented for exemplary purposes only):
English: You have (2) messages in your mailbox.
Japanese: Your mailbox in (2-ken) message there is.
Thai: In your mailbox message (2) message you have.
Portuguese: You have (2-feminine) messages in your mailbox.
Hungarian: You (2-neutral) messages have.
   As described hereinabove, the foregoing results are provided with no code change or data table modification, or other developer effort.

### Example 2

### Translation Customization and Localization Results of System 10, as Applied to a Food Produce Price Scanner Screen

Words vary across dialects of any language—especially nouns. Indeed, providing for changes in dialect has been highly time-consuming over the years, requires much lead-time to schedule and, as such, is often avoided by most companies. Accordingly, if the “master” text (as entered by the developer) is “corn”, then system 10, in addition to supplying a picture of corn, would present the following results on the food pricing screen, in the designated languages and countries (selected languages and countries are presented for exemplary purposes only):

For Mexican markets, the master text appears as: ejote.

For Ecuadorian/Bolivian/Peruvian/Chilean/Argentinean markets, the master text appears as: choclo.

For other markets, the master text appears as: maiz.

Similarly, if the “master” text (as entered by the developer) is “green beans”, then system 10, in addition to supplying a picture of green beans, would present the following results on the food pricing screen, in the designated language and country (selected languages and countries are presented for exemplary purposes only):

For Mexican markets, the master text appears as: elote.

For Peruvian markets, the master text appears as: vainitas.

For Argentinean markets, the master text appears as: chaucha.

For Spanish markets, the master text appear as: judias verdes.

As described hereinabove, the foregoing results are provided with no code change or data table modification, or other developer effort.

### Example 3

### Image, Picture and Video Customization Results of System 10, as Applied to a Retail Store Checkout Payment Screen and Audio System

As applied to a retail store checkout payment screen and audio system, system 10 enables feature customization of the visual aspects of the screen, as well as any accompanying audio prompts, video, text, and multimedia data.

Accordingly, if the “master” visuals (as entered by the developer) are as follows:

Title: Select payment method:

Button 1: Credit Card (+VisaMC.jpg)

Button 2: Cash

Button 3: Debit Card (+DebitCard.jpg)

then system 10 would present the following customized results, along with the “.jpg” image, specific to the retail store (selected retail store name is presented for exemplary purposes only):

Title: Please choose payment method

Button 1: Home Depot Card (+HomeDepotCreditCard.jpg)

Button 2: Cash

Button 3: Other Credit Card (+OtherCreditCard.jpg).

Additionally, where necessary, system 10 provides customer-specific re-sized visuals. As such, the foregoing results may alternatively be provided as follows:
Title: Select payment method; (Size: INCH12×2)(Screen Loc: 12,52,200,400)
Button 1: Home Depot Card (+HomeDepotCreditCard.jpg) (Size: INCH/3×2)(Screen Loc:72,92,150,350)
Button 2: Cash
Button 3: Other Credit Card (+OtherCreditCard.jpg)
Video: (HowToSlideCard.avi). (Size: PXL/120×240) (Left Screen Loc: 500,500).
   As described hereinabove, the foregoing results are provided with no code change or data table modification, or other developer effort.

### Example 4

### Compound Numbers Customization Results of System 10, as Applied to a Bank-by-Phone Application

As described hereinabove, system 10 comprises compound number driver 220 to perform intricate compound number ordering for the selected application, and to ensure perfect numeric output according to the specific language, region, and modified noun. The manner in which a compound number is spoken is re-ordered by system 10, and thereafter passed to the selected application along with all other required elements to complete the sentence or text. When played, the audio compound number will play in the proper natural, spoken language, wherein the associated text will display in high-quality grammar.

Accordingly, if the “master” sentence (as entered by the developer) is “Your account balance is 102 dollars and 24 cents.”, then system 10 would present the following results in the designated languages (selected languages are presented for exemplary purposes only):
English: (Your account balance is) (one hundred) (two) (dollars and) (24) (cents)
Mandarin Chinese: (hundred) (zero) (two) dollar (24) (cent) (your account balance is).
Russian: (Your account balance is) (hundred-AccusitiveMasculine) (two-AccusitiveMasculine) (dollar-Plural#1) (24-AccusitiveMasculine) (cents-plural#2).

Similarly, if the “master” sentence (as entered by the developer) is “Your account balance is 11,080 dollars and 21 cents.”, then system 10 would present the following results in the designated languages (selected languages are presented for exemplary purposes only):

English: (Your account balance is) (eleven thousand)(eighty) (dollars and) (one) (cent).

Mandarin Chinese: (mon*) (one thousand) (zero) (eighty) (dollar)(one) (cent) (your account balance is).

Korean: (Your account balance) (mon*) (thousand) (eighty) (dollar) (one) (cent) (is).

If the “master” sentence (as entered by the developer) is “Your account balance is 111,080 dollars and 21 cents.”, then system 10 would present the following results in the designated languages (selected languages are presented for exemplary purposes only):

English: (Your account balance is) (one hundred)(eleven thousand)(eighty) (dollars and) (one) (cent).

Mandarin Chinese: (eleven mon*) (one thousand) (zero) (eighty) (dollar)(one) (cent) (your account balance is).

Tamil: (Your account balance) (one lak**) (one mon*) (thousand) (eighty) (dollar) (one) (cent) (is).

(* Most Asian languages have a special word for 10,000, which changes all numbers concatenation thereafter.)

(** Many languages have a special word for 100,000, which changes all numbers concatenation thereafter.)

As described hereinabove, the foregoing results are provided with no code change.

### Example 5

### International Telephone Number Results of System 10, as Applied to a Telephone Application

As described hereinabove, system 10 comprises an international telephone number driver 230 to organize number prompt order, and feed that order to the developer's application in the four (4) major methods that telephone numbers are spoken around the world; although system 10 may certainly accommodate other methods of spoken telephone numbers.

Accordingly, if the “master” text (as entered by the developer) is a selected telephone number <telephone number>, then system 10 would present the following results in the designated countries (selected countries are presented for exemplary purposes only):

Digit by digit style: 7-7-0-4-1-4-6-0-0-3

Double-triple style (ex., U.K., Australia): 7-70-41-46-double zero-three

Hundreds style (ex., France, Italy, Spain): 77-zero-4-hundred-fourteen-sixty-zero three

Combo style, which offers a selection of results by country and developer preference: 7-7-oh-4-1-4-six thousand three

If the “master” text (as entered by the developer) comprises an extension <number>, then system 10 would present the following results in the designated countries (selected countries are presented for exemplary purposes only):

Digit by digit style: <extension>1-7-2-2

U.K., Australia: <extension>17-doubleTwo

European: <extension>17.22

Hungary: 1-7-2-2<extension>

Other examples: <extension>1-thousand-7-hundred-22

As described hereinabove, the foregoing results are provided with no code change or data table modification, or other developer effort.

Tables

The following tables illustrate, without limitation, the numerous localization issues accounted for and resolved by system 10, wherein the resolutions are provided with no code change or data table modification, or other developer effort.

TABLE 1
Below is an example of a concatenated menu using run-time
variable numbers and times, that has not been reprogrammed
to accommodate Japanese. Application of system 10 would
ensure that the following message would be heard in
perfect, natural grammar.

Hello! Your Asian Message Center this is.
Double boo voice message and single boo email there is.
Your message review, single press. Exit, triple press.
Voice message for, single press. Email for, double press.
P.M.. 3 hour 30 minute at yesterday message received.
“Hi Tom! This is Sue Ellen. I'll be late tonight. Sorry!”
This message save, single press please.
This message delete, double press please.
This message forward, triple press please.
The number for forward enter please:
“Sorry, the number: single double double triple single
double double you dial ain't service is not.
Again call, please.”

TABLE 2
System 10 further accounts for differing sentence structure
amongst the languages.

| | | | | | |
|---|---|---|---|---|---|
| English | You have | | 2 | messages | in your |
| | | | | | mailbox. |
| Japanese | Your | | 2 ken | message | there is. |
| | mailbox in | | | | |
| Thai | In your | message | 2 | message | you have. |
| | mailbox | | | | |
| Portuguese | You have | | 2 | messages | in your |
| | | | feminine | | mailbox |
| Arabic | You have | | | tw-messag-i | in your |
| | | | | | mailbox. |
| Hungarian | You | | 2 | messages | have. |

TABLE 3
System 10 further accounts for the changes in language names based
on the position of same within a sentence. Below are varying
translations for “American English”:

| | TRANSLATION | USAGE |
|---|---|---|
| subject | az amerikai angol | “AmericanEnglish is not available |
| | nyelv | on this system” |
| for- | amerikai angol | “For AmericanEnglish, press 4” |
| language | nyelvhez | |
| to-language | amerikai angol | “To change the system to American |
| | nyelvre | English, press 1.” |
| is-language | amerikai angol | “The default language is American |
| | | English” |

TABLE 4
System 10 further accounts for the changes in adjectives with gender of
the noun, with number, and based on the position of the adjective
within a sentence.

| | ADJECTIVE | NOUN |
|---|---|---|
| DIRECT OBJECT (you have x | | |
| messages) | | |
| singular | novú | správu |
| plural #1 | nové | správy |
| plural #2 | novych | správ |
| SUBJECT (The message is in your | | |
| mailbox) | | |
| singular | nová | správa |
| plural #1 | nové | správy |
| plural #2 | novych | správ |
| OBJECT OF PREP. (text of message) | | |
| singular | novej | správy |
| plural #1 | novych | správ |
| plural #2 | novych | správ |

TABLE 5
System 10 further accounts for nouns that have many plurals, and
the different rules of usage associated therewith.

| | | | | | OTHER |
|---|---|---|---|---|---|
| | | | | | SINGULARS, |
| | | | | | PLURALS & |
| | | | | | VARIATIONS |
| | SINGULAR | DUAL | PLURAL #1 | PLURAL #2 | ON PLURALS |
| ENGLISH | 1 | | 2+ | | |
| SPANISH | 1 | | 2+ | | |
| GERMAN | 1 | | 2+ | | |
| JAPANESE | 1+ | | | | |
| MANDARIN | 1+ | | | | |
| THAI | 1 | | singular | | |
| | | | <number> | | |
| | | | singular | | |
| ARABIC | special | special | 3+ | | |
| | word | word | | | |
| SLOVAK | 1 | | 2 to 4 | 5+ | 1, 2-4, 5+ |
| RUSSIAN | 1 | | 3 | 6 | Programming |
| | 2 | | 4 | 7 | for Slavic |
| | 21 | | 5 | 8 | languages |
| | 22 | | 11 | 9 | based upon |
| | 31 | | 12 | 10 | the digits |
| | 32 | | 13 | 20 | that end |
| | 41 | | 14 | 26 | the |
| | 42 | | 15 | 27 | compound |
| | 51 | | 16 | 28 | number. |
| | 52 | | 17 | 29 | Thus: |
| | 61 | | 18 | 30 | “if |
| | 62 | | 19 | 36 | <number> |
| | 71 | | 23 | 37 | ends in |
| | 72 | | 24 | 38 | “2” or “11” |
| | 81 | | 25 | 39 | or “14” |
| | 82 | | 33 | 40 . . . 99 | then play |
| | 91 | | 34 | to infinity | Plural #X |
| | 92 | | 35 | for any | |
| | to | | 43 | number | |
| | infinity | | 44 | ending in | |
| | for any | | 45 . . . 95 | these | |
| | number | | to infinity | digits and | |
| | ending in | | for any number | double- | |
| | these | | ending in | digits | |
| | digits and | | these digits | | |
| | double- | | and double- | | |
| | digits | | digits | | |

TABLE 6
System 10 further accounts for pronouns and possessives
that vary by language, and that might otherwise complicate
proper grammar during concatenation.

| | | |
|---|---|---|
| PRONOUNS | I | I |
| | you | you-masculine |
| | he | you-feminine |
| | she | you-young |
| | it | you-old |
| | we | he |
| | they | she |
| | | it-feminine |
| | | it-masculine |
| | | it-neuter |
| | | we-feminine |
| | | we-masculine |
| | | we-mixed |
| | | you-all-feminine |
| | | you-all-masculine |
| | | you-all-young |
| | | you-all-old |
| | | you-all-mixed |
| | | they-feminine |
| | | they-masculine |
| | | they-neuter |
| | | they-mixed |
| POSSESSIVES | my | my-feminine |
| | your | my-masculine |
| | hers | your-feminine |
| | his | your-masculine |
| | our | your-feminine young |
| | their | your-feminine old |
| | (yours) | his/masculine |
| | | her/feminine |
| | | its/neuter |
| | | our-feminine |
| | | our-masculine |
| | | our-mixed |
| | | your-all-feminine |
| | | your-all-masculine |
| | | your-all-young |
| | | your-all-old |
| | | your-all-mixed |
| | | their-feminine |
| | | their-masculine |
| | | their-neuter |
| | | their-mixed |

TABLE 7
System 10 further accounts for changes in people's names that arise
from the position of same within a sentence.

| | | |
|---|---|---|
| FEMININE - HELEN | | |
| Nominative | Elena | I am Elena |
| Genitive | Eleny | Is this Elena's book? |
| Dative | Elene | Give this to Elena |
| Accusative | Elenu | I see Elena |
| Locative | Elene | I am speaking about Elena |
| Instrumental | Elenou | I work with Elena (not I |
| | | work for Elena) |
| MASCULINE - JOHN | | |
| Nominative | Ján | |
| Genitive | Jána | |
| Dative | Jánovi | |
| Accusative | Jána | |
| Locative | Jánovi | |
| Instrumental | Jánom | |

TABLE 8
System 10 accounts for prepositions that vary with the word
that follows - or precedes in many languages - varying with
its gender, with numbers, and/or with a name or object.

| English #1 | ABC has a message for | <spoken name> | |
|---|---|---|---|
| English #2 | ABC has a message for | <phone number> | |
| Spanish #1 | ABC tiene un mensaje para | <spoken name> | |
| Spanish #2 | ABC tiene un mensaje para el | <phone number> | |
| Portuguese #1 | de (“of”) | (used with | |
| | | digits) | |
| Portuguese #2 | da (“of”) | (singular female - | |
| | | message) | |
| Portuguese #3 | das (“of”) | (plural female) | |
| Portuguese #4 | do (“of”) | (singular male - | |
| | | email) | |
| Portuguese #5 | dos (“of”) | (plural male) | |
| English | received | Sunday | March 2 |
| Portuguese #1 | recibido no (received on) | domingo | March 2 |
| | | (Sunday) | |
| Portuguese #2 | recibido na (received on) | segunda- | March 2 |
| | | feira | |
| | | (Tuesday) | |

TABLE 9
System 10 further accounts for the verb “to be”, which
verb often changes other verbs to adjectives, and accounts
for the gender and number of same.

| | | | |
|---|---|---|---|
| English | Mailbox | (is) | deleted. |
| Spanish | El buzón | ha sido (has | eliminado. |
| #1 | | been, | |
| | | definite) | |
| Spanish | La cassilla | ha sido (has | eliminada. |
| #2 | | been, | |
| | | definite) | |

TABLE 10
System 10 further accounts for the permanent and temporary versions
of the verb “to be.”

| English | The | is | “All Employees” |
|---|---|---|---|
| | distribution | | |
| | list . . . | | |
| Spanish | La lista de | es (is, definite) | <name> |
| #3 | distribucion | | |
| Spanish | El numero de | es el (is the, | <number> |
| #4 | telefono | definite) | |
| English | The mailbox | is | empty. |
| Spanish | El buzon | está (is, temp) | vacio. |
| #5 | | | |
| Spanish | La cassilla | está (is, temp) | vacia. |
| #6 | | | |
| English | Messages | are | cancelled. |
| Spanish | Los mensages | están (is, temp) | cancellados. |
| #7 | | | |
| Spanish | Las | están (is, temp) | cancelladas. |
| #8 | reservaciones | | |

TABLE 11
System 10 further accounts for verbs as adjectives,
and the associated change with gender of the noun modified.

| | | | |
|---|---|---|---|
| English #1 | <noun> | (is) | added. |
| Slovak #1 | Name | | pridana. |
| Slovak #2 | Operator | | pridany. |
| Slovak #2 | Guest | | pridane. |

TABLE 12
System 10 further accounts for the variety of press
prompts required by various telephone applications.

| | |
|---|---|
| English | press 1 |
| Korean | 1-pon press please |
| Japanese | 1-poo press |
| Hungarian | press 1 button |
| Spanish | press the 1 |

For telephone applications providing ending press prompts:

| | | |
|---|---|---|
| English | For | press 1 |
| #1 | English | |
| Latin | English | press 1 |
| Languages | for | |
| Asian | English | 1-pon press |
| languages | for | please. |

For telephone applications providing beginning press prompts:

| | | |
|---|---|---|
| English | For English | press 1 |
| #1 | | |
| Korean | undesirable | |

Table 13:

System 10 further accounts for telephone numbers that are spoken and written differently around the world, and others as preferred by language, dialect or developer.

| English | 7-7-0-4-1-4-6-0-0-0 or |
|---|---|
| | 7.7.oh.4.1.4.six thousand |
| U.K., Australia | 7-70-4-1-4-6-triple zero |
| France, Italy, Spain . . . | 77-0-4-146.0.0.0 |

Table 14:

System 10 further accounts for extension to telephone numbers that are spoken and written differently around the world, and others as preferred by language, dialect or developer.

| | |
|---|---|
| English | <extension> 1-7-2-2 or 17-22 |
| U.K., Australia | <extension> 17-doubleTwo |
| Other: | <extension> 1-thousand-7 hundred-22 |
| China | <extension> 1-7-2-2 |
| Hungary | 1-7-2-2 <extension> |

TABLE 15
System 10 further accounts for mailbox <number>, list
<number>, line <number>, room <number>, and the like, all
of which use different numbersets than telephone numbers,
or are spoken and/or written differently around the world.

| | |
|---|---|
| English | <list> 1-7 or 17 |
| U.K., Australia | <list> 1-7 or 17 |
| Many Asian | <list> 17-boo (using equivalent |
| | “counter”) |
| | <list> 1-7 or 17 (using |
| | different “1” than with |
| | telephone, for example) |
| Hungarian | 1-7 <list> or 17 list |

TABLE 16
System 10 further accounts for Asian numbers comprising syllables that
are spoken after the number and before the noun (i.e., called “counters”).
There may be dozens of counters, each of which are often based upon
the shape of the object it modifies (round, flat, square, etc).

| | | Minutes | Messages | | O'clock |
|---|---|---|---|---|---|
| Digits | Digits | “pun” | “ken” | Days“nichi” | “ji” |
| one | ichi | ip-pun | ik-ken | ichinichi | ich-iji |
| two | ni | ni-fun | n-iken | futsu-ka | ni-ji |
| three | san | san-pun | san-ken | mik-ka | sa-nji |
| four | yon | yo-fun | yon-ken | yok-ka | yo-ji |
| five | go | go-fun | go-ken | itsu-ka | go-ji |
| six | roku | rop-pun | ro-ken | mui-ka | roku-ji |

TABLE 17
System 10 further accounts for general global number complications.

```
Null - Zero - Sentences
You ain't got no mail.
You no mail have.
You have no mail.
None mail you have.
You ain't got none mail not.
Digits (digit-by-digit 5-5-5-1-2-1-2)
213-555-1212
Extension 1234
Press 2 (2 press) - not always work
Compound number formulas differ
Digit-Non-Digit After Nouns (solid numbers i.e,. 47)
  Mailbox #14
  List #1
  Room #300
  #300 Room (Hungarian)
Modify Nouns (3 messages)
Are different from digits
Vary with gender
Spanish: 3 French: 5 German: 3 Russian: 6
Mandarin: 8 Japanese: 12
Vary with sentences position
    German: ein, eine, einer, eines, einem, einen
Have “kinks” (Spanish 500, Arabic 2)
Counters and numbersets (9 numbersets)
Compound numbers differ:
    100 feminine, 100 masculine - special words -
Chinese, Vietnamese new concatenation formula
    100s/1000s cannot be concatenated - and may
change with gender (ie. Port)
    Asian 10,000 has own word - new concatenation
formula
    Indian 100,000 has own word - new concatenation
formula
    Spanish, Portuguese . . . 100 versus 101
    101 versus 121 (“and”)
1021 versus 1121 (different 100)
```

TABLES 18
Compound Numbers are wildly divergent across the language spectrum. Below are the minimum
prompts required for concatenation to play compound numbers in the designated languages
(languages are presented for exemplary purposes only). System 10 accounts for such prompts.

| | | | | | | | | | | | |
|---|---|---|---|---|---|---|---|---|---|---|---|
| | | | | | | 100+ | | | | | |
| | Lower- | Lower- | “and” | “and” | 100- | (to | | | | | |
| Digits | Digits-M | Digits-F | digits-M | digits-F | exact | 200) | 100s-M | 100s-F | 1,000 | 1,000,000 | 1,000,000,000 |

English

| | | | |
|---|---|---|---|
| 0-99 | 1 | 1 | 1 |

Spanish

| | | | | | | | | | | | |
|---|---|---|---|---|---|---|---|---|---|---|---|
| 0-99 | 1 | 10 | 9 | 1 | 1 | 1 | 9 | 9 | 1 | 1 | dialect |
| | | | | | | | | | | | problem |

French and Quebecois

| | | | | | | | | | |
|---|---|---|---|---|---|---|---|---|---|
| 0-99 | 40 | 10 | 9 | 1 | 1 | 5 | 1 | 1 | 1 |

Portuguese

| | | | | | | | | | | | |
|---|---|---|---|---|---|---|---|---|---|---|---|
| 0-99 | 1 | 2 | 99 | 2 | 1 | 1 | 9 | 9 | 10 | 1 | 1 |

German

| | | | | | | |
|---|---|---|---|---|---|---|
| 0-99 | 1 | 1 | 1 | 1 | 1 | 1 |

| | | | | | | |
|---|---|---|---|---|---|---|
| Lower-Digits- | Lower- | Lower-Digits-F- | Lower- | Lower- | Lower- | Lower-Digits-N-Obj Prep |
| N-Subj. | Digits- | D.O. | Digits- | Digits- | Digits-F- | |
| | M-D.O. | | N-D.O | M-obj | Obj Prep | |
| | | | | Prep | | |
| 1 | 1 | 1 | 1 | 2 | 1 | 1 |

Mandarin

| | | | | | | | | | |
|---|---|---|---|---|---|---|---|---|---|
| 0-99 | 99 | 99 | 99 | 1 | 1 | 1 | 1 | 1 | 1 |

| | | | | | |
|---|---|---|---|---|---|
| 10,000 (wan) | 10,000+ | Special 0 | 100,000,000 | Extra “1” | Extra “2” |
| | (1-wan) | (for | | | |
| | | compounds) | | | |
| 1 | 1 | 1 | 1 | 1 | |

Japanese

| | | | | | | | | | |
|---|---|---|---|---|---|---|---|---|---|
| 0-99 | 99 | 99 | 99 | 1 | 1 | 1 | 1 | 1 | 1 |

| | | | | | | | | |
|---|---|---|---|---|---|---|---|---|
| 10,000 | 10,000+ | Special 0 | Extra | Extra | Lower- | Lower- | Lower- | 100,000,000 |
| (mon) | (1-mon) | (for | “1” | “2” | Digits-E | Digits-F | Digits-G | |
| | | compounds) | | | | | | |
| 1 | 1 | 1 | 1 | 1 | 99 | 99 | 99 | 1 |

Russian

| | | | | | | | | | | |
|---|---|---|---|---|---|---|---|---|---|---|
| 0-99 | 99 | 99 | 99 | 10 | 10 | 10 | 10 | 10 | 10 | 1 |

| | | | | | | |
|---|---|---|---|---|---|---|
| Lower- | Lower- | Lower-Digits- | Lower-Digits-N- | Lower-Digits- | Lower-Digits- | Lower-Digits- |
| Digits-N- | Digits- | F-D.O. | D.O. | M-Obj Prep | F-Obj Prep | N-Obj Prep |
| Subj. | M-D.O. | | | | | |
| 2 | 2 | 2 | 2 | 2 | 2 | 2 |

Russian Masculine

| | | | | | |
|---|---|---|---|---|---|
| 20-90- | 0-90- | 0-90- | 0-90- | 0-90- | 0-90- |
| Subj. | D.O. | Obj | Dative | Instr. | Genative |
| | | Prep. | | | |
| 8 | 8 | 8 | 8 | 8 | 8 |
| 100s- | 100s- | 100s- | 100s- | 100s- | 100s- |
| Subj. | D.O. | Obj | Dative | Instr. | Genative |
| | | Prep. | | | |
| 10 | 10 | 10 | 10 | 10 | 10 |
| 1,000s- | 1,000s- | 1,000ss- | 1,000s- | 1,000s- | 1,000s- |
| Subj. | D.O. | Obj | Dative | Instr. | Genative |
| | | Prep. | | | |
| 10 | 10 | 10 | 10 | 10 | 10 |
| Million- | Million- | Million- | Million- | Million- | Million- |
| Subj. | D.O. | Obj | Dative | Instr. | Genative |
| | | Prep. | | | |
| 10 | 10 | 10 | 10 | 10 | 10 |

Russian Feminine

| | | | | | |
|---|---|---|---|---|---|
| 20-90- | 0-90- | 0-90- | 0-90- | 0-90- | 0-90- |
| Subj. | D.O. | Obj | Dative | Instr. | Genative |
| | | Prep. | | | |
| 8 | 8 | 8 | 8 | 8 | 8 |
| 100s- | 100s- | 100s | 100s- | 100s- | 100s- |
| Subj. | D.O. | Obj | Dative | Instr. | Genative |
| | | Prep. | | | |
| 10 | 10 | 10 | 10 | 10 | 10 |
| 1,000s- | 1,000s- | 1,000ss- | 1,000s- | 1,000s- | 1,000s- |
| Subj. | D.O. | Obj | Dative | Instr. | Genative |
| | | Prep. | | | |
| 10 | 10 | 10 | 10 | 10 | 10 |
| Million- | Million- | Million- | Million- | Million- | Million- |
| Subj. | D.O. | Obj | Dative | Instr. | Genative |
| | | Prep. | | | |
| 10 | 10 | 10 | 10 | 10 | 10 |

TABLE 19
Compound numbers can be quite complex. Below are some
rules for Mandarin Chinese compound numbers that are
accounted for by system 10.

1-99 MANDARIN
Use 5 versions of lower digits 0-99 for most natural
sound with “counters”
101 to 9999
Mandarin compounds numbers similar to English up to 9999,
except for “0” and “1” of any decimal point, and “1” and
“2” of anything. The entire concatenation scheme changes at
10,000.
Number 2
The exact number two “liang” is used to modify a noun such
as “2 dollars”, and is used to create 200 and 2000 etc.
However, this version of the word “two” (liang) is NOT used
for the final digit on a compound numbers. Rather, the word
“ar” is used as the final digit in concatenations.
Examples:
2 days = LIANG days
102 days = one hundred zero AR days
200, 2000, 200 million
A variant of two (liang 3rd tone) is used in the hundred,
thousand, ten-thousand or hundred-million. It is never used
in the tens place or higher-ten compounds.
Examples:
200 dollars = LIANG hundred dollars
20 dollars = AR ten dollars
222, 222, 222 = LIANG YI LIANG thousand LIANG hundred, AR ten
AR WAN, LIANG thousand LIANG hundred, AR ten AR
10,000 “wan”
Special word for 10,000 (“wan”).
Example:
10,000 = wan
20,000 = 2 wan
1,000,000 = 100 wan
10,000+
Over 10,000, the word “wan” becomes “1 wan”
Example:
11,000 = 1 wan 1 thousand
100 million
Special word for 100 million, “yi”.
Example:
100,000,000 = 1 yi
200,000,000 = 2 yi
10s in 100+
For 100+, if “ten” appears in the middle or end, “ten”
becomes “one ten”.
Example:
111 = one hundred one ten one
2019 = two thousand zero one ten nine
10 as 1st number
If “ten” appears at the beginning of a number, it is
announced as “ten” (not “one ten”). Also applies to the
other “ten” forms: “ten wan” and “ten yi”.
Example:
100,000 dollars = Ten wan dollars
Zero
When a zero occurs inside the number (not end), the word
“zero” is spoken, but only once for two or more consecutive
zeroes.
Example:
101 = one hundred zero one
10,100 = one wan zero one hundred

The above table illustrates an example of one language; however, other languages can be equally complex, yet processed and result in perfect grammar with system 10.

TABLE 20
Below are some rules for Russian compound numbers that
are accounted for by system 10.

1-99 RUSSIAN
Use up to 16 versions of 1 to 99. (3 genders and a plural
for 5 different grammatical cases: subj, d.o., obj. of
prep, etc). Each usage must be coordinated with the “sex”
of the noun and sentence position.
Hundreds
Use up to 15 versions of 100s (3 genders and a plural for 5
different grammatical cases (subj, d.o., obj. Of prep,
etc). Each usage must be coordinated with the “sex” of the
noun and sentence position.

The above table illustrates an example of one language; however, other languages can be equally complex, yet processed and result in perfect grammar with system 10.

TABLE 20

(Continued):
Thousands
Use up to 15 versions of 1000s (3 genders and a plural for
5 different grammatical cases (subj, d.o., obj. Of prep,
etc). Each usage must be coordinated with the “sex” of the
noun and sentence position.
Millions
Use up to 15 versions of millions (3 genders and a plural
for 5 different grammatical cases (subj, d.o., obj. Of
prep, etc). Each usage must be coordinated with the “sex”
of the noun and sentence position.
One
The masculine and plural accusative should be like the
genitive when the noun is animate, and like the nominative
when the noun is inanimate.
2, 3 and 4
The accusative will be like the genitive when the noun is
animate, and like the nominative when the noun is
inanimate. The distinction between animate and inanimate in
the accusative case does not apply to compounds, but only
to lower numbers 2, 3, and 4.
5 to 20
The numbers 5 through 20 and the number 30 change so that
the endings are the same as those for feminine nouns ending
in a soft sign. The numbers drops the “e” in all cases
except for nominative and accusative.
Hundreds
In 200 through 900 (not 100) both parts of the compound
must agree with noun for gender and sentence position. The
first part of the number is declined like digits. The word
“hundred” varies. The nominative singular of 200, 300 and
600 have specific endings for each sentence position. But
the numbers 300 and 400 take the same form for all sentence
positions.
Thousand, Million, Billion
Thousand changes forms as feminine, and million and billion
as masculine. Unlike other numbers, thousand, million and
billion never behave like adjectives (changing with the
noun modified). On the contrary, these numbers will change
the noun they modify from the proper version for the
sentence position, to the genitive case.

TABLE 21
Beginning End-Conjunction

| | |
|---|---|
| 1 | BEFORE - ALWAYS Always plays no matter what |
| 2 | BEFORE - EVEN Plays if first number element being processed is an “Even” number |
| | field (only zeros after), and is the first number processed in the whole |
| 3 | BEFORE - NON-EVEN Plays if first number element being processed is a “non-even” |
| | number field (rest of the number > 0) |
| 4 | BEFORE - PLUS EVEN Plays if first number element being processed is an “Even” |
| | number field (only zeros after) and is the last number processed in the whole |
| 5 | BEFORE - PLUS NON-EVEN Plays if first number element being processed is an |
| | “non-even” number field (rest of the number > 0) and is the last number |
| | processed in the whole |
| 6 | BEFORE - MID-ARRAY N/A |
| 7 | BEFORE - IF DATA Always plays if number > 0 |

Before Billing Conjunction

| | |
|---|---|
| 1 | BEFORE —ALWAYS Always plays no matter what |
| 2 | BEFORE - EVEN Plays if is modifying an “Even” number field (only zeros after), |
| | and is the first number processed in the whole |
| 3 | BEFORE - NON-EVEN Plays if modifies a “non-even” number field (rest of the |
| | number > 0), and is the first number processed in the whole |
| 4 | BEFORE - PLUS EVEN Plays if is modifying an “Even” number field (only zeros |
| | after) and is the last number processed in the whole |
| 5 | BEFORE - PLUS NON-EVEN Plays if modifies a “non-even” number field (rest of the |
| | number > 0) and is the last number processed in the whole |
| 6 | BEFORE - MID-ARRAY Plays mid-array only |
| 7 | BEFORE - IF DATA Always plays if drawing from following field |

EVEN BILLION (1 thru 99)
PLUS EVEN BILLION (1 thru 99) (for when go over 99 billion) 1^{st}-0-bln, 2^{nd}-0-bln,
3^{RD}-0-bln, 4^{th}-0-bln thru 99)
BILLION PLUS (1^{st}-0-bln, 2^{nd}-0-bln, 3^{RD}-0-bln, 4^{th}-0-bln thru 99)
PLUS BILLION (1^{st}-0-bln, 2^{nd}-0-bln, 3^{RD}-0-bln, 4^{th}-0-bln thru 99) (for when go over 99
billion)

AfterBillionConjunction

| | |
|---|---|
| 8 | AFTER - IF DATA Always plays if drawing from preceding field |
| 9 | AFTER - MID-ARRAY Plays mid-array only |
| 10 | AFTER - PLUS NON-EVEN Plays if modifies a “non-even” number field (rest of the |
| | number > 0) and is the last number processed in the whole |
| 11 | AFTER - PLUS EVEN Plays if is modifying an “Even” number field (only zeros |
| | after) and is the last number processed in the whole |
| 12 | AFTER - NON-EVEN Plays if modifies a “non-even” number field (rest of the |
| | number > 0), and is the first number processed in the whole |
| 13 | AFTER - EVEN Plays if is modifying an “Even” number field (only zeros after), |
| | and is the first number processed in the whole |
| 14 | AFTER - ALWAYS Always plays no matter what |

BeforeHundredMillionConjunction

| | |
|---|---|
| 1 | BEFORE —ALWAYS Always plays no matter what |
| 2 | BEFORE - EVEN Plays if is modifying an “Even” number field (only zeros after), |
| | and is the first number processed in the whole |
| 3 | BEFORE - NON-EVEN Plays if modifies a “non-even” number field (rest of the |
| | number > 0), and is the first number processed in the whole |
| 4 | BEFORE - PLUS EVEN Plays if is modifying an “Even” number field (only zeros |
| | after) and is the last number processed in the whole |
| 5 | BEFORE - PLUS NON-EVEN Plays if modifies a “non-even” number field (rest of the |
| | number > 0) and is the last number processed in the whole |
| 6 | BEFORE - MID-ARRAY Plays mid-array only |
| 7 | BEFORE - IF DATA Always plays if drawing from following field |

EVEN HUNDRED MILLION (1 thru 9)
PLUS EVEN HUNDRED MILLION (1 thru 9) (for when we go over 1 billion) (1^{st}-0, 2^{nd}-0
thru 9)
HUNDRED MILLION PLUS (1^{st}-0, 2^{nd}-0 thru 9)
PLUS HUNDRED MILLION (1^{st}-0, 2^{nd}-0 thru 9) (for when we go over 1 billion)

AfterHundredMillionConjunction

| | |
|---|---|
| 8 | AFTER - IF DATA Always plays if drawing from preceding field |
| 9 | AFTER - MID-ARRAY Plays mid-array only |
| 10 | AFTER - PLUS NON-EVEN Plays if modifies a “non-even” number field (rest of the |
| | number > 0) and is the last number processed in the whole |
| 11 | AFTER - PLUS EVEN Plays if is modifying an “Even” number field (only zeros |
| | after) and is the last number processed in the whole |
| 12 | AFTER - NON-EVEN Plays if modifies a “non-even” number field (rest of the |
| | number > 0), and is the first number processed in the whole |
| 13 | AFTER - EVEN Plays if is modifying an “Even” number field (only zeros after), |
| | and is the first number processed in the whole |
| 14 | AFTER - ALWAYS Always plays no matter what |

BeforeMillionConjunction

| | |
|---|---|
| 1 | BEFORE - ALWAYS Always plays no matter what |
| 2 | BEFORE - EVEN Plays if is modifying an “Even” number field (only zeros after), |
| | and is the first number processed in the whole |
| 3 | BEFORE - NON-EVEN Plays if modifies a “non-even” number field (rest of the |
| | number > 0), and is the first number processed in the whole |
| 4 | BEFORE - PLUS EVEN Plays if is modifying an “Even” number field (only zeros |
| | after) and is the last number processed in the whole |
| 5 | BEFORE - PLUS NON-EVEN Plays if modifies a “non-even” number field (rest of the |
| | number > 0) and is the last number processed in the whole |
| 6 | BEFORE - MID-ARRAY Plays mid-array only |
| 7 | BEFORE - IF DATA Always plays if drawing from following field |

EVEN MILLION = (1 thru 99)
PLUS EVEN MILLION (1 thru 99) 1^{st}-0-mil, 2^{nd}-0-mil, 3^{RD}-0-mil, 4^{th}-0-mil
MILLION PLUS (1^{st}-0-mil, 2^{nd}-0-mil, 1^{st}-ten-mil, 2^{nd}-0-ten-mil, 3^{RD}-0-mil, 4^{th}-0-mil thru 99)
PLUS MILLION (1^{st}-0-mil, 2^{nd}-0-mil, 1^{st}-ten-mil, 2^{nd}-0-ten-mil, 3^{RD}-0-mil, 4^{th}-0-mil thru 99)

AfterMillionConjunction

| | |
|---|---|
| 8 | AFTER - IF DATA Always plays if drawing from preceding field |
| 9 | AFTER - MID-ARRAY Plays mid-array only |
| 10 | AFTER - PLUS NON-EVEN Plays if modifies a “non-even” number field (rest of the |
| | number > 0) and is the last number processed in the whole |
| 11 | AFTER - PLUS EVEN Plays if is modifying an “Even” number field (only zeros |
| | after) and is the last number processed in the whole |
| 12 | AFTER - NON-EVEN Plays if modifies a “non-even” number field (rest of the |
| | number > 0), and is the first number processed in the whole |
| 13 | AFTER - EVEN Plays if is modifying an “Even” number field (only zeros after), |
| | and is the first number processed in the whole |
| 14 | AFTER - ALWAYS Always plays no matter what |

BeforeHundredThousandConjunction

| | |
|---|---|
| 1 | BEFORE - ALWAYS Always plays no matter what |
| 2 | BEFORE - EVEN Plays if is modifying an “Even” number field (only zeros after), |
| | and is the first number processed in the whole |
| 3 | BEFORE - NON-EVEN Plays if modifies a “non-even” number field (rest of the |
| | number > 0), and is the first number processed in the whole |
| 4 | BEFORE - PLUS EVEN Plays if is modifying an “Even” number field (only zeros |
| | after) and is the last number processed in the whole |
| 5 | BEFORE - PLUS NON-EVEN Plays if modifies a “non-even” number field (rest of the |
| | number > 0) and is the last number processed in the whole |
| 6 | BEFORE - MID-ARRAY Plays mid-array only |
| 7 | BEFORE - IF DATA Always plays if drawing from following field |

EVEN HUNDRED THOUSAND (1 thru 9)
PLUS EVEN HUNDRED THOUSAND (1 thru 9) 1^{st}-0-hund-thou, 2^{nd}-0-hund-thou
HUNDRED THOUSAND PLUS (1^{st}-0-hund-thou, 2^{nd}-0-hund-thou thru 9)
PLUS HUNDRED THOUSAND (1^{st}-0-hund-thou, 2^{nd}-0-hund-thou thru 9)

AfterHundredThousandConjunction

| | |
|---|---|
| 8 | AFTER - IF DATA Always plays if drawing from preceding field |
| 9 | AFTER - MID-ARRAY Plays mid-array only |
| 10 | AFTER - PLUS NON-EVEN Plays if modifies a “non-even” number field (rest of the |
| | number > 0) and is the last number processed in the whole |
| 11 | AFTER - PLUS EVEN Plays if is modifying an “Even” number field (only zeros |
| | after) and is the last number processed in the whole |
| 12 | AFTER - NON-EVEN Plays if modifies a “non-even” number field (rest of the |
| | number > 0), and is the first number processed in the whole |
| 13 | AFTER - EVEN Plays if is modifying an “Even” number field (only zeros after), |
| | and is the first number processed in the whole |
| 14 | AFTER - ALWAYS Always plays no matter what |

BeforeThousandConjunction

| | |
|---|---|
| 1 | BEFORE —ALWAYS Always plays no matter what |
| 2 | BEFORE - EVEN Plays if is modifying an “Even” number field (only zeros after), |
| | and is the first number processed in the whole |
| 3 | BEFORE - NON-EVEN Plays if modifies a “non-even” number field (rest of the |
| | number > 0), and is the first number processed in the whole |
| 4 | BEFORE - PLUS EVEN Plays if is modifying an “Even” number field (only zeros |
| | after) and is the last number processed in the whole |
| 5 | BEFORE - PLUS NON-EVEN Plays if modifies a “non-even” number field (rest of the |
| | number > 0) and is the last number processed in the whole |
| 6 | BEFORE - MID-ARRAY Plays mid-array only |
| 7 | BEFORE - IF DATA Always plays if drawing from following field |

EVEN THOUSAND (1 thru 99)
PLUS EVEN THOUSAND (1 thru 99) 1^{st}-0-thou, 2^{nd}-0-thou, 3^{rd}-0-ten-thou, 4^{th}-0-ten-thou
THOUSAND PLUS (1^{st}-0-thou, 2^{nd}-0-thou, 3^{rd}-0-ten-thou, 4^{th}-0-ten-thou thru 99)
PLUS THOUSAND (1^{st}-0-thou, 2^{nd}-0-thou, 3^{rd}-0-ten-thou, 4^{th}-0-ten-thou thru 99)

AfterThousandConjunction

| | |
|---|---|
| 8 | AFTER - IF DATA Always plays if drawing from preceding field |
| 9 | AFTER - MID-ARRAY Plays mid-array only |
| 10 | AFTER - PLUS NON-EVEN Plays if modifies a “non-even” number field (rest of the |
| | number > 0) and is the last number processed in the whole |
| 11 | AFTER - PLUS EVEN Plays if is modifying an “Even” number field (only zeros |
| | after) and is the last number processed in the whole |
| 12 | AFTER - NON-EVEN Plays if modifies a “non-even” number field (rest of the |
| | number > 0), and is the first number processed in the whole |
| 13 | AFTER - EVEN Plays if is modifying an “Even” number field (only zeros after), |
| | and is the first number processed in the whole |
| 14 | AFTER - ALWAYS Always plays no matter what |

BeforeHundredConjunction

| | |
|---|---|
| 1 | BEFORE - ALWAYS Always plays no matter what |
| 2 | BEFORE - EVEN Plays if is modifying an “Even” number field (only zeros after), |
| | and is the first number processed in the whole |
| 3 | BEFORE - NON-EVEN Plays if modifies a “non-even” number field (rest of the |
| | number > 0), and is the first number processed in the whole |
| 4 | BEFORE - PLUS EVEN Plays if is modifying an “Even” number field (only zeros |
| | after) and is the last number processed in the whole |
| 5 | BEFORE - PLUS NON-EVEN Plays if modifies a “non-even” number field (rest of the |
| | number > 0) and is the last number processed in the whole |
| 6 | BEFORE - MID-ARRAY Plays mid-array only |
| 7 | BEFORE - IF DATA Always plays if drawing from following field |

EVEN HUNDRED (1 thru 99)
PLUS EVEN HUNDRED (1 thru 99) 1^{st}-0-hund, 2^{nd}-0-hund, 3^{rd}-0-hund, 4^{th}-0-hund thru 99)
HUNDRED PLUS (1^{st}-0-hund, 2^{nd}-0-hund, 3^{rd}-0-hund, 4^{th}-0-hund thru 99)
PLUS HUNDRED (1^{st}-0-hund, 2^{nd}-0-hund, 3^{rd}-0-hund, 4^{th}-0-hund thru 99)

AfterHundredConjunction

| | |
|---|---|
| 8 | AFTER - IF DATA Always plays if drawing from preceding field |
| 9 | AFTER - MID-ARRAY Plays mid-array only |
| 10 | AFTER - PLUS NON-EVEN Plays if modifies a “non-even” number field (rest of the |
| | number > 0) and is the last number processed in the whole |
| 11 | AFTER - PLUS EVEN Plays if is modifying an “Even” number field (only zeros |
| | after) and is the last number processed in the whole |
| 12 | AFTER - NON-EVEN Plays if modifies a “non-even” number field (rest of the |
| | number > 0), and is the first number processed in the whole |
| 13 | AFTER - EVEN Plays if is modifying an “Even” number field (only zeros after), |
| | and is the first number processed in the whole |
| 14 | AFTER - ALWAYS Always plays no matter what |

BeforeDigitsConjunction

| | |
|---|---|
| 1 | BEFORE - ALWAYS Always plays no matter what |
| 2 | BEFORE - EVEN Plays if is modifying an “Even” number field (only zeros after), |
| | and is the first number processed in the whole |
| 3 | BEFORE - NON-EVEN Plays if modifies a “non-even” number field (rest of the |
| | number > 0), and is the first number processed in the whole |
| 4 | BEFORE - PLUS EVEN Plays if is modifying an “Even” number field (only zeros |
| | after) and is the last number processed in the whole |
| 5 | BEFORE - PLUS NON-EVEN Plays if modifies a “non-even” number field (rest of the |
| | number > 0) and is the last number processed in the whole |
| 6 | BEFORE - MID-ARRAY Plays mid-array only |
| 7 | BEFORE - IF DATA Always plays if drawing from following field |

PLUS DIGITS (1 thru 99)
PLUS DIGITS (1^{st}-0-ten, 2^{nd}-0-ten, 3^{rd}-0-ten, 4^{th}-0-ten thru 99)

AfterDigitsConjunction

| | |
|---|---|
| 8 | AFTER - IF DATA Always plays if drawing from preceding field |
| 9 | AFTER - MID-ARRAY Plays mid-array only |
| 10 | AFTER - PLUS NON-EVEN Plays if modifies a “non-even” number field (rest of the |
| | number > 0) and is the last number processed in the whole |
| 11 | AFTER - PLUS EVEN Plays if is modifying an “Even” number field (only zeros |
| | after) and is the last number processed in the whole |
| 12 | AFTER - NON-EVEN Plays if modifies a “non-even” number field (rest of the |
| | number > 0), and is the first number processed in the whole |
| 13 | AFTER - EVEN Plays if is modifying an “Even” number field (only zeros after), |
| | and is the first number processed in the whole |
| 14 | AFTER - ALWAYS Always plays no matter what |

Trailing End-Conjunction

| | |
|---|---|
| 8 | AFTER - IF DATA if number > 0 |
| 9 | AFTER - MID-ARRAY N/A |
| 10 | AFTER - PLUS NON-EVEN Plays if preceding was a “non-even” number field, last |
| | number processed in the whole |
| 11 | AFTER - PLUS EVEN Plays if preceding was an “Even” number field (only zeros |
| | after) and was the last number processed in the whole |
| 12 | AFTER - NON-EVEN Plays if preceding was a “non-even” number field (rest of the |
| | number > 0), and was the only number processed in the whole |
| 13 | AFTER - EVEN Plays if is modifying an “Even” number field (only zeros after), |
| | and was the only number processed in the whole |
| 14 | AFTER - ALWAYS Always plays no matter what |

Having thus described exemplary embodiments of the present invention, it should be noted by those skilled in the art that the within disclosures are exemplary only, and that various other alternatives, adaptations, and modifications may be made within the scope of the present invention. Additionally, merely listing or numbering the steps of a method in a certain order does not constitute any limitation on the order of the steps of that method. Accordingly, the present invention is not limited to the specific embodiments illustrated herein, but is limited only by the following claims.

What is claimed is:

1. A method for globally localizing and/or customizing a selected client application, said method comprising the steps of:
a. inputting master data into a graphical user interface;
b. creating an extract file comprising data required by the client application for localization and customization of the client application, wherein said data is selected from group consisting of master data, a translated script, binary data, and a combination thereof; and,
c. loading a table driver with said extract file, wherein said table driver is a decision-making engine which, based on commands from said extract file, instructs the client application to provide said data in a specific order at run-time of the client application and, thereby, properly localize and/or customize the client application.

2. The method of claim 1, wherein said step a. comprises the step of inputting said master data into said graphical user interface via a template, wherein said template guides the user to separate said master data into prompts, binary data, media types, and variables for proper concatenation.

3. The method of claim 2, further comprising the step of storing said master data and binary data in a database.

4. The method of claim 3, further comprising the step of storing variable content in said database for retrieval during run-time of the client application.

5. The method claim 1, wherein said step b. comprises the prior step of exporting any selected portion of said master data from said database, and creating from said portion of master data a script for translation into a selected language.

6. The method claim 5, further comprising the step of translating said script into the selected language to yield said translated script.

7. The method claim 6, further comprising the step of importing said translated script into said database.

8. The method claim 7, further comprising the step of validating said translated script to ensure proper concatenation.

9. The method of claim 1, wherein said step b. comprises the step of creating said extract file via said graphical user interface.

10. The method of claim 1, wherein said step c. comprises the prior step of exporting said extract file from said graphical user interface.

11. The method of claim 1, further comprising the step of initiating the client application, and permitting the client application to query said table driver to receive said data from said extract file, as required at run-time, and thereby localize and/or customize the client application.

12. The method of claim 1, further comprising the step of loading said extract file into the client application's memory upon initiating the client application, and thereby localize and/or customize the client application.

13. A method for globally localizing and customizing a selected client application, said method comprising the steps of:
a. creating a file comprising data required by the client application for localization and customization of the client application; and,
b. loading a decision-making engine with said file and instructing the client application to provide said data in a specific order at run-time of the client application and, thereby, properly localize and/or customize the client application.

14. The method of claim 13, wherein said step a. comprises the prior step of inputting master data into a graphical user interface via a template, wherein said template guides the user to separate said master data into prompts, binary data, media types, and variables for proper concatenation.

15. The method of claim 14, further comprising the step of storing said master data in a database.

16. The method of claim 15, further comprising the step of storing variable content in said database for retrieval during run-time of the client application.

17. The method claim 15, further comprising the step of exporting any selected portion of said master data from said database, and creating from said portion of master data a script for translation into a selected language.

18. The method claim 17, further comprising the step of translating said script into the selected language to yield a translated script.

19. The method claim 18, further comprising the step of importing said translated script into said database.

20. The method claim 19, further comprising the step of validating said translated script to ensure proper concatenation.

21. The method of claim 20, wherein said step a. comprises the step of selecting said data for said file from said database.

22. The method of claim 21, comprising the step of creating said file via said graphical user interface.

23. The method of claim 22, wherein said step b. comprises the prior step of exporting said file from said graphical user interface.

24. The method of claim 13, further comprising the step of initiating the client application, and permitting the client application to query said decision-making engine to receive said data from said file, as required at run-time, and thereby localize and/or customize the client application.

25. The method of claim 13, further comprising the step of loading said file into the client application's memory upon initiating the client application, and thereby localize and/or customize the client application.

26. A method for globally localizing and customizing a selected client application, said method comprising the steps of:
passing a repeating code string to a decision-making engine, and instructing the client application to provide data in a specific order at run-time of the client application and, thereby, properly localize and/or customize the client application.

27. A method for globally localizing and customizing a selected client application, said method comprising the steps of:
a. entering data into a database via a graphical user interface;
b. creating an extract file comprising at least a portion of said data from said database;
c. loading a decision-making engine with said extract file; and,
d. instructing the client application to provide data in a specific order at run-time of the client application and, thereby, properly localize and/or customize the client application.

28. The method of claim 27, wherein said step a. comprises the prior step of providing a template through which to enter said data.

29. The method of claim 27, wherein said step a. further comprises the step of entering and storing variable content in said database for retrieval during run-time of the client application.

30. The method claim 27, wherein said step a. further comprises the step of translating at least a portion of said data into a selected language.

31. The method claim 27, wherein said step b. comprises the prior step of validating said data.

32. The method of claim 27, wherein said step b. comprises the step of creating said extract file via said graphical user interface.

33. The method of claim 27, wherein said step c. comprises the prior step of exporting said extract file from said graphical user interface.

34. The method of claim 27, wherein said step d. comprises the prior step of initiating the client application, and permitting the client application to query said decision-making engine to receive said data from said extract file, as required at run-time, and thereby localize and/or customize the client application.

35. The method of claim 27, wherein said step d. comprises the prior step of loading said extract file into the client application's memory upon initiating the client application.

36. A method for globally localizing and customizing a selected client application, said method comprising the steps of:
a. entering data into a database via a graphical user interface; and,
b. instructing the client application to provide data in a specific order at run-time of the client application and, thereby, properly localize and/or customize the client application.

37. The method of claim 36, wherein said step a. comprises the prior step of providing a template through which to enter said data.

38. The method of claim 36, wherein said step a. further comprises the step of entering and storing variable content in said database for retrieval during run-time of the client application.

39. The method claim 36, wherein said step a. further comprises the step of translating at least a portion of said data into a selected language.

40. The method claim 36, wherein said step b. comprises the prior step of validating said data.

41. The method of claim 36, wherein said step b. comprises the prior step of creating an extract file comprising at least a portion of said data from said database.

42. The method of claim 41, further comprising the step of creating said extract file via said graphical user interface.

43. The method of claim 42, further comprising the step of exporting said extract file from said graphical user interface.

44. The method of claim 43, further comprising the step of loading a decision-making engine with said extract file.

45. The method of claim 44, further comprising the step of initiating the client application, and permitting the client application to query said decision-making engine to receive said data from said extract file, as required at run-time, and thereby localize and/or customize the client application.

46. The method of claim 44, further comprising the step of loading said extract file into the client application's memory upon initiating the client application.

47. The method of claim 36, wherein said step b. comprises the prior step of generating localized hard code from said data.

48. The method of claim 47, further comprising the step of manually inserting said localized hard code into the client application.

49. The method of claim 47, further comprising the step of exporting said localized hard code into the client application.

50. The method of claim 47, further comprising the step of inserting said localized hard code into the client application via peripheral files searched by the client application at run-time.

51. A system for globally localizing and customizing a selected client application, said system comprising:
a graphical user interface, wherein data is entered through said graphical user interface;
a database, wherein said database stores said data;
a means for instructing the client application to provide at least a portion of said data in a specific order at run-time of the client application and, thereby, properly localize and/or customize the client application.

52. The system of claim 51, wherein said graphical user interface comprises a plurality of templates, wherein said templates guide the user to separate said data into prompts, binary data, media types, and variables for proper concatenation.

53. The system of claim 52, wherein said data entered into said templates is selected from the group consisting of text, single prompt full sentences, single number variable sentences, date variable sentences, time variable sentences, “and” constructions, nested conditionals, pass through variables, criteria variables-multiple choice, repeat single variables, compound numbers, international telephone numbers, pictures, video, sound, multimedia, subtitles, screen coordinates governing display of said data at run-time of the client application, timing conditions governing display of said data at run-time of the client application, images, image size, image color, image timing, image coordinates, image shape, method of appearance of an image, method of image fade away, client application version by country, client application version by language, client application version by custom language, and combinations thereof.

54. The system of claim 51, wherein said database comprises a unique schema utilized by the user to store said data as entered through said graphical user interface.

55. The system of claim 51, wherein said graphical user interface can selectively connect to alternate databases other than said database for access to localized data thereof.

56. The system of claim 51, further comprising a script manager, wherein said script manager exports data from said database and produces and manages a plurality of scripts from said data based upon the client application.

57. The system of claim 56, wherein said plurality of scripts are selected from the group consisting of talent scripts, scripts for recording, scripts for database content, scripts for file names, scripts destined for translation, audio scripts, textual scripts, variables by entry, visual display scripts, element lists, and combinations thereof.

58. The system of claim 57, further comprising a translation manager, wherein said translation manager creates documents for translation and localization from said scripts.

59. The system of claim 58, wherein said translation manager automatically imports translated documents and scripts into said database.

60. The system of claim 51, further comprising a global database, wherein said global database comprises basic variable translations, binary data localizations and controls, in internationalized form, for proper concatenation of said data entered into said graphical user interface.

61. The system of claim 60, wherein said global database comprises a plurality of sub-parts, said sub-parts selected from the group consisting of unique variables set, linguistic information for user entry validation, customized language information, written international numbersets, verbal international numbersets, written international dates, verbal international dates, written international times, verbal international times, administrator related data, and combinations thereof.

62. The system of claim 60, wherein said global database is integrated into said graphical user interface.

63. The system of claim 51, wherein said instructing means is a table driver, wherein said table driver is a decision-making engine that instructs the client application to provide at least a portion of said data in a specific order at run-time of the client application and, thereby, properly localize and/or customize the client application.

64. The system of claim 63, wherein said table driver utilizes an extract file, and wherein said extract file comprises said data required by said table driver for accurate localization and customization of the client application.

65. The system of claim 64, wherein said extract file is produced by said graphical user interface.

66. The system of claim 64, wherein said table driver drives call-up and concatenation of said data, utilizing run-time variable information.

67. The system of claim 64, wherein said extract file is exported from said graphical user interface and thereafter loaded into said table driver.

68. The system of claim 67, wherein the client application queries said table driver to receive said data, on an as-needed basis at run-time, and wherein said table driver provides said data to the client application based on commands by said extract file.

69. The system of claim 63, wherein said table driver can be compiled with the client application in an embedded environment.

70. The system of claim 63, wherein said table driver can be statically or dynamically linked with the client application.

71. The system of claim 63, wherein said table driver supports a plurality of world languages, including character, 2-byte and multi-byte languages, and custom languages.

72. The system of claim 63, wherein said table driver comprises a compound numbers driver, wherein said compound numbers driver compounds and concatenate numbers according to globally-differing compound number patterns, to thereby provide accurate screen text, relevant punctuation, modifying words, and text to speech.

73. The system of claim 63, wherein said table driver comprises an international telephone number driver, wherein said international telephone number driver provides prompt names, accurate screen text, relevant punctuation, modifying words, and information required to display written text telephone numbers and play audio telephone numbers according to globally-differing international telephone number patterns, and text to speech.

74. The system of claim 63, wherein said table driver further comprises table driver reporting suite, wherein said table driver reporting suite provides table driver reports showing what said table driver will return to the client application for a range of possible run-time inputs.

75. The system of claim 74, wherein said table driver reporting suite operates on an extract file created by said graphical user interface.

76. The system of claim 75, wherein a table data report configuration generator of said table driver reporting suite generates a modifiable default configuration file.

77. The system of claim 76, wherein said table driver report is run against a customized configuration file to produce a table driver extract report, and wherein said table driver extract report may be analyzed for errors, and discrepancies that might adversely affect the client application.

78. The system of claim 63, wherein said table driver further comprises a table driver command line viewer, wherein said table driver command line viewer is utilized by support personnel to troubleshoot issues and validate data integrity of said extract file.

79. The system of claim 78, wherein said table driver command line viewer enables remote validation of said extract file via telnet.

80. The system of claim 63, wherein said table driver further comprises table driver graphical viewer, wherein said table driver graphical viewer enables viewing of foreign character sets and other graphical fonts that cannot be displayed properly on a command line.

81. The system of claim 63, further comprising a language hierarchy search pattern, wherein said language hierarchy search pattern enables a user td assign an unlimited number of custom language names to a client application.

82. The system of claim 63, wherein said language hierarchy search pattern provides versatility in assigning text, image, video, and/or sound via sublanguages.

83. The system of claim 82, wherein a customized language hierarchy created by the user through said language hierarchy search pattern may be utilized by said table driver at run-time of the client application to call up language information applicable to the exact location and circumstances surrounding the client application.

84. The system of claim 83, wherein said system enables selection and assignment of a custom language and/or a normal world language to identify the language of a selected portion of data.

85. The system of claim 84, wherein said table driver, in providing said selected portion of data in the assigned custom or normal language, searches said system in a hierarchal manner for up to a pre-set number of languages, defaulting to the last language in a list of selected and assigned languages if no pervious versions of said selected portion of data in an assigned language is found.

86. The system of claim 51, wherein said instructing means is a localized hard code generator, wherein said localized hard code generator generates localized hard code, said localized hard code utilized by the client application to instruct the client application to provide at least a portion of said data in a specific order at run-time of the client application and, thereby, properly localize and/or customize the client application.

87. The system of claim 86, wherein said localized hard code is manually inserted into the client application.

88. The system of claim 86, wherein said localized hard code is exported into the client application.

89. The system of claim 86, wherein said localized hard code is inserted into the client application via peripheral files searched by the client application at run-time.

90. The system of claim 86, wherein said localized hard code comprises a format and content based upon said data of said database, combined with algorithms of said system.

91. A system for globally localizing and customizing a selected client application, said system comprising:
a user interface, wherein data is entered through said user interface;
a database, wherein said database stores said data;
a means for instructing the client application to provide at least a portion of said data in any selected order and, thereby, properly localize and/or customize the client application.

92. A method for globally localizing and customizing a selected client application, said method comprising the steps of:
a. creating a file comprising data for use by the client application for localization and customization of the client application; and,
b. loading a decision-making engine with said file and instructing the client application to provide said data in any selected order and, thereby, properly localize and/or customize the client application.
